(19) United States
(12) Patent Application Publication
(10) Pub. No.: US 2014/0378661 A1
(43) Pub. Date: Dec. 25, 2014

(54) MOLDED REGENERATED SILK GEOMETRIES USING TEMPERATURE CONTROL AND MECHANICAL PROCESSING

(71) Applicants: Tim Jia-Ching Lo, Lungtan (TW); Gary G. Leisk, Wilmington, MA (US); Lei Li, Beijing (CN); David L. Kaplan, Concord, MA (US)

(72) Inventors: Tim Jia-Ching Lo, Lungtan (TW); Gary G. Leisk, Wilmington, MA (US); Lei Li, Beijing (CN); David L. Kaplan, Concord, MA (US)

(73) Assignee: TRUSTEES OF TUFTS COLLEGE, Medford, MA (US)

(21) Appl. No.: 14/112,637

(22) PCT Filed: Apr. 20, 2012
(86) PCT No.: PCT/US12/34401

§ 371 Date: Aug. 29, 2014

Related U.S. Application Data
(60) Provisional application No. 61/477,486, filed on Apr. 20, 2011.

(51) Int. Cl. D01F 4/02; B05D 7/24; B05D 3/00; B29C 39/00

(52) U.S. Cl. CPC D01F 4/02; B29C 39/003; B05D 7/24; B05D 3/007; D10B 2211/22; B29K 2089/00; B29L 2007/008
USPC 530/353; 264/28; 264/299; 264/41; 264/405; 427/331; 427/398.1

(57) ABSTRACT

The present disclosure provides methods for fabricating various regenerated silk geometries using temperature control. In addition to temperature control, mechanical processing can be used to enhance properties of the fabricated article. The present disclosure also provides silk foam and paper-like materials molded using freezer processing.

### CROSS-REFERENCE TO RELATED APPLICATIONS

This application claims benefit under 35 U.S.C. §119(e) of the U.S. Provisional Application No. 61/477,486, filed Apr. 20, 2011, the content of which is incorporated herein by reference in its entirety

### GOVERNMENT SUPPORT

This invention was made with government support under grant no. EB002520 awarded by the National Institutes of Health. The government has certain rights in the invention.

### TECHNICAL FIELD

The present disclosure relates generally to compositions and methods for preparing molded regenerated silk geometries using temperature control and mechanical processing.

### BACKGROUND

Researchers have used various approaches to form regenerated silk fibers. One common technique is wet spinning. In this process, a polymer is dissolved or chemically treated into a soluble form that can be extruded through a spinneret into a wet bath. Methanol and ethanol has been used, but can cause rapid conformation changes from random coil to beta sheet, which prevents molecular chains from adjusting/aligning and limits mechanical performance improvement (Yan, J., Zhou, G., Knight, D. P., Shao, Z., and Chen, X., Wet-Spinning of Regenerated Silk Fiber from Aqueous Silk Fibroin Solution: Discussion of Spinning Parameters, Biomaterials (2010), 11, pp. 1-5). The crystalline structures formed are not well-aligned in the fiber direction and molecular chain entanglements lead to poor mechanical properties. Yan et al. utilized a coagulation bath with ammonium sulfate for wet spinning. Their simplified industrial processing equipment, which incorporated continuous mechanical post-drawing, produced fibers that rivaled the strength and toughness of natural silk cocoon fibers. The best reported properties using this process were strength of 390 MPa and over 30% strain to failure (Yan, J., Zhou, G., Knight, D. P., Shao, Z., and Chen, X., Wet-Spinning of Regenerated Silk Fiber from Aqueous Silk Fibroin Solution: Discussion of Spinning Parameters, Biomaterials (2010), 11, pp. 1-5). Zhu et al. wet spun regenerated silk fibers through a stainless steel spinneret into a methanol and acetic acid coagulation bath. After soaking for several hours, the fibers were mechanically stretched. Fibers with about 100 micron diameter demonstrated strengths of 210 MPa, about half that of native silk fiber (Zhu, Z., Imada, T., and Asakura, T., Preparation and characterization of regenerated fiber from the aqueous solution of Bombyx mori cocoon silk fibroin, Materials Chemistry and Physics (2009), 117, pp. 430-433).

Plaza et al. (Effect of Water on Bombyx mori Regenerated Silk Fibers and Its Application in Modifying Their Mechanical Properties, J of Applied Polymer Science (2008), 109, pp. 1793-1801) compared mechanical properties of natural fibers to regenerated silkworm fiber in various solvents. Both silkworm and spider fibers become compliant when immersed in water. This is attributed to two competing effects: (a) the breaking of intermolecular hydrogen bonds due to water and increased mobility of the polymer chains due to the weakened intermolecular interactions; and (b) swelling due to the inclusion of water molecules along the polymer chains. Spider silks supercontract more than 50% of original length when tested in water. Silkworm silk fibers contract less than 5% with a small decrease in properties compared to spider silk. The contraction of silk is likely due to weakening of intermolecular interactions and/or swelling of the fiber due to the inclusion of water molecules with the polymer water. It was also demonstrated that water could predictably modify the properties of regenerated silk fibers. Their regenerated silk fibers were produced by wet-spinning through a 100 micron spinneret into an ethanol bath. The regenerated fibers had voids that were left by the solvent used during coagulation. The voids were seen to collapse when the fiber was dried and to elongate with drawing (Plaza, G. R., Corsini, P., Perez-Rigueiro, J., Marsano, E., Guinea, G., and Elices, M., Effect of Water on Bombyx mori Regenerated Silk Fibers and Its Application in Modifying Their Mechanical Properties, J of Applied Polymer Science (2008), 109, pp. 1793-1801).

Mandal et al. (Biospinning by silkworms: Silk fiber matrices for tissue engineering applications, Acta Biomaterialia (2010), 6, pp. 360-371) compiled a list of tensile strengths for various fibers. Bave silk fiber generated from Bombyx Mori silkworms were reported to have tensile strength of 500 MPa with intact sericin coating and 740 MPa for degummed bave silk. Spider silks are reported to have tensile strength between 875-972 MPa. Kevlar is reported to have a very high tensile strength of 3600 MPa (Mandal B. B. and Kundu, S. C., Biospinning by silkworms: Silk fiber matrices for tissue engineering applications, Acta Biomaterialia (2010), 6, pp. 360-371). Xia et al. (Native-sized recombinant spider silk protein produced in metabolically engineered Escherichia coli results in a strong fiber, Proc of the National Academy of Sciences (2010), 107, pp. 14059-14063) expressed recombinant silk proteins modeled on major spidroin I of the spider Nephila clavipes. The molecular weight was adjusted through a multimerization process. The recombinant silk proteins were dissolved in hexafluoroisopropanol (HFIP) and spun at a silk concentration of 20% (w/v). Each fiber was then hand-drawn to 5 times the original length. Tenacity (maximum fiber stress) was 508 MPa and elongation was 15%, which is somewhat close to properties for native N. clavipes dragline silk (740-1200 MPa and 18-27% elongation). It is commonly thought that mechanical properties of a polymer increase with increasing molecular weight, to a point. There may also be a threshold necessary to achieve the incredible mechanical properties exhibited by spider silk (X., X.-X., Oian, Z.-G., Ki, C. S., Park, Y. H., Kaplan, D. L., and Lee, S. Y., Native-sized recombinant spider silk protein produced in metabolically engineered Escherichia coli results in a strong fiber, Proc of the National Academy of Sciences (2010), 107, pp. 14059-14063).

Regenerated silk solution can be processed in a variety of ways to create a wide array of geometries. Because of this flexibility, many applications have been explored by researchers. High-frequency sonication has been used to create silk gel that can be used for cell encapsulation (Wang, X., Kluge, J. A., Leisk, G. G., and Kaplan, D. L., Sonication-Induced Gelation of Silk Fibroin for Cell Encapsulation, Biomaterials (2008), 29, pp. 1054-1064). Through the use of high-voltage charging of a silk solution, electro spinning has been used to make nano-fiber-based tubular constructs for vascular graft tissue engineering (Soffer, L., Wang, X., Zhang, X., Kluge, J., Dorfmann, L., Kaplan, D. L., and Leisk, G., Silk-Based Electrospun Tubular Scaffolds for Tissue-Engineered Vascular Grafts, J Biomaterials Science Polymer Edition (2008), 19, pp. 653-664). Three-dimensional bone scaffolds have been created from an aqueous-based silk processing approach (Kim, H. J., Kim, U.-J., Leisk, G. G., Bayan, C., Georgakoudi, I., and Kaplan, D. L., Bone Regeneration on Macroporous Aqueous-Derived Silk 3-D Scaffolds, Macromolecular Bioscience (2007), 7, pp. 643-655). In general, demanding applications that required excellent mechanical properties, such as high stiffness and strength, and good toughness have been a challenge for the introduction of silk materials. While some post solution-processing approaches, such as water annealing and methanol treatment can provide an improvement in silk performance, there have heretofore been limitations in the level of mechanical performance possible. In general, regenerated silk solution-based geometries have not been able to achieve mechanical properties approaching the native cocoon fiber properties.

Thus, there is need in the art for compositions and methods for fabricating article from silk having enhanced mechanical properties.

### SUMMARY

Provided herein is method for fabricating or molding a variety of articles from silk. The method generally comprises pouring a silk solution in a mold and inducing a conformation change in the silk fibroin in the solution by holding the mold comprising the silk solution at room temperature or a lower temperature. In some embodiments, conformational change can be induced at a temperature from about −8° C. to about −10° C.

Without limitations any type of silk can be used for the molding process. In addition, the silk solution can be preprocessed before molding. Alternatively, or in addition, the article can be post-processed after fabrication. Articles fabricated by the method described herein can include fibers, foams, sponges, films, coatings, layers, gels, mats, meshes, hydrogels, 3D-scaffolds, controlled drug delivery systems, and the like.

### BRIEF DESCRIPTION OF THE DRAWINGS

FIGS. 1A-1C show silk film generated with silk solution away from egel. FIG. 1A, remaining half in Petri dish; FIG. 1B, removed half on supports; and FIG. 1C, both halves after 2 hours at room temperature (leftmost sample remained in Petri dish until dry).

FIGS. 2A and 2B show adhesion of silk egel film on hand (FIG. 2A) and arm FIG. 2B).

FIG. 3 shows silk egel being removed from milli-Q water.

FIGS. 4A-4C show silk egel film being stretched by hand.

FIGS. 5A and 5B show DragonSkin silicone molds for molding silk nuts and screws: with steel machine nuts and screws embedded (FIGS. 5A and 5B) and after nut and screw removal (FIGS. 5C and 5D).

FIGS. 6A and 6B show molded silk screw: compared to a steel machine screw (FIG. 6A) and with steel machine nut installed (FIG. 6B).

FIG. 7 shows plastic spur and worm gears (top) compared to their molded silk counterparts. (bottom).

FIGS. 8A and 8B show silk screws and nuts: (a) in their silicone molds (FIG. 8A) and screwed together after molding (FIG. 8B).

FIGS. 9A-9C show various geometries molded from hot silk egel: nuts in a silicone mold (FIG. 9A); after removal (FIG. 9B); and silk screws (FIG. 9C).

FIGS. 10A-10D show high concentration silk gears: in a mold (FIG. 10A); after removal, next to plastic counterparts (left) (FIG. 10B); mounted to a hardened steel shaft (FIG. 10C); and mounted in a gear motor housing (FIG. 10D).

FIGS. 11A and 11B shows a molded silk body for soft-bodied robot: in a silicone mold (FIG. 11A); and after removal from the mold (FIG. 11B).

FIGS. 12A and 12B show a drawn molded silk fiber: post-drawing (FIG. 12A) ands during diameter measurement (0.15 mm) (FIG. 12).

FIG. 13 is a schematic representation of an embodiment of the method described herein for creating a regenerated silk fiber. Steps include: (i) molding; (ii) conformation control; (iii) removal from mold; (iv) stretching; and (v) drawing.

FIG. 14 shows a molded regenerated silk fiber stretched between adjustable wrenches.

FIG. 15A shows a molded fiber.

FIG. 15B shows the molded fiber of FIG. 15A mounted on to a ukulele.

FIGS. 16A-16C show molded regenerated silk fiber: mounted on 3-point flexural test fixture (FIG. 16A); during flexural testing (FIG. 16B); and after failure during the testing (FIG. 16C).

FIGS. 17A-17D show molded regenerated silk fiber treated with Sericin: mounted on 3-point flexural test fixture (FIG. 17A); during flexural testing (FIG. 17B and FIG. 17C); and after failure during the testing (FIG. 17D).

FIGS. 18A-18C show molded regenerated silk fibers: sandwiched between cardboard tabs (FIG. 18A); mounted in tensile testing grips (FIG. 18B); and stress-strain results (FIG. 18C).

FIG. 19 is a schematic representation of an embodiment of the method described herein for creating a regenerated silk fiber from preprocessed silk. Steps include: (i) conformation control; (ii) molding; (iii) removal from mold; (iv) stretching; and (v) drawing.

FIG. 20 shows regenerated fiber undergoing steam treatment.

FIG. 21 shows regenerated fiber soaking in a mineral oil bath.

FIG. 22 shows fiber test specimens mounted in cardboard tabs for proper gripping.

FIG. 23 shows regenerated fiber installed in one pneumatic grip (top) and a machining vise (bottom) for tensile testing.

FIG. 24 is a bar graph showing the average fiber diameter for molded freezer-processed and old silk processed at room temperature.

FIGS. 25 and 26 are line graph showing the raw fiber testing data for regenerated fibers processed at room temperature (FIG. 25) and at sub-zero temperatures (FIG. 26). The raw graphs in FIG. 25 were analyzed to produce the modulus of elasticity, ultimate strength, and elongation data shown in FIGS. 27-29. For example, the 4 sample curves that elongated to below 2% strain are the as-molded fibers processed at room temperature with no drawing cycles (“old-0”). The sample curves in FIG. 26 were used to generated the data in FIGS. 27-29 labeled “Fr-700.” Those samples were molded at sub-zero temperatures and post-drawn approximately 700 cycles.

FIG. 27 is a bar graph showing the average modulus of elasticity for fibers processed in a freezer and at room temperature.

FIG. 28 is a bar graph showing the average ultimate strength for fibers processed in a freezer and at room temperature.

FIG. 29 is a bar graph showing the average elongation to failure for fibers processed in a freezer and at room temperature.

FIGS. 30A-30C shows regenerated fiber undergoing mechanical rolling: fiber under roller (FIG. 30A); (b) fiber in cross-section (FIG. 30B); and under a microscope (FIG. 30C).

FIGS. 31A and 31B show silk material in Falcon tube several days after removal from a freezer: liquid is still present in the tube (FIG. 31A); and a dry sample removed from its tube (FIG. 31B).

FIGS. 32A-32C show silk foam morphology: after sectioning (FIG. 32A); and under stereo microscope (FIGS. 32B and 32C).

FIGS. 33A-33C show scanning electron microscope (SEM) images of coarser inner region of silk egel foam cross section: at 200× (FIG. 33A); 3500× (FIG. 33B); and 12000× (FIG. 33C).

FIGS. 34A-34C show scanning electron microscope (SEM) images of smooth outer surface of silk egel foam: at 200× (FIG. 33A); 3500× (FIG. 33B); and 12000× (FIG. 33C).

FIGS. 35A and 35 B show silk egel film: after 3 days (FIG. 35A); and after 5 days (FIG. 35) in a freezer.

FIGS. 36A and 36B show silk egel foam: after removal from a laser etched acrylic substrate (FIG. 36A); and close-up of the etched letters cast onto its surface (FIG. 36B).

FIGS. 37A and 37B show silk egel foam: (FIG. 37A) crystalline-like contours in the surface morphology; and (FIG. 37B) close-up of the etched “Y” letter cast onto its surface.

FIGS. 38A-38C show a large sheet of silk egel foam: FIG. 38A shows an overall view; close-up of embedded defects (FIG. 38B), and a close-up of the leading edge of the foam construct (FIG. 38C).

FIGS. 39A and 39B show silk egel foam: (FIG. 39A) cast in a plastic Petri dish; and (FIG. 39B) close-up of a large pore that shows the highly porous nature of the foam.

FIGS. 40A-40C show silk egel foam: (FIG. 40A) removed from the freezer after 8 (left) and 12 days (right); (FIG. 40B) with writing executed with an ink-based pen; and (FIG. 40C) with laser-cut shapes and an etched name embedded.

FIG. 41 shows foam formed by casting hot egel (20% w/v silk solution) in a dish and freezing for 10 days at −10° C.

FIGS. 42A and 42B show foam material made for the remaining silk solution and electrogelation: (FIG. 42A) in cross-section and (FIG. 42B) compared to foam made the same way with high concentration silk (15% w/v).

FIGS. 43A-43C show silk cocoons from Taiwan used to create foam: (FIG. 43A) raw cocoons being cut; (FIG. 43B) a foam construct after freezing and removal from a plastic syringe; and (FIG. 43C) foam in cross-section.

FIGS. 44A-44D show comparison of silk foams fabricated using a freezing process and cocoons from Japanese and Chinese suppliers: (FIG. 44A) silk in 60 ml syringes (Japanese on the left); (FIG. 44B) gooey silk construct using Japanese silk; (FIG. 44C) robust hydrated construct using Chinese source; and (FIG. 44D) silk material flexibility using Chinese source.

FIGS. 45A-45C show silk foam fabricated from Chinese cocoons: (FIG. 45A) after sectioning in a dry state; (FIG. 45B) submerged in milli-Q water after being dried in a fully compressed state; and (FIG. 45C) back in fully reconstituted state after 17 minutes.

FIGS. 46A and 46B show silk solution converts relatively quickly to a gel-like material when a large volume of silk powder is mixed in: (FIGS. 16A and 16B) silk construct under impact loading.

FIGS. 47A-48C show effect of the addition of silk powder on the formation of silk foam using silk degummed for 60 minutes: (FIGS. 47A and 47B) silk-filled syringe exposed to liquid nitrogen; (FIG. 47C) dried foam construct after sectioning; and (FIG. 47D) zoom in of quality silk foam.

FIGS. 48A-48C show machinable silk foam fabricated using high concentration silk solution with silk powder embedded: (FIG. 48A) foam being tapped; (FIG. 48B) foam with machine screw installed; and (FIG. 48C) turning on a jewelers' lathe.

FIGS. 49A-49C show steps in fabricating a bone-shaped foam model according to an embodiment of a method described herein: (FIG. 49A) liquid nitrogen poured into silk solution; (FIG. 49B) freezing mixture on a stir plate; and (FIG. 49C) silk being packed into a DragonSkin mold using a lab spatula.

FIGS. 50A and 50B show silk foam constructs: (FIG. 50A) dog femurs and (FIG. 50B) machine screw.

FIG. 51 shows temperature cycling inside a thermoelectric cooler.

FIG. 52 shows temperature cycling inside thermoelectric cooler, along tube.

FIG. 53 shows cross-section of silk foam showing fine-pore structure on the top and sides of the construct and larger pore structure throughout the bulk of the sample.

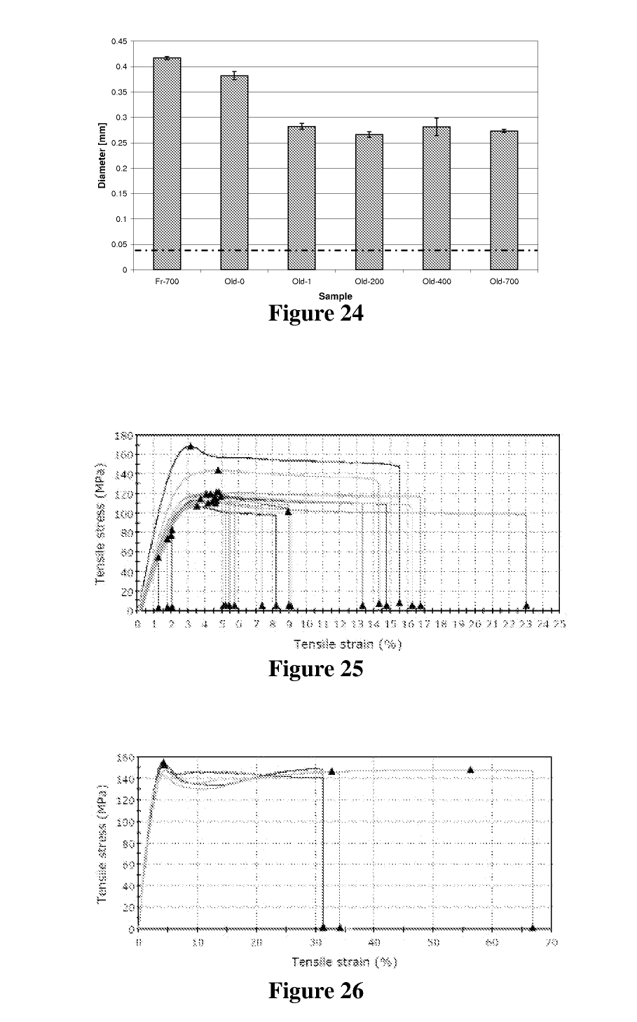

FIGS. 24A and 24B show fluke IR camera views of silk foam thermal experiment: (FIG. 24A) silk foam placed onto heating plate and (FIG. 24B) after steady-state temperature was reached.

FIGS. 25A-25D show silk foam-based version of a Styrofoam coffee cup: (FIG. 25A) silk cup still in DragonSkin mold; (FIG. 25B) after molding, next to coffee cup used as a positive; (FIG. 25C) final silk cup; and (FIG. 25D) zoom in of molded detail.

FIG. 26 shows thin, fine-pored silk construct demonstrating fine pore control due to enhanced freezing rate.

FIGS. 57A-57D show fabrication approach for silk foam skull: (FIG. 57A) plastic skull in DragonSkin mold; (FIG. 57B) silk skull after removal from freezer (half of DragonSkin mold removed); (FIG. 57C) silk skull in lyophilizer (bottom shelf); and (FIG. 57D) complete silk skull.

FIGS. 58A-58C show freezer-processed silk foam infused with pure silk powder: (FIG. 58A) after removal from a lyophilizer; (FIG. 58B) being compressed after re-hydration; and (FIG. 58C) self-expansion to its original geometry.

FIG. 59 shows a hemispherical silk foam construct for soft tissue void filling.

FIG. 60 shows a hemispherical silk foam construct for soft tissue void filling. Metallic rods have been embedded to provide increased cooling rate through the interior of the construct. The faster cooling successfully generated a much finer pore structure surrounding each rod.

FIG. 61 shows freezer-processed silk foam samples (Chinese, 10 minute degumming) using silk solution concentrations of 1, 2, 3, 4, 5, and 6% w/v silk fibroin.

FIG. 62 shows close-up of sections freezer-processed silk foam samples (Chinese, 10 minute degumming) using silk solution concentrations of 1, 2, 3, 4, 5, and 6% w/v silk fibroin.

FIGS. 63A-63C show silk stabilization: (FIG. 63A) egg yolk foam; (FIG. 63B) egg white foam; and (FIG. 63C) fully hydrated egg yolk and egg white foams.

FIG. 64 shows silk stabilized egg yolk and egg white combined in a single egg-like construct.

FIG. 65 shows molded fiber with drawing according to an embodiment of the method described herein. The moist fiber stretches significantly. During stretching, a stretch limit is reached after each drawing cycle. Additional moisture is added by damping fingers used in drawing. Significant decrease in diameter and increase in length is achieved. Remarkable strength and toughness is achieved in the drawn fiber. Flexibility is maintained in the fiber, even after many days of air drying. Fibers can be used for biomed applications and industrial applications.

### DESCRIPTION OF EXEMPLARY EMBODIMENTS

Embodiments of the method described herein are based on the inventors' discovery that a silk solution undergoes conformational change at low temperatures. The microstructure of silk solution is dominated by random coil molecular conformation. It is known that the conformation can become more crystalline, achieving a higher-order conformation through several methods: time-driven self-assembly, increased temperature, decreased pH, through addition of ions, shearing, and several other ways. The most crystalline state, beta-sheet rich Silk II, provides robust mechanical strength performance, with limited elongation. Silk I conformations are typically meta-stable phases in that the material can be driven to either a more random conformation or to a more stable conformation, such as a beta-sheet conformation. Given the meta-stable behavior, significant elongation is possible, although the mechanical strength characteristics in the silk I conformation is limited. The inventors have discovered that a meta-stable phase can be achieved (likely silk I) in a silk solution that has been maintained at a low temperature. At the temperatures used, the water can begin to freeze, but the silk fibroin can still maintains some mobility. The resulting concentrating effect (molecular chains of the silk protein being collected in regions of mobility) can lead to some hydrogen bonding of chains, but not the more crystalline silk II conformation (as long as the temperature is not too cold, the time too long, etc.). The inventors have also discovered that the meta-stable form can be mechanically drawn at elevated temperature to silk material having properties which are different from silk material molded using methods presently known in the art.

Accordingly, provided herein are methods for fabricating various articles from silk using temperature control. In general, the method comprises molding a silk solution in a mold and inducing a conformation change, e.g., inducing a meta-stable phase, in the silk solution by holding the mold comprising the silk solution at room temperature or a lower temperature. Without limitations any type of silk can be used for the molding process. In addition, the silk solution can be preprocessed before molding. Alternatively, or in addition, the article can be post-processed after fabrication. Articles fabricated by the method described herein can include fibers, films, foams, sponges, coatings, layers, gels, mats, meshes, hydrogels, 3D-scaffolds, controlled drug delivery systems, and the like.

After pouring the silk solution in the mold, the mold can be held at room temperature or a lower temperature for a desired period time. For example, the mold comprising the silk solution can be held at a temperature from about −30° C. to about room temperature. In some embodiments, the mold comprising the silk solution can be held at a temperature from about −25° C. to about 20° C., from about −20° C. to about 15° C., −15° C. to about 10° C., or from about −10° C. to about 5° C. In some embodiments, the mold comprising the silk solution can be held at a temperature of about −30° C., about −25° C., about −20° C., about −15° C., about −10° C., about −5° C., about 0° C., about 5° C., about 10° C., about 15° C., about 20° C., or about 23° C. In some embodiments, the mold comprising the silk solution can be held at a temperature of about −8° C. to about −10° C.

As used herein, the term “room temperature” means a temperature of about 20° C. to about 23° C. with an average of 23° C.

Inventors have discovered that tensile strain of a fiber molded at low temperature (i.e., molded at temperature below 0° C., e.g., molded at −5° C., at −6° C., at −7° C., at −8° C., at −9° C., at −10° C., at −11° C., at −12° C., at −13° C., at −14° C., at −15° C., at −16° C., at −17° C., at −18° C., at −19° C., or at −20° C. or below) is higher than that of a fiber molded at room temperature or from a preprocessed silk solution. As used herein, the term “tensile strain” refers to the elongation of a material which is subject to tensile stress. The term “tensile stress” refers to the maximum stress that a material can withstand while being stretched or pulled before necking, which is when the material's cross-section starts to significantly contract. Typically, stress strain testing involves taking a small sample with a fixed cross-section area, and then pulling it with a controlled, gradually increasing force until the sample changes shape or breaks.

A fiber molded at low temperature can have a tensile strain from about 30% to about 70%. The tensile strain can be at a tensile stress of about 120 MPa to about 150 MPa. For example, a fiber molded at low temperature can have a tensile strain of about 30%, about 32%, about 34%, about 35%, about 40%, about 45%, about 50%, about 55%, about 65%, about 67%, or about 70%.

A fiber molded at room temperature or from a preprocessed silk solution can have a tensile strength from about 1% to about 25%. The tensile stress can be at about 90 MPa to about 180 MPa. For example, a fiber molded at room temperature or from a preprocessed silk solution can have a tensile strength about 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5% or 25%.

The mold comprising the silk solution can be kept at the holding temperature for any period of time. One of skill in the art can determine the optimum time based on the concentration of the silk solution used, desired degree of conformational change, desired mechanical properties of the molded article, desired viscosity of the silk solution in the mold, type of post-processing, and the like. Accordingly, the mold comprising the silk solution can be kept at the holding temperature for about 1 hour to about 6 months. In some embodiments, the mold comprising the silk solution can be kept at the holding temperature for at least one day, two days, three days, four days, five days, six days, one week, two weeks, three weeks, four weeks, one month, two months, three months, four months, five months or more. The preferred times for maintaining the molds at low temperature is 5-6 days, depending on the volume and concentration of silk solution utilized (longer times are preferred with larger volume).

Without limitations, the fabricated article can comprise a silk II beta-sheet crystallinity content of at least about 5%, at least 10%, at least 15%, at least 20%, at least 25%, at least 3%, at least 35%, at least 40%, at least 45%, at least 50%, at least 55%, at least 60%, at least 65%, at least 70%, at least 75%, at least 80%, at least 85%, at least 90%, or at least about 95% but not 100% (i.e., all the silk is present in a silk II beta-sheet conformation). In some embodiments, the silk in the fabricated article can be present completely in a silk II beta-sheet conformation.

The fabricated article can be removed from the mold using methods and process well known in the art and available to an ordinarily skilled artisan. For example, the mold can be warmed to room temperature and the fabricated article removed from the mold. In one example, when the mold is a tube, the fabricated article, i.e., a fiber, can be removed from the mold by pushing an aqueous solution, e.g., water (milliQ water), from one end of the tube to extrude the fiber from the tube.

Silk solution can have any concentration of silk fibroins for the molding process. Generally, a higher concentration needs a shorter time for inducing a conformational change at room temperature or a lower temperature. Accordingly, the silk solution for molding can have a silk fibroin concentration of from about 1% to about 50%. In some embodiments, the silk fibroin solution has a silk fibroin concentration of from about 10% to about 40% or from 15% to about 35%. In one embodiment, the silk fibroin solution has a silk fibroin concentration of from about 20% to about 30%. In one embodiment, the silk fibroin solution has a silk fibroin concentration of about 5%, about 10%, about 15%, about 20%, about 25%, about 30%, about 35%, about 40%, or about 45%.

As used herein, the term “fibroin” includes silkworm fibroin and insect or spider silk protein (Lucas et al., Adv. Protein Chem 13: 107-242 (1958)). Preferably, fibroin is obtained from a solution containing a dissolved silkworm silk or spider silk. The silkworm silk protein is obtained, for example, from Bombyx mori, and the spider silk is obtained from Nephila clavipes. In the alternative, the silk proteins suitable for use according to the present disclosure can be obtained from a solution containing a genetically engineered silk, such as from bacteria, yeast, mammalian cells, transgenic animals or transgenic plants. See, for example, WO 97/08315 and U.S. Pat. No. 5,245,012, content of both of which is incorporated herein by reference.

The silk fibroin solution can be prepared by any conventional method known to one skilled in the art. For example, B. mori cocoons are boiled for about 30 minutes in an aqueous solution. Preferably, the aqueous solution is about 0.02M Na₂CO₃. The cocoons are rinsed, for example, with water to extract the sericin proteins and the extracted silk is dissolved in an aqueous salt solution. Salts useful for this purpose include lithium bromide, lithium thiocyanate, calcium nitrate or other chemicals capable of solubilizing silk. Preferably, the extracted silk is dissolved in about 9-12 M LiBr solution. The salt is consequently removed using, for example, dialysis or chromatography.

If necessary, the solution can then be concentrated using, for example, dialysis against a hygroscopic polymer, for example, PEG, a polyethylene oxide, amylose or sericin. Preferably, the PEG is of a molecular weight of 8,000-10,000 g/mol and has a concentration of 10-50%. A slide-a-lyzer dialysis cassette (Pierce, MW CO 3500) is preferably used. However, any dialysis system may be used. The dialysis is for a time period sufficient to result in a final concentration of aqueous silk solution between 10-30%. In most cases dialysis for 2-12 hours is sufficient. See, for example, PCT application PCT/US/04/11199, content of which is incorporated herein by reference.

Alternatively, the silk fibroin solution can be produced using organic solvents. Such methods have been described, for example, in Li, M., et al., J. Appl. Poly Sci. 2001, 79, 2192-2199; Min, S., et al. Sen'I Gakkaishi 1997, 54, 85-92; Nazarov, R. et al., Biomacromolecules 2004 May-June; 5(3):718-26.

The silk fibroin for molding can be modified for different applications or desired mechanical or chemical properties of the fabricated article. One of skill in the art can select appropriate methods to modify silk fibroins, e.g., depending on the side groups of the silk fibroins, desired reactivity of the silk fibroin and/or desired charge density on the silk fibroin. In one embodiment, modification of silk fibroin can use the amino acid side chain chemistry, such as chemical modifications through covalent bonding, or modifications through charge-charge interaction. Exemplary chemical modification methods include, but are not limited to, carbodiimide coupling reaction (see, e.g. U.S. Patent Application. No. US 2007/0212730), diazonium coupling reaction (see, e.g., U.S. Patent Application No. US 2009/0232963), avidin-biotin interaction (see, e.g., International Application No.: WO 2011/011347) and pegylation with a chemically active or activated derivatives of the PEG polymer (see, e.g., International Application No. WO 2010/057142). Silk fibroin can also be modified through gene modification to alter functionalities of the silk protein (see, e.g., International Application No. WO 2011/006133). For instance, the silk fibroin can be genetically modified, which can provide for further modification of the silk such as the inclusion of a fusion polypeptide comprising a fibrous protein domain and a mineralization domain, which can be used to form an organic-inorganic composite. See WO 2006/076711. In some embodiments, the silk fibroin can be genetically modified to be fused with a protein, e.g., a therapeutic protein. Additionally, the silk fibroin matrix can be combined with a chemical, such as glycerol, that, e.g., affects flexibility and/or solubility of the matrix. See, e.g., WO 2010/042798, Modified Silk films Containing Glycerol.

Before pouring into the mold, the silk solution can be preprocessed. For example, the silk solution can be subjected to an electogelation step to form a silk electrogel (egel). The formed egel can be removed from the solution and the remaining solution used for molding. Silk electrogelation (egel) is a processing modality for silk fibroin protein. In simple terms, the egel process applies an electric field (either direct or alternating current, referred to as DC or AC) to solubilized silk fibroin solution, causing a transformation of the silk protein's random coil conformation into a meta-stable, silk I conformation. The electric field can be applied through using a voltage source, such as a DC or AC voltage source. Direct current is produced by sources such as batteries, thermocouples, solar cells, etc. Alternatively, alternating current (AC), the general powder source for business and residence, can also be used to induce the electrogelation process, although the gel formation may not be as fast as the gelation process induced by direct current voltage. Other methods of applying an electric field to the silk solution can also be used, such as current sources, antennas, lasers, and other generators. The resulting gel-like substance has a very sticky, thick, mucus-like consistency and has many interesting properties, including muco-adhesive qualities and the ability to be further transformed into other conformations, including back to a random coil conformation or to an even higher-order β-sheet conformation. The method of eletrogelation, the related parameters used in the eletrogelation process and the structural transition of silk fibroin during the electrogelation process can be found, for example, in WO/2010/036992, content of which is incorporated herein by reference. One can also use the egel portion for molding an article according to the method described herein. For example, the egel portion can be heated before pouring into the mold. Without wishing to be bound by a theory, the egel viscosity is decreased by heating. When egel is heated, the viscosity decreases, but the original material properties return when the egel cools back to room temperature.

In some embodiments, the silk solution to be used for molding can be preprocessed at room temperature or a lower temperature for a period time before pouring into the mold. Without wishing to be bound by a theory, when the silk solution is preprocessed, self-assembly into beta-sheet conformation can begin before the molding process. This can increase the beta-sheet content of the solution to be used for the molding. Molding such a silk solution at room temperature or a lower temperature accelerates the assembly process and further increases the beta-sheet content. The material can be removed from the mold before the silk is completely solid, producing a rubbery material that has high water content. The inventors have discovered that such pretreatment can enhance properties, such as mechanical properties, and allows use of higher temperature (e.g. room temperature) or shorter molding times for the molding process. This can be beneficial if the molded article comprises a temperature or time-sensitive material.

The silk solution to be used for molding can comprise one or more (e.g., one, two, three, four, five or more) additives in addition to the silk fibroins. Without limitations, an additive can be selected from small organic or inorganic molecules; saccharines; oligosaccharides; polysaccharides; biological macromolecules, e.g., peptides, proteins, and peptide analogs and derivatives; peptidomimetics; antibodies and antigen binding fragments thereof; nucleic acids; nucleic acid analogs and derivatives; glycogens or other sugars; immunogens; antigens; an extract made from biological materials such as bacteria, plants, fungi, or animal cells; animal tissues; naturally occurring or synthetic compositions; and any combinations thereof. Total amount of additives in the solution can be from about 0.1 wt % to about 70 wt %, from about 5 wt % to about 60 wt %, from about 10 wt % to about 50 wt %, from about 15 wt % to about 45 wt %, or from about 20 wt % to about 40 wt %, of the total silk fibroin in the solution.

In some embodiments, an additive is a biocompatible polymer. Exemplary biocompatible polymers include, but are not limited to, a poly-lactic acid (PLA), poly-glycolic acid (PGA), poly-lactide-co-glycolide (PLGA), polyesters, poly(ortho ester), poly(phosphazine), poly(phosphate ester), polycaprolactone, gelatin, collagen, fibronectin, keratin, polyaspartic acid, alginate, chitosan, chitin, hyaluronic acid, pectin, polyhydroxyalkanoates, dextrans, and polyanhydrides, polyethylene oxide (PEO), poly(ethylene glycol) (PEG), triblock copolymers, polylysine, alginate, polyaspartic acid, any derivatives thereof and any combinations thereof. Other exemplary biocompatible polymers amenable to use according to the present disclosure include those described for example in U.S. Pat. No. 6,302,848; No. 6,395,734; No. 6,127,143; No. 5,263,992; No. 6,379,690; No. 5,015,476; No. 4,806,355; No. 6,372,244; No. 6,310,188; No. 5,093,489; No. U.S. 387,413; No. 6,325,810; No. 6,337,198; No. U.S. Pat. No. 6,267,776; No. 5,576,881; No. 6,245,537; No. 5,902,800; and No. 5,270,419, content of all of which is incorporated herein by reference.

Other additives suitable for use with the present disclosure include biologically or pharmaceutically active compounds. Examples of biologically active compounds include, but are not limited to: cell attachment mediators, such as collagen, elastin, fibronectin, vitronectin, laminin, proteoglycans, or peptides containing known integrin binding domains e.g. “RGD” integrin binding sequence, or variations thereof, that are known to affect cellular attachment (Schaffner P & Dard 2003 Cell Mol Life Sci. January; 60(1):119-32; Hersel U. et al. 2003 Biomaterials. November; 24(24):4385-415); biologically active ligands; and substances that enhance or exclude particular varieties of cellular or tissue ingrowth. Other examples of additive agents that enhance proliferation or differentiation include, but are not limited to, osteoinductive substances, such as bone morphogenic proteins (BMP); cytokines, growth factors such as epidermal growth factor (EGF), platelet-derived growth factor (PDGF), insulin-like growth factor (IGF-I and II) TGF-β1 and the like.

In some embodiments, additive is silk powder. As used herein, the term “silk powder” refers to non-pigmentitious particles comprising silk finbroin. The particle generally have a particle size ranging from about 0.02 to 200, preferably 0.5 to 100, microns. The particulates can also be in the fiber form such as silk fibers and the like. Such fibers are generally circular in cross-section and have a discernable length. In some embodiments, total amount of silk powder in the solution can be from about 0.1 wt % to about 70 wt %, from about 5 wt % to about 60 wt %, from about 10 wt % to about 50 wt %, from about 15 wt % to about 45 wt %, or from about 20 wt % to about 40 wt %, of the total silk fibroin in the solution.

After the molded article has been removed from the mold, the article can undergoing further processing, i.e., post-processing. For example, the article can be dried, rehydrated, mechanically processed, coated, freeze-dried, applying of shear-stress, or a combination thereof.

Any process known to one of skill in the art can be used for drying the fabricated article. For example, the fabricated article can be dried using air flow, inert gas flow, heating, freeze-drying, treating with an alcohol (e.g. methanol, ethanol, etc), or a combination thereof. The alcohol concentration can be at least 10%, at least 20%, at least 30%, at least 40%, at least 50%, at least 60%, at least 70%, at least 80%, at least 90% or 100%.

In some embodiments, the molded article can be coated with a composition comprising one or more natural or synthetic biocompatible or non-biocompatible polymers. Without wising to be bound by a theory, coating the molded article with one or more polymers provides enhanced properties, for example, properties for mechanical processing. Exemplary biocompatible polymers include, but are not limited to, polyethylene oxide, polyethylene glycol, collagens (native, reprocessed or genetically engineered versions), polysaccharides (native, reprocessed or genetically engineered versions, e.g. hyaluronic acid, alginates, xanthans, pectin, chitosan, chitin, and the like), elastin (native, reprocessed or genetically engineered and chemical versions), agarose, polyhydroxyalkanoates, pullan, starch (amylose amylopectin), cellulose, cotton, gelatin, fibronectin, keratin, polyaspartic acid, polylysin, alginate, chitosan, chitin, poly lactide, poly glycolic, poly(lactide-co-glycolide), poly caproloactone, polyamides, polyanhydrides, polyaminoacids, polyortho esters, poly acetals, proteins, degradable polyurethanes, polysaccharides, polycyanoacrylates, glycosamino glycans (e.g., chrondroitin sulfate, heparin, etc.), and the like. Exemplary non-biodegradable polymers include, but are not limited to, polyamide, polyester, polystyrene, polypropylene, polyacrylate, polyvinyl, polycarbonate, polytetrafluorethylene and nitrocellulose material. In some embodiments, the polymer is sericin.

The inventors have discovered that a fiber molded by a method described herein can be further processed to provide enhanced strength and toughness relative to a fiber fabricated using methods currently known in the art. Accordingly, a molded fiber can be subjected to a stretching or drawing process. The stretching process can comprise stretching the fabricated article, e.g., a fiber, from its ends. A fiber can be allowed to dry before undergoing a drawing process.

The drawing process can comprise applying lateral pressure on the fiber while drawing the fiber along its axis. The drawing process can be repeated any desired number of times to obtain a fiber of desired thickness or mechanical properties. This process of fiber drawing can mimic the native process, leading to superior outcomes to all other fiber formation processes using regenerated silk. See, e.g., Zhou et al. (Adv. Mats. 209, 21: 366-370).

The amount that each fiber can be stretched or drawn can be affected by how many drawing cycles are used, how much lateral pressure is used during the drawing process, and if and how the molded fiber is processed during or before undergoing the stretching or drawing process. Accordingly, in some embodiments, moisture can be applied to the fiber while drawing it. In addition, or alternatively, a molded fiber can be processed soaking the molded fiber in a steam, boiling water, or in oil (e.g., mineral oil) before the stretching or drawing process. Without wishing to be bound by a theory, processed fibers are more flexible after exposure to moisture, moist heat, or soaking in oil. Accordingly, additional drawing cycles can be applied to the fibers. Thus, this process can be used for increasing the amount of drawing that can be applied to fibers, without causing premature failure or significantly degrading the elongation capability of the regenerated fibers.

As discussed above, inventors' discovery that a meta-stable phase can be achieved (likely silk I) in a silk solution that has been maintained at a low temperature. Further, the inventors' have also discovered that silk in the meta-stable form can be mechanically drawn at elevated temperature to provide silk material having properties which are different from silk material molded using methods presently known in the art. Accordingly, silk in the meta-stable form can be drawn at temperatures from about 20° C. or higher, e.g., about 21° C. or higher, about 22° C. or higher, about 23° C. or higher, about 24° C. or higher, about 25° C. or higher, about 26° C. or higher, about 27° C. or higher, about 28° C. or higher, about 29° C. or higher, about 30° C. or higher, about 31° C. or higher, about 32° C. or higher, about 33° C. or higher, about 34° C. or higher, about 35° C. or higher. In some embodiments, the meta-stable form can be mechanically drawn at a temperature from about 20° C. to about 75° C., from about 20° C. to about 70° C., from about 20° C. to about 65° C., from about 20° C. to about 60° C., from about 20° C. to about 55° C., from about 20° C. to about 50° C., from about 20° C. to about 45° C., about 20° C. to about 40° C., from about 20° C. to about 35° C., or from about 20° C. to about 30° C.

The inventors have also discovered that the moist fiber stretches significantly; during stretching, a stretch limit is reached after each drawing cycle; significant decrease in diameter and increase in length can be achieved. Further, a fiber made using the method described herein shows remarkable strength and toughness relative to a fiber made using currently used methods for making silk fibers. Additionally, a fiber made using a method described herein maintains flexibility, even after many days of air drying.

The silk fiber made by the method described herein can be used for biomed applications and industrial applications. Further, since a fiber made by the method described herein can be transparent, can transmit light, such as a laser light, and therefore can be used as optical fiber.

A silk fiber produced by the process described herein can undergo further processing to obtain a desired article. For example, the fiber can be rolled to provide a strip of silk.

The silk fiber can also be contracted, such as by reducing the ambient humidity to which the silk fiber is exposed; or expanded, such as by increasing the ambient humidity to which the silk fiber is exposed. Additionally, the silk fiber can be further processed, for example with a methanol treatment, to generate water-insoluble silk fiber.

Silk fibers produced from the method of the invention can be wrapped with other type of fibers made from silk or other materials, natural or synthetic, into a fiber bundle or fiber composite. For example, a fiber composite can be made from one or more silk fibers of the invention combined with one or more native silkworm fibroin fibers to form a silk-fiber-based matrix. Immunogenic components in the silk (such as sericin) can be removed from native silk fiber if such silk fiber based matrix is to be used as implantable materials. These silk fiber based matrix can be used to produce tissue materials for surgical implantation into a compatible recipient, e.g., for replacement or repair of damaged tissue. Some non-limiting examples of tissue materials that can be produced include ligaments or tendons such as anterior cruciate ligament, posterior cruciate ligament, rotator cuff tendons, medial collateral ligament of the elbow and knee, flexor tendons of the hand, lateral ligaments of the ankle and tendons and ligaments of the jaw or temporomandibular joint; cartilage (both articular and meniscal), bone, muscle, skin and blood vessels. Methods of making tissue materials or medical device using silk-fiber based matrix or silk composite containing silk fibers may be found in, e.g., U.S. Pat. No. 6,902,932, Helically organized silk fibroin fiber bundles for matrices in tissue engineering; U.S. Pat. No. 6,287,340, Bioengineered anterior cruciate ligament; U.S. Patent Application Publication Nos. 2002/0062151, Bioengineered anterior cruciate ligament; 2004/0224406, Immunoneutral silk-fiber-based medical devices; 2005/0089552, Silk fibroin fiber bundles for matrices in tissue engineering; 20080300683, Prosthetic device and method of manufacturing the same; 2004/0219659, Multi-dimensional strain bioreactor; 2010/0209405, Sericin extracted silkworm fibroin fibers, which are incorporated by reference in their entirety.

Silk fibers produced from the method of the invention can be incorporated into textile (e.g., yarns, fabrics) and textile-based structures using traditional textile-processing equipment, including winding, twisting, flat braiding, weaving, spreading, crocheting, bonding, tubular braiding, knitting, knotting, and felting (i.e., matting, condensing or pressing) machines. Such textiles can be incorporated in composite materials and structures through many known composite-manufacturing processes.

Silk fibers produced from the method of the invention can be combined with other forms of silk material, such as silk films (WO2007/016524), coatings (WO2005/000483; WO2005/123114), microspheres (PCT/US2007/020789), layers, hydrogel (WO2005/012606; PCT/US08/65076), mats, meshes, sponges (WO2004/062697), 3-D solid blocks (WO2003/056297), etc., to form an all-silk composite. The silk composite material can be reinforced by silk fiber, as well as incorporate the optical property of silk optical fiber into the composite. For example, a one, two or three-dimensional silk composite can be prepared by exposing silk fiber with silk fibroin solution and drying or solidifying the silk fibroin solution containing the silk fiber of the invention to form the silk composite. Different solidifying processes and additional approaches for processing silk fibroin solution into different formats of silk materials can be used. See, e.g., WO/2005/012606; WO/2008/150861; WO/2006/042287; WO/2007/016524; WO 03/004254, WO 03/022319; WO 04/000915.

Moreover, silk fiber produced by the method of the invention can be combined with one or more other natural or synthetic biocompatible or non-biocompatible polymers, and incorporated into a composite with different material formats, such as fibers, films, coatings, layers, gels, mats, meshes, hydrogel, sponges, 3-D scaffold, and the like. The non-limiting biocompatible polymers include polyethylene oxide, polyethylene glycol, collagens (native, reprocessed or genetically engineered versions), polysaccharides (native, reprocessed or genetically engineered versions, e.g. hyaluronic acid, alginates, xanthans, pectin, chitosan, chitin, and the like), elastin (native, reprocessed or genetically engineered and chemical versions), agarose, polyhydroxyalkanoates, pullan, starch (amylose amylopectin), cellulose, cotton, gelatin, fibronectin, keratin, polyaspartic acid, polylysin, alginate, chitosan, chitin, poly lactide, poly glycolic, poly(lactide-co-glycolide), poly caproloactone, polyamides, polyanhydrides, polyaminoacids, polyortho esters, poly acetals, proteins, degradable polyurethanes, polysaccharides, polycyanoacrylates, glycosamino glycans (e.g., chrondroitin sulfate, heparin, etc.), and the like. Exemplary non-biodegradable polymers include polyamide, polyester, polystyrene, polypropylene, polyacrylate, polyvinyl, polycarbonate, polytetrafluorethylene and nitrocellulose material. When incorporating silk fiber into the composite, one or more of these aforementioned polymers can be combined. See also, e.g., U.S. Pat. No. 6,902,932; U.S. Patent Application Publication Nos. 2004/0224406; 2005/0089552; 2010/0209405.

The geometry and properties of composite materials containing the silk fiber of the invention can be tailored to specific applications. For example, single fiber layers have been shown to be very tough and flexible. Cylindrical mandrels can be used to produce very stiff rod or tubular constructs that can have impressive compressive, tensile, flexural, and torsional properties. Custom wavy or highly curved geometries can also be produced.

The composite material generally enhances the matrix properties such as mechanical strength, porosity, degradability, and the like, and also enhances cell seeding, proliferation, differentiation or tissue development when used as medical suture or implantable tissue materials.

Silk fibroin in the silk fiber can also be chemically modified with active agents in the solution, for example through diazonium or carbodiimide coupling reactions, avidin-biodin interaction, or gene modification and the like, to alter the physical properties and functionalities of the silk protein. See, e.g., PCT/US09/64673; PCT/US10/42502; PCT/US2010/41615; U.S. patent application Ser. No. 12/192,588.

An article molded using the method described herein can include at least one active agent. The agent can be embedded in the article or immobilized on the surface of the article. The active agent can be a therapeutic agent or biological material, such as chemicals, cells (including stem cells) or tissues, proteins, peptides, nucleic acids (e.g., DNA, RNA, siRNA), nucleic acid analogues, nucleotides, oligonucleotides or sequences, peptide nucleic acids (PNA), aptamers, antibodies or fragments or portions thereof (e.g., paratopes or complementarity-determining regions), antigens or epitopes, hormones, hormone antagonists, cell attachment mediators (such as RGD), growth factors or recombinant growth factors and fragments and variants thereof, cytokines, enzymes, antioxidants, antibiotics or antimicrobial compounds, anti-inflammation agents, antifungals, viruses, antivirals, toxins, prodrugs, drugs, dyes, amino acids, vitamins, chemotherapeutic agents, small molecules, and combinations thereof. The agent can also be a combination of any of the above-mentioned active agents.

As used herein, the term “therapeutic agent” means a molecule, group of molecules, complex or substance administered to an organism for diagnostic, therapeutic, preventative medical, or veterinary purposes. As used herein, the term “therapeutic agent” includes a “drug” or a “vaccine.” This term include externally and internally administered topical, localized and systemic human and animal pharmaceuticals, treatments, remedies, nutraceuticals, cosmeceuticals, biologicals, devices, diagnostics and contraceptives, including preparations useful in clinical and veterinary screening, prevention, prophylaxis, healing, wellness, detection, imaging, diagnosis, therapy, surgery, monitoring, cosmetics, prosthetics, forensics and the like. This term can also be used in reference to agriceutical, workplace, military, industrial and environmental therapeutics or remedies comprising selected molecules or selected nucleic acid sequences capable of recognizing cellular receptors, membrane receptors, hormone receptors, therapeutic receptors, microbes, viruses or selected targets comprising or capable of contacting plants, animals and/or humans. This term can also specifically include nucleic acids and compounds comprising nucleic acids that produce a therapeutic effect, for example deoxyribonucleic acid (DNA), ribonucleic acid (RNA), or mixtures or combinations thereof, including, for example, DNAnanoplexes.

The term “therapeutic agent” also includes an agent that is capable of providing a local or systemic biological, physiological, or therapeutic effect in the biological system to which it is applied. For example, the therapeutic agent can act to control infection or inflammation, enhance cell growth and tissue regeneration, control tumor growth, act as an analgesic, promote anti-cell attachment, and enhance bone growth, among other functions. Other suitable therapeutic agents can include anti-viral agents, hormones, antibodies, or therapeutic proteins. Other therapeutic agents include prodrugs, which are agents that are not biologically active when administered but, upon administration to a subject are converted to biologically active agents through metabolism or some other mechanism. Additionally, a silk-based drug delivery composition can contain combinations of two or more therapeutic agents.

A therapeutic agent can include a wide variety of different compounds, including chemical compounds and mixtures of chemical compounds, e.g., small organic or inorganic molecules; saccharines; oligosaccharides; polysaccharides; biological macromolecules, e.g., peptides, proteins, and peptide analogs and derivatives; peptidomimetics; antibodies and antigen binding fragments thereof; nucleic acids; nucleic acid analogs and derivatives; an extract made from biological materials such as bacteria, plants, fungi, or animal cells; animal tissues; naturally occurring or synthetic compositions; and any combinations thereof. In some embodiments, the therapeutic agent is a small molecule.

As used herein, the term “small molecule” can refer to compounds that are “natural product-like,” however, the term “small molecule” is not limited to “natural product-like” compounds. Rather, a small molecule is typically characterized in that it contains several carbon-carbon bonds, and has a molecular weight of less than 5000 Daltons (5 kDa), preferably less than 3 kDa, still more preferably less than 2 kDa, and most preferably less than 1 kDa. In some cases it is preferred that a small molecule have a molecular weight equal to or less than 700 Daltons.

Exemplary therapeutic agents include, but are not limited to, those found in Harrison's Principles of Internal Medicine, 13^{th} Edition, Eds. T. R. Harrison et al. McGraw-Hill N.Y., N.Y.; Physicians Desk Reference, 50^{th} Edition, 1997, Oradell N.J., Medical Economics Co.; Pharmacological Basis of Therapeutics, 8^{th} Edition, Goodman and Gilman, 1990; United States Pharmacopeia, The National Formulary, USP XII NF XVII, 1990, the complete contents of all of which are incorporated herein by reference.

Therapeutic agents include the herein disclosed categories and specific examples. It is not intended that the category be limited by the specific examples. Those of ordinary skill in the art will recognize also numerous other compounds that fall within the categories and that are useful according to the present disclosure. Examples include a radiosensitizer, a steroid, a xanthine, a beta-2-agonist bronchodilator, an anti-inflammatory agent, an analgesic agent, a calcium antagonist, an angiotensin-converting enzyme inhibitors, a beta-blocker, a centrally active alpha-agonist, an alpha-1-antagonist, an anticholinergic/antispasmodic agent, a vasopres sin analogue, an antiarrhythmic agent, an antiparkinsonian agent, an antiangina/antihypertensive agent, an anticoagulant agent, an antiplatelet agent, a sedative, an ansiolytic agent, a peptidic agent, a biopolymeric agent, an antineoplastic agent, a laxative, an antidiarrheal agent, an antimicrobial agent, an antifingal agent, a vaccine, a protein, or a nucleic acid. In a further aspect, the pharmaceutically active agent can be coumarin, albumin, steroids such as betamethasone, dexamethasone, methylprednisolone, prednisolone, prednisone, triamcinolone, budesonide, hydrocortisone, and pharmaceutically acceptable hydrocortisone derivatives; xanthines such as theophylline and doxophylline; beta-2-agonist bronchodilators such as salbutamol, fenterol, clenbuterol, bambuterol, salmeterol, fenoterol; antiinflammatory agents, including antiasthmatic anti-inflammatory agents, antiarthritis antiinflammatory agents, and non-steroidal antiinflammatory agents, examples of which include but are not limited to sulfides, mesalamine, budesonide, salazopyrin, diclofenac, pharmaceutically acceptable diclofenac salts, nimesulide, naproxene, acetaminophen, ibuprofen, ketoprofen and piroxicam; analgesic agents such as salicylates; calcium channel blockers such as nifedipine, amlodipine, and nicardipine; angiotensin-converting enzyme inhibitors such as captopril, benazepril hydrochloride, fosinopril sodium, trandolapril, ramipril, lisinopril, enalapril, quinapril hydrochloride, and moexipril hydrochloride; beta-blockers (i.e., beta adrenergic blocking agents) such as sotalol hydrochloride, timolol maleate, esmolol hydrochloride, carteolol, propanolol hydrochloride, betaxolol hydrochloride, penbutolol sulfate, metoprolol tartrate, metoprolol succinate, acebutolol hydrochloride, atenolol, pindolol, and bisoprolol fumarate; centrally active alpha-2-agonists such as clonidine; alpha-1-antagonists such as doxazosin and prazosin; anticholinergic/antispasmodic agents such as dicyclomine hydrochloride, scopolamine hydrobromide, glycopyrrolate, clidinium bromide, flavoxate, and oxybutynin; vasopressin analogues such as vasopressin and desmopressin; antiarrhythmic agents such as quinidine, lidocaine, tocamide hydrochloride, mexiletine hydrochloride, digoxin, verapamil hydrochloride, propafenone hydrochloride, flecamide acetate, procainamide hydrochloride, moricizine hydrochloride, and disopyramide phosphate; antiparkinsonian agents, such as dopamine, L-Dopa/Carbidopa, selegiline, dihydroergocryptine, pergolide, lisuride, apomorphine, and bromocryptine; antiangina agents and antihypertensive agents such as isosorbide mononitrate, isosorbide dinitrate, propranolol, atenolol and verapamil; anticoagulant and antiplatelet agents such as Coumadin, warfarin, acetylsalicylic acid, and ticlopidine; sedatives such as benzodiazapines and barbiturates; ansiolytic agents such as lorazepam, bromazepam, and diazepam; peptidic and biopolymeric agents such as calcitonin, leuprolide and other LHRH agonists, hirudin, cyclosporin, insulin, somatostatin, protirelin, interferon, desmopres sin, somatotropin, thymopentin, pidotimod, erythropoietin, interleukins, melatonin, granulocyte/macrophage-CSF, and heparin; antineoplastic agents such as etoposide, etoposide phosphate, cyclophosphamide, methotrexate, 5-fluorouracil, vincristine, doxorubicin, cisplatin, hydroxyurea, leucovorin calcium, tamoxifen, flutamide, asparaginase, altretamine, mitotane, and procarbazine hydrochloride; laxatives such as senna concentrate, casanthranol, bisacodyl, and sodium picosulphate; antidiarrheal agents such as difenoxine hydrochloride, loperamide hydrochloride, furazolidone, diphenoxylate hdyrochloride, and microorganisms; vaccines such as bacterial and viral vaccines; antimicrobial agents such as penicillins, cephalosporins, and macrolides, antifungal agents such as imidazolic and triazolic derivatives; and nucleic acids such as DNA sequences encoding for biological proteins, and antisense oligonucleotides.

Exemplary antibiotics suitable for use herein include, but are not limited to, aminoglycosides (e.g., neomycin), ansamycins, carbacephem, carbapenems, cephalosporins (e.g., cefazolin, cefaclor, cefditoren, cefditoren, ceftobiprole), glycopeptides (e.g., vancomycin), macrolides (e.g., erythromycin, azithromycin), monobactams, penicillins (e.g., amoxicillin, ampicillin, cloxacillin, dicloxacillin, flucloxacillin), polypeptides (e.g., bacitracin, polymyxin B), quinolones (e.g., ciprofloxacin, enoxacin, gatifloxacin, ofloxacin, etc.), sulfonamides (e.g., sulfasalazine, trimethoprim, trimethoprim-sulfamethoxazole (co-trimoxazole)), tetracyclines (e.g., doxycyline, minocycline, tetracycline, etc.), chloramphenicol, lincomycin, clindamycin, ethambutol, mupirocin, metronidazole, pyrazinamide, thiamphenicol, rifampicin, thiamphenicl, dapsone, clofazimine, quinupristin, metronidazole, linezolid, isoniazid, fosfomycin, or fusidic acid.

Exemplary cells suitable for use herein may include, but are not limited to, progenitor cells or stem cells (e.g., bone marrow stromal cells), ligament cells, smooth muscle cells, skeletal muscle cells, cardiac muscle cells, epithelial cells, endothelial cells, urothelial cells, fibroblasts, myoblasts, chondrocytes, chondroblasts, osteoblasts, osteoclasts, keratinocytes, hepatocytes, bile duct cells, pancreatic islet cells, thyroid, parathyroid, adrenal, hypothalamic, pituitary, ovarian, testicular, salivary gland cells, adipocytes, and precursor cells.

Exemplary antibodies include, but are not limited to, abciximab, adalimumab, alemtuzumab, basiliximab, bevacizumab, cetuximab, certolizumab pegol, daclizumab, eculizumab, efalizumab, gemtuzumab, ibritumomab tiuxetan, infliximab, muromonab-CD3, natalizumab, ofatumumab omalizumab, palivizumab, panitumumab, ranibizumab, rituximab, tositumomab, trastuzumab, altumomab pentetate, arcitumomab, atlizumab, bectumomab, belimumab, besilesomab, biciromab, canakinumab, capromab pendetide, catumaxomab, denosumab, edrecolomab, efungumab, ertumaxomab, etaracizumab, fanolesomab, fontolizumab, gemtuzumab ozogamicin, golimumab, igovomab, imciromab, labetuzumab, mepolizumab, motavizumab, nimotuzumab, nofetumomab merpentan, oregovomab, pemtumomab, pertuzumab, rovelizumab, ruplizumab, sulesomab, tacatuzumab tetraxetan, tefibazumab, tocilizumab, ustekinumab, visilizumab, votumumab, zalutumumab, and zanolimumab.

Exemplary enzymes suitable for use herein include, but are not limited to, peroxidase, lipase, amylose, organophosphate dehydrogenase, ligases, restriction endonucleases, ribonucleases, DNA polymerases, glucose oxidase, laccase, and the like.

Additional active agents to be used herein include cell growth media, such as Dulbecco's Modified Eagle Medium, fetal bovine serum, non-essential amino acids and antibiotics; growth and morphogenic factors such as fibroblast growth factor, transforming growth factors, vascular endothelial growth factor, epidermal growth factor, platelet derived growth factor, insulin-like growth factors), bone morphogenetic growth factors, bone morphogenetic-like proteins, transforming growth factors, nerve growth factors, and related proteins (growth factors are known in the art, see, e.g., Rosen & Thies, CELLULAR & MOLECULAR BASIS BONE FORMATION & REPAIR (R.G. Landes Co.); anti-angiogenic proteins such as endostatin, and other naturally derived or genetically engineered proteins; polysaccharides, glycoproteins, or lipoproteins; anti-infectives such as antibiotics and antiviral agents, chemotherapeutic agents (i.e., anticancer agents), anti-rejection agents, analgesics and analgesic combinations, anti-inflammatory agents, and steroids.

In some embodiments, the active agent can also be an organism such as a bacterium, fungus, plant or animal, or a virus. Moreover, the active agent may include neurotransmitters, hormones, intracellular signal transduction agents, pharmaceutically active agents, toxic agents, agricultural chemicals, chemical toxins, biological toxins, microbes, and animal cells such as neurons, liver cells, and immune system cells. The active agents may also include therapeutic compounds, such as pharmacological materials, vitamins, sedatives, hypnotics, prostaglandins and radiopharmaceuticals.

Additional applications for the articles fabricated using the methods described herein can include photomechanical actuation, electro-optic fibers, and smart materials.

When the silk fibers of the present invention are used in the textile, medical suture materials or tissue materials, either separately or combined into a composite, stimulus can be incorporated in the aforementioned method of producing the textile medical suture materials or tissue materials. For example, chemical stimuli, mechanical stimuli, electrical stimuli, or electromagnetic stimuli can also be incorporated herein. Because the silk fiber of the invention possess light-transmission property, the silk fiber contained in the textile, medical suture materials or tissue materials can be used to transmit the optical signals that may be from the stimuli or converted from the stimuli originated from the environment (e.g., tissue, organ or cells when used as implant materials) and influence the properties of the textile, suture or tissue materials. Alternatively, silk optical fiber can be used to transmit the optical signal to the applied medium, such as cells or tissues when used as implant materials, and modulate the activities of the cells or tissues. For example, cell differentiation is known to be influenced by chemical stimuli from the environment, often produced by surrounding cells, such as secreted growth or differentiation factors, cell-cell contact, chemical gradients, and specific pH levels, to name a few. Some stimuli are experienced by more specialized types of tissues (e.g., the electrical stimulation of cardiac muscle). The application of such stimuli that may be directly or indirectly transmitted by optical signal is expected to facilitate cell differentiations.

Additionally, a controlled drug delivery system can be made available by incorporating the fabricated article into the system, for example, the drug administration and release can be controlled in a manner that precisely matches physiological needs through the external stimuli applied on the fabricated article.

In some embodiments, the fabricated article is a fiber, a foam, or a film.

### Exemplary Embodiments for Fabricating a Silk Fiber

In some embodiments, the method described herein can be used for fabricating a silk fiber. In some embodiments, the method for fabricating a silk fiber comprises: (i) pouring a silk fibroin solution into a mold to form a fiber; (ii) holding the mold at a temperature from about −30° C. to about 25° C. for a period of time; (iii) removing the fiber from the mold; and (iv) optionally further processing the fiber.

In some other embodiments, the method for fabricating a silk fiber comprises: (i) subjecting a silk fibroin solution to a gelation process; (ii) at least partially removing a geled portion of the silk fibroin solution from the silk fibroin solution; (iii) heating the removed geled portion to reduce its viscosity and pouring at least part of the heated geled portion into a mold; (iv) holding the mold at a temperature from about −30° C. to about 25° C. for a period of time; (v) removing the fiber from the mold; and (vi) optionally further processing the fiber.

In yet some other embodiments, the method for fabricating a silk fiber comprises: (i) subjecting a silk fibroin solution to a gelation process; (ii) at least partially removing a geled portion of the silk fibroin solution from the silk fibroin solution; (iii) pouring a non-gelated portion from step (ii) into a mold to form a fiber; (iv) holding the mold at a temperature from about −30° C. to about 25° C. for a period of time; (v) removing the fiber from the mold; and (vi) optionally further processing the fiber

In still some other embodiments, the method for fabricating a silk fiber comprises: (i) incubating a silk fibroin solution at a temperature from about −30° C. to about 25° C. for a first period of time; (ii) pouring the silk fibroin solution from step (i) into a mold to form a fiber; (iii) holding the mold at a temperature from about −30° C. to about 25° C. for a second period of time; (iv) removing the fiber from the mold; and (v) optionally further processing the fiber.

A silk fiber can be further processed by applying pressure to the fiber and drawing the fiber along its elongated axis. This drawing process can be repeated 1 to about a million times. For example, the drawing process can be repeated from 1 to about 100,000; from 1 to about 10,000; from 1 to about 5,000; from 1 to about 1,000; 1 to about 500; 1 to about 400; 1 to about 300; 1 to about 250; 1 to about 200; 1 to about 150; 1 to about 100; 1 to about 75; 1 to about 50; 1 to about 25; or 1 to about 10 times.

A fabricated silk fiber can be coated with a composition comprising a polymer, e.g., a protein, such as sericin. The coated fibers have enhanced mechanical properties.

In some embodiments, the molded article can be coated with a composition comprising a polymer. Without wising to be bound by a theory, coating the molded article with a polymer provides enhanced properties. In some embodiments, the polymer is sericin.

### Exemplary Embodiments for Fabricating a Silk Foam

In some embodiments, the method described herein can be used for fabricating a silk foam. As used herein the term “foam” is intended to mean a light substance. As used herein, the term “foam” includes solid porous foams, reticulated foams, water-disintegratable foams, open-cell foams, and closed-cell foams. A foam can have a density ranging from about 1 pound per square feet (pcf) to about 3 pcf.

In some embodiments, the method for fabricating a silk foam comprises: (i) pouring a silk fibroin solution into a mold; and (ii) holding the mold at a temperature from about −30° C. to about 25° C. for a period of time.

In some other embodiments, the method for fabricating a silk foam comprises: (i) subjecting a silk fibroin solution to a gelation process; (ii) at least partially removing a geled portion of the silk fibroin solution from the silk fibroin solution; and (iii) incubating a non-gelated portion from step (ii) at a temperature from about −30° C. to about 25° C. for a period of time.

In yet some other embodiments, the method for fabricating a silk foam comprises: (i) subjecting a silk fibroin solution to a gelation process; (ii) at least partially removing a geled portion of the silk fibroin solution from the silk fibroin solution; (iii) heating the removed geled portion to reduce its viscosity and pouring the heated geled portion into a mold; and (iv) holding the mold at a temperature from about −30° C. to about 25° C. for a period of time.

In still some other embodiments, the method for fabricating a silk foam comprises: (i) incubating a silk fibroin solution at pouring a temperature from about −30° C. to about 25° C. for a first period of time; (ii) pouring the silk fibroin solution from step (i) into a mold; and (iii) holding the mold at a temperature from about −30° C. to about 25° C. for a second period of time.

A silk foam fabricated using a method described herein can have a porosity of at least about 30%, at least about 40%, at least about 50%, at least about 60%, at least about 70%, at least about 80%, at least about 90%, or higher. Too high porosity can yield a silk foam with lower mechanical properties. Conversely, too low a porosity can yield a silk foam with high mechanical properties but may not be able to withstand physical constraints. One of skill in the art can adjust the porosity accordingly, based on a number of factors such as, but not limited to, desired mechanical properties. As used herein, the term “porosity” is a measure of void spaces in a material and is a fraction of volume of voids over the total volume, as a percentage between 0 and 100% (or between 0 and 1). Determination of porosity is well known to a skilled artisan, e.g., using standardized techniques, such as mercury porosimetry and gas adsorption, e.g., nitrogen adsorption.

The foam can have any pore size. As used herein, the term “pore size” refers to a diameter or an effective diameter of the cross-sections of the pores. The term “pore size” can also refer to an average diameter or an average effective diameter of the cross-sections of the pores, based on the measurements of a plurality of pores. The effective diameter of a cross-section that is not circular equals the diameter of a circular cross-section that has the same cross-sectional area as that of the non-circular cross-section. In some embodiments, the pores of a foam can have a size distribution ranging from about 50 nm to about 1000 μm, from about 250 nm to about 500 μm, from about 500 nm to about 250 μm, from about 1 μm to about 200 μm, from about 10 μm to about 150 μm, or from about 50 μm to about 100 μm. In some embodiments, the silk fibroin can be swellable when the silk fibroin tube is hydrated. The sizes of the pores can then change depending on the water content in the silk fibroin. The pores can be filled with a fluid such as water or air.

The inventor have discovered that pore size of a foam can be controlled by the temperature or freezing-rate used for molding. Thus, a foam produced by method described herein can a comprise smaller pores near the outer surface of the foam and larger pores in the interior of the foam. Alternatively, or in addition, one side of the foam can comprise smaller pores and the other side can comprise larger pores. As used herein, the terms “smaller” and “larger” are used in context of each other, i.e. relative to each other.

### Exemplary Embodiments for Fabricating a Silk Film

In some embodiments, the methods described herein can be used for fabricating, silk films. As used herein the term “film” refers to an article of manufacture whose width exceeds its height. A film can be of any thickness. For example, a film fabricated using a method described herein can range in thickness from about 1 nm to about 10 cm. In some embodiments, the film can have thickness in the nanometer range, e.g., from about 1 nm to about 1000 nm, from about 25 nm to about 100 nm. In some embodiments, the film can have a thickness in the micrometer range, e.g., from about 1 μm to about 1000 μm. In some embodiments, the film can have a thickness in the millimeter range, e.g., from about 1 mm to about 1000 mm.

In some embodiments, the method for fabricating a silk film comprises: (i) coating a surface of a solid-substrate with a silk fibroin solution; and (ii) incubating the coated substrate at a temperature from about −30° C. to about 25° C. for a period of time.

In some other embodiments, the method for fabricating a silk film comprises: (i) subjecting a silk fibroin solution to a gelation process; (ii) at least partially removing a geled portion of the silk fibroin solution from the silk fibroin solution; and (iii) coating a surface of a solid substrate with a non-gelated portion from step (ii); and incubating the coated substrate at a temperature from about −30° C. to about 25° C. for a period of time.

In yet some other embodiments, the method for fabricating a silk film comprises: (i) subjecting a silk fibroin solution to a gelation process; (ii) at least partially removing a geled portion of the silk fibroin solution from the silk fibroin solution; (iii) heating the removed geled portion to reduce its viscosity and coating a surface of a solid substrate with the heated geled portion; and (iv) incubating the coated substrate at a temperature from about −30° C. to about 25° C. for a period of time.

In still some other embodiments, the method for fabricating a silk foam comprises: (i) incubating a silk fibroin solution at pouring a temperature from about −30° C. to about 25° C. for a first period of time; (ii) coating a surface of solid substrate with the silk fibroin solution from step (i); and (iii) incubating the coated substrate at a temperature from about −30° C. to about 25° C. for a period of time.

### Some Exemplary Applications of Materials Fabricated by the Method

Because of their unique properties, spider dragline silks have been considered for industrial applications such as for parachutes, protective clothing, and for composite materials. Many biomedical applications, such as sutures for wounds, coatings for implants, drug carriers, and scaffolds in tissue engineering have been considered as well. A significant limitation with spider silks is the difficulty in farming spiders; their territorial and aggressive behavior limits the ability to generate large amounts of native spider silk (X., X.-X., Oian, Z.-G., Ki, C. S., Park, Y. H., Kaplan, D. L., and Lee, S. Y., Native-sized recombinant spider silk protein produced in metabolically engineered Escherichia coli results in a strong fiber, Proc of the National Academy of Sciences (2010), 107, pp. 14059-14063). Regenerated silk geometries not only can be derived from silkworm cocoons, which allows for larger volumes to be created, but the material can be easily customized for specific applications; e.g., antibiotics or growth factors could be incorporated into a regenerate silk fiber to make an intriguing suture material. Some of the regenerated geometries described in this document exhibit the ability to transmit light. In combination with tremendous mechanical properties, this suggests the ability to create all-polymer composites, smart fabrics, and impressive yarns and ropes. Given the ease of creating silk-based textiles, there are a number of applications in protective material, such as for making bullet-proof vests. There is evidence that light transmittance is affected by the amount of material elongation. This can be used for load/stress monitoring application. Given the excellent outcomes from mechanical drawing and rolling of the regenerated silk fibers, many material processing modalities can be used, such as press-forming or thread rolling to create screws and other machine elements, stamping and embossing to create unusual thin geometries with controlled morphologies and surface patterns, and extruding to create various prismatic bar-like geometries.

Silk egel foam or freezer-processed silk foam can be used for various applications. Flexible, open-celled foam can be used in filling defects within the body, such as in bone (osteochondrosis) or soft tissue. The compressed foam can be packed into a defect, expanding to stay in place. The open-cell architecture can provide space for drugs, antibiotics, other materials such as hydrogels, or cells for tissue re-growth. Thin foam strips can be created to act as bandages, covering minor wounds. An egel-generated film can be fabricated which has the consistency of a highly stretchable elastic material when hydrated; the consistency of writing paper when dry. In a hydrated state, the film can be used as an in vivo wrap for a fracture or an external covering/wrap for a burn or other wound. In either a foam or film/paper-like form, the material can be used as a component in a protein-based composite material. As in more traditional foam-core composites, the foam could provide the center bulk of a structure material that could provide impressive mechanical properties, yet offer the advantages of silk material and concomitant benefits of biodegradability, biocompatibility, and the ability to contain drugs, antibiotics, growth factors, etc. In one application, the material can be incorporated in soft-bodied robots that can be used for in vivo diagnostic and therapeutic purposes. The material can be used as a biodegradable alternative to traditional foam core or non-biodegradable products, such as Styrofoam coffee cups and food containers or packaging material.

Embodiments of the various aspects described herein can be illustrated by the following numbered paragraphs.
1. A method of fabricating an article from silk fibroin, the method comprising:
   (i) providing a silk fibroin solution into a mold; and
   (ii) holding the mold at a temperature from about −30° C. to about 25° C. for a period of time.
2. The method of paragraph 1, wherein the silk fibroin solution comprises from about 1 to about 50 wt % silk.
3. The method of any of paragraphs 1-3, wherein the period of time is at least 1 hour
4. The method of paragraph 4, wherein the period of time is from about 1 hour to about 6 months.
5. The method of paragraph 1, further comprising a post-processing step.
6. The method of paragraph 5, wherein the post-processing step comprises drying, rehydrating, coating, soaking in a solution, mechanical processing, or freeze-drying the article.
7. The method of any of paragraphs 1-6, further comprising incubating the silk fibroin solution at a temperature from about −30° C. to about 25° C. for a period of time before coating the surface of the mold.
8. The method of any of paragraphs 1-7, wherein the silk fibroin solution comprises an additive in addition to silk fibroins.
9. The method of paragraph 8, wherein the additive is selected from the group consisting of small organic or inorganic molecules; saccharines; oligosaccharides; polysaccharides; biological macromolecules, e.g., peptides, proteins, and peptide analogs and derivatives; peptidomimetics; antibodies and antigen binding fragments thereof; nucleic acids; nucleic acid analogs and derivatives; glycogens or other sugars; immunogens; antigens; an extract made from biological materials such as bacteria, plants, fungi, or animal cells; animal tissues; naturally occurring or synthetic compositions; and any combinations thereof.
10. The method of paragraph 1, wherein the article is a film, a foam, a fiber, a coating, a gel, a hydrogel, a sponge, a 3D-scaffold, and the like.
11. The method of any of paragraph 1-10, further comprising preprocessing the silk fibroin solution before contacting with the mold.
12. The method of paragraph 11, wherein said preprocessing comprises increasing viscosity of the silk fibroin solution.
13. The method of paragraph 12, wherein said preprocessing comprises electrogelation, pH induced gelation, shear stress induced gelation, or a combination thereof.
14. The method of any of paragraphs 12 or 13, further comprising heating the silk fibroin solution before pouring into the mold.
15. An article prepared by a method according to any of paragraphs 1-14.
16. The article of paragraph 15, wherein the article is a fiber, a gel, a foam, a sponge, or a film.
17. A method of fabricating a silk fiber, the method comprising:
   (i) providing a silk fibroin solution in a mold to form a fiber;
   (ii) holding the mold at a temperature from about −30° C. to about 25° C. for a period of time;
   (iii) removing the fiber from the mold; and
   (iv) optionally further processing the fiber.
18. A method of fabricating a silk fiber, the method comprising:
   (i) subjecting a silk fibroin solution to a gelation process;
   (ii) partially removing at least a geled portion of the silk fibroin solution from the silk fibroin solution;
   (iii) heating the geled portion;
   (iv) pouring the heated geled portion from step (iii) into a mold to form a fiber;
   (v) holding the mold at a temperature from about −30° C. to about 25° C. for a period of time;
   (vi) removing the fiber from the mold; and
   (vii) optionally further processing the fiber.
19. A method of fabricating a silk fiber, the method comprising:
   (i) incubating a silk fibroin solution at pouring a temperature from about −30° C. to about 25° C. for a first period of time;
   (ii) pouring the silk fibroin solution from step (i) into a mold to form a fiber; and
   (iii) holding the mold at a temperature from about −30° C. to about 25° C. for a second period of time;
   (iv) removing the fiber from the mold; and
   (v) optionally further processing the fiber.
20. A method of fabricating a silk foam, the method comprising
   (i) subjecting a silk fibroin solution to a gelation process;
   (ii) removing geled portion of the silk fibroin solution from the silk fibroin solution; and
   (iii) incubating non-gelated portion from step (ii) at a temperature from about −30° C. to about 25° C. for a period of time.
21. A method of fabricating a silk foam, the method comprising
   (i) pouring a silk fibroin solution into a mold; and
   (ii) holding the mold at a temperature from about −30° C. to about 25° C. for a period of time.
22. A method of fabricating a silk film, the method comprising
   (i) subjecting a silk fibroin solution to a gelation process;
   (ii) removing geled portion of the silk fibroin solution from the silk fibroin solution;
   (iii) coating a surface of a solid-substrate with the non-gelated portion of the silk fibroin solution; and
   (iv) incubating the coated substrate at a temperature from about −30° C. to about 25° C. for a period of time.
23. A method of fabricating a silk film, the method comprising
   (iii) coating a surface of a solid-substrate with a silk fibroin solution; and
   (iv) incubating the coated substrate at a temperature from about −30° C. to about 25° C. for a period of time.
24. The method of any of paragraphs 17-23, wherein the silk fibroin solution comprises from about 1 to about 50 wt % silk.
25. The method of any of paragraphs 17-24-3, wherein the period of time is at least 1 hour 26. The method of paragraph 25, wherein the period of time is from about 1 hour to about 6 months.
27. The method of any of paragraphs 17-26, further comprising a post-processing step.
28. The method of paragraph 27, wherein the post-processing step comprises drying, rehydrating, coating, soaking in a solution, mechanical processing, or freeze-drying the article.
29. The method of any of paragraphs 17-28, wherein the silk fibroin solution comprises an additive in addition to silk fibroins.
30. The method of paragraph 29, wherein the additive is selected from the group consisting of small organic or inorganic molecules; saccharines; oligosaccharides; polysaccharides; biological macromolecules, e.g., peptides, proteins, and peptide analogs and derivatives; peptidomimetics; antibodies and antigen binding fragments thereof; nucleic acids; nucleic acid analogs and derivatives; glycogens or other sugars; immunogens; antigens; an extract made from biological materials such as bacteria, plants, fungi, or animal cells; animal tissues; naturally occurring or synthetic compositions; and any combinations thereof.

### Some Selected Definitions

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments, and are not intended to limit the claimed invention, because the scope of the invention is limited only by the claims. Further, unless otherwise required by context, singular terms shall include pluralities and plural terms shall include the singular.

As used herein the terms “comprising” or “comprises” means “including” or “includes” and are used in reference to compositions, methods, and respective component(s) thereof, that are useful to the invention, yet open to the inclusion of unspecified elements, whether useful or not.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

Other than in the operating examples, or where otherwise indicated, all numbers expressing quantities of ingredients or reaction conditions used herein should be understood as modified in all instances by the term “about.” The term “about” when used in connection with percentages may mean±5% of the value being referred to. For example, about 100 means from 95 to 105.

The singular terms “a,” “an,” and “the” include plural referents unless context clearly indicates otherwise. Similarly, the word “or” is intended to include “and” unless the context clearly indicates otherwise. Thus for example, references to “the method” includes one or more methods, and/or steps of the type described herein and/or which will become apparent to those persons skilled in the art upon reading this disclosure and so forth.

Although methods and materials similar or equivalent to those described herein can be used in the practice or testing of this disclosure, suitable methods and materials are described herein. The abbreviation, “e.g.” is derived from the Latin exempli gratia, and is used herein to indicate a non-limiting example. Thus, the abbreviation “e.g.” is synonymous with the term “for example.”

As used herein, the term “small molecule” can refer to compounds that are “natural product-like,” however, the term “small molecule” is not limited to “natural product-like” compounds. Rather, a small molecule is typically characterized in that it contains several carbon-carbon bonds, and has a molecular weight of less than 5000 Daltons (5 kDa), preferably less than 3 kDa, still more preferably less than 2 kDa, and most preferably less than 1 kDa. In some cases it is preferred that a small molecule have a molecular weight equal to or less than 700 Daltons.

The terms “decrease”, “reduced”, “reduction”, “decrease” or “inhibit” are all used herein generally to mean a decrease by a statistically significant amount. However, for avoidance of doubt, “reduced”, “reduction” or “decrease” or “inhibit” means a decrease by at least 10% as compared to a reference level, for example a decrease by at least about 20%, or at least about 30%, or at least about 40%, or at least about 50%, or at least about 60%, or at least about 70%, or at least about 80%, or at least about 90% or up to and including a 100% decrease (e.g. absent level as compared to a reference sample), or any decrease between 10-100% as compared to a reference level.

The terms “increased”, “increase” or “enhance” or “activate” are all used herein to generally mean an increase by a statically significant amount; for the avoidance of any doubt, the terms “increased”, “increase” or “enhance” or “activate” means an increase of at least 10% as compared to a reference level, for example an increase of at least about 20%, or at least about 30%, or at least about 40%, or at least about 50%, or at least about 60%, or at least about 70%, or at least about 80%, or at least about 90% or up to and including a 100% increase or any increase between 10-100% as compared to a reference level, or at least about a 2-fold, or at least about a 3-fold, or at least about a 4-fold, or at least about a 5-fold or at least about a 10-fold increase, or any increase between 2-fold and 10-fold or greater as compared to a reference level.

The term “statistically significant” or “significantly” refers to statistical significance and generally means at least two standard deviation (2SD) away from a reference level. The term refers to statistical evidence that there is a difference. It is defined as the probability of making a decision to reject the null hypothesis when the null hypothesis is actually true.

To the extent not already indicated, it will be understood by those of ordinary skill in the art that any one of the various embodiments herein described and illustrated can be further modified to incorporate features shown in any of the other embodiments disclosed herein.

The disclosure is further illustrated by the following examples which should not be construed as limiting. It will be apparent to those skilled in the relevant art that various modifications, additions, substitutions, and the like can be performed without altering the spirit or scope of the invention, and such modifications and variations are encompassed within the scope of the invention as defined in the claims which follow. The examples are illustrative only, and are not intended to limit, in any manner, any of the aspects described herein. The following examples do not in any way limit the invention.

### EXAMPLES

### Example 1

### Molded Regenerated Silk Geometries Using Temperature Control and Mechanical Process

The following experiments were conducted according to various embodiments of the method described herein. These experiments explored various molding strategies to generate complex silk geometries. The results of these experiments demonstrate that a variety of geometries can be created for various applications using the methods described herein. The geometries created which have a wide range of applications.

### 1. Thin Film Construct

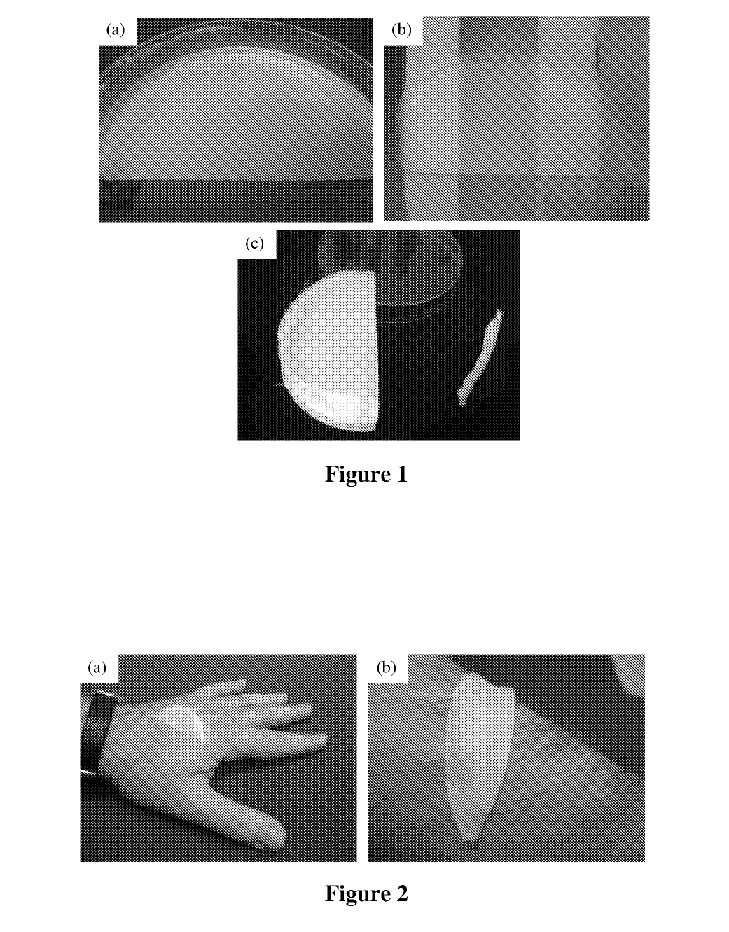

Silk electrogelation is a silk processing technique in which DC voltage is applied to a silk solution through submerged electrodes. Through the application of the DC field and resulting pH changes, the solution forms a more stable conformation with an elevation of silk I content. In this experiment, platinum electrodes and a Falcon tube were used to create gel from 8% w/v silk solution (25 VDC). After removing the gel by lifting the electrodes from the Falcon tube, the remaining silk solution was poured into a plastic Petri dish, forming a thin film. The dish was then placed in a freezer maintained at around 14° F. (−10° C.) for 8 days. After removal from the freezer, the solid film was semi-transparent with a slightly white color. The film had not contracted and still covered the bottom of the Petri dish. A razor blade was used to section the film in two, as shown in FIG. 1a. The half that was removed was seen to be very soft, flexible, and cool to the touch (FIG. 1b). After two hours at room temperature, the removed half dried and curled into a tight tube (FIG. 1c). The half remaining in the Petri dish dried in place. After removal from the dish, the bottom surface was seen to be very smooth. The film itself was very lightweight, flexible, and tough, with the consistency of writing paper.

### 2. On-Skin Adhesion

Given the moistness, softness, and coolness of the silk egel films after removal from freezing temperatures, the films can work well in wound covering. Accordingly, two strips of egel film were placed on a hand (FIG. 2a) and arm (FIG. 2b) to see the effect when exposed to room temperature conditions. A spray bottle was used to hydrate the film with milli-Q water. The films conformed easily to the arm geometry and were initially cool on the surface of the skin. Over a period of 10-20 minutes, the films dried somewhat and began to adhere to the skin surface. During removal, the films peeled off of the skin without leaving residual silk.

### 3. Re-Hydration and Stretching Experiment

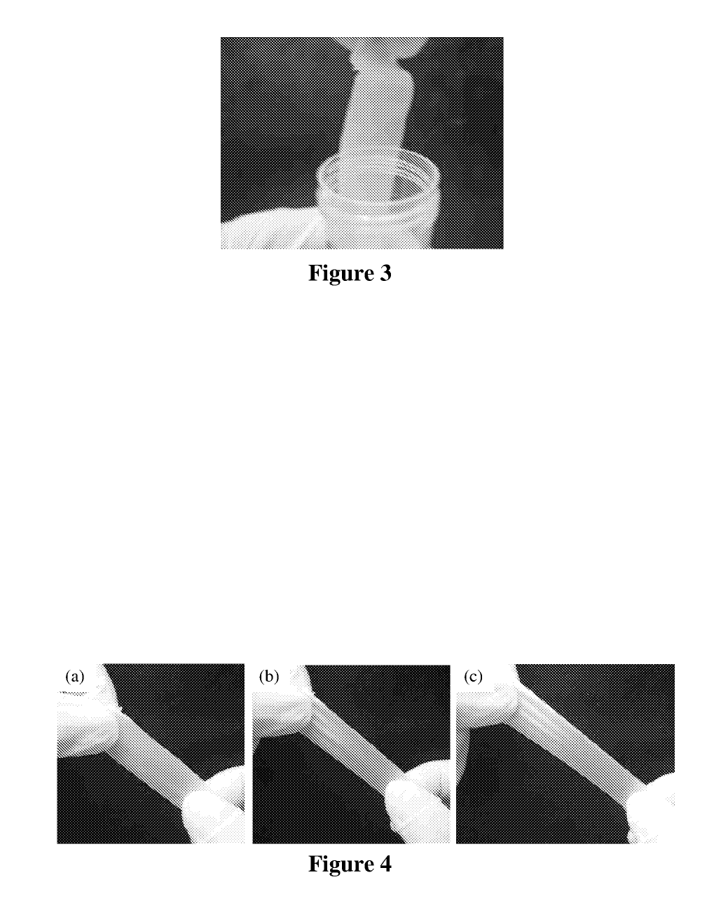

A strip of egel film was soaked in a Falcon tube containing milli-Q water. After 24 hours, the film was removed by hand (FIG. 3). While the film became very flexible after soaking, it was quite tough and had not solubilized in the water. The stiffness of the film was tested by stretching it by hand (FIGS. 4a-4c). The film was stretched roughly 50% before failure occurred. The failure initiation can be seen as a small lateral split midway along the sample in FIG. 4c.

### 4. Initial Molding of High Concentration Silk Screws and Nuts

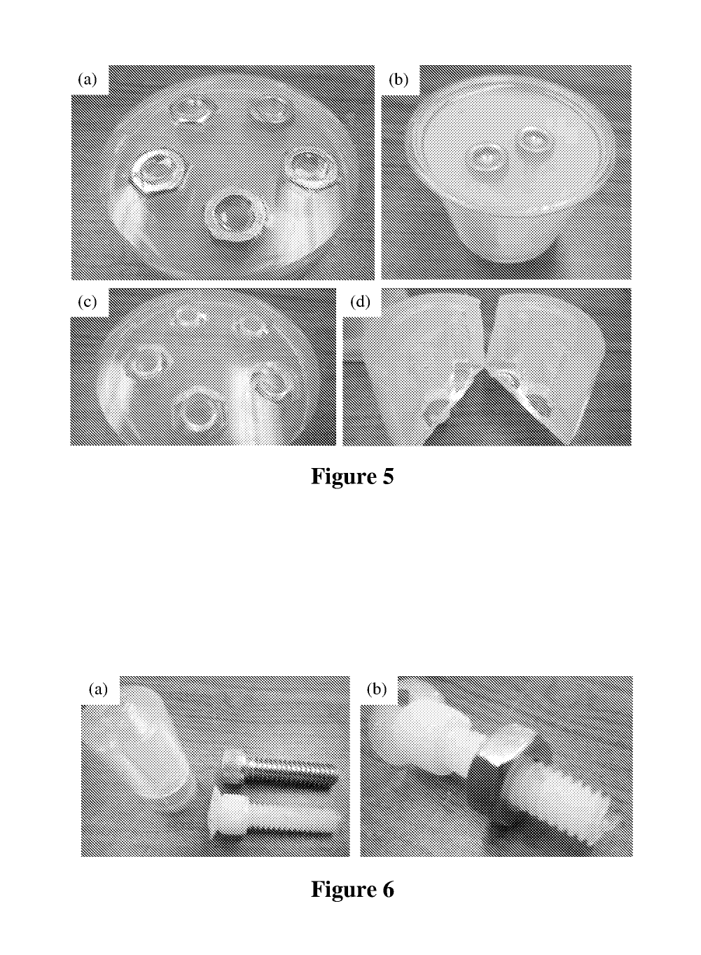

Molds of machine screws and nuts were fabricated using DragonSkin, a platinum-cured silicone rubber from Smooth-on, Inc. The two-part silicone mix was poured into plastic dishes containing five steel machine nuts and two machine screws (FIGS. 5a and 5b). After placing the dish in a 60° C. oven for two hours, the nuts could be easily separated from the cured DragonSkin, producing molding cavities (FIGS. 5c and 5d). Silk solution of approximately 20% w/v concentration was prepared using a standard protocol described elsewhere and poured into the molds. The molds were then stored at 5° C. in a laboratory refrigerator. After 7-10 days, the molded geometries were removed from the molds, aided by the pliability of the silicone molds. The actual molding time appears to be indirectly related to silk concentration; the higher the concentration, the shorter the time required in the refrigerator to create a molded solid material. After removal, the silk was still moist but in a solid state, with a well-defined geometry. The parts were solid enough that a steel machine nut could be screwed onto one of the silk screws (FIGS. 6a and 6b). The silk material was observed to have some pores in it, likely due to trapped air not escaping before silk solidification. The material was rubbery, with the ability to be bent and return to its original shape. The completed silk screws and nuts were then stored at room temperature to fully dry. During this drying, the geometry shrank and the material became hard and relatively brittle. When bending in the dry state, the silk screws exhibited fairly high strength, but failed with a sudden, brittle failure mode.

### 5. Initial Molding of High Concentration Silk Gears

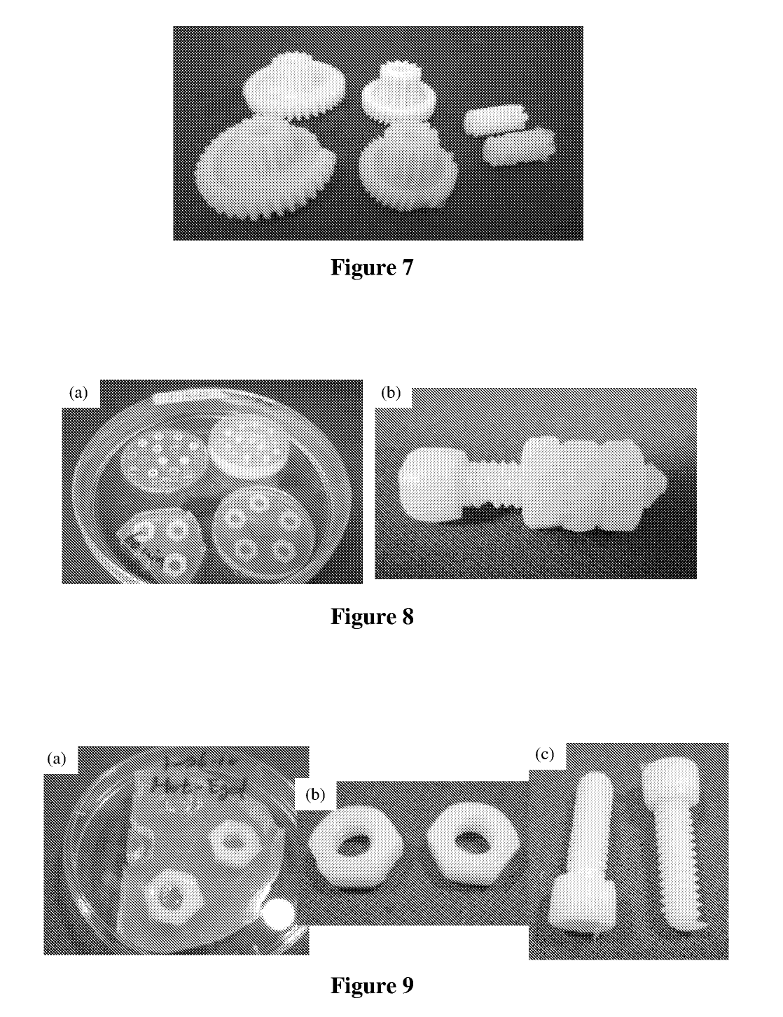

Using the same molding procedure outlined in Experiment 4 above, gears molds were fabricated by embedding two plastic spur gears and a plastic worm gear in platinum-cured DragonSkin silicone. After curing the silicone containing the screws in a 60° C. oven for two hours, the plastic gears were removed. Silk solution of approximately 20% w/v concentration was poured into the screw mold cavities. The molds were then stored at 5° C. in a laboratory refrigerator for about 7 days. As in Experiment 4, the material was removed from the mold while still somewhat wet, and had a rubbery consistency. After drying, the gears were observed to be stiff and brittle. FIG. 7 shows the plastic gears used as molding positives (top) and the molded silk gears (bottom). While the resulting gears had large defects due to pore formation and rough handling, this first outcome was very successful. The molding process can produce a silk gear with excellent detail. It was observed that work would need to be done to reduce the pores and improve the material toughness so handling would not cause damage.

### 6. Molding of Higher Concentration Silk Screws and Nuts

Platinum-cured DragonSkin silicone molds of machine screws and nuts were once again created (and re-used from Experiment 4 above). Molded silk screws and nuts were produced using a higher concentration of silk solution than in Experiments 4 and 5 above. Using a concentration of approximately 30% w/v silk solution, the nuts and screws shown in FIG. 8 were produced. It was observed qualitatively that the resulting parts were tougher than previously fabricated molded geometries, suggesting that the higher silk fibroin content in the solution can provide increased toughness. While some defects were still present (see middle nut in FIG. 8b), the geometries were stable enough in the wet state to be able to be screwed together. As before, the initially wet and rubbery material consistency would become stiff and brittle after drying.

7. Molding of 8% w/v Silk Solution with Hot Egel

Silk electrogelation, as discussed above, allows the rapid conversion of a silk solution to a meta-stable gel-phase using the direct application of DC voltage through the use of electrodes. In this experiment, molded silk screws and nuts were fabricated using electrogelated silk. Silk egel was formed in a simple test cell that consisted of a Falcon tube containing several ml of 8% w/v silk solution and two vertical platinum electrodes connected to a DC power supply. A volume of silk egel was produced by applying 25 volts DC through the electrodes for 10 minutes. The egel, which forms on the positive electrode and tends to stick to the electrode, was then transferred to a plastic syringe. Because shearing action caused by extruding the egel through a syringe needle can cause the meta-stable egel to convert to a beta-sheet conformation, the egel viscosity was dramatically decreased by heating the syringe to 60-70° C. with a Wagner heat gun. When egel is heated in this way, the viscosity decreases, but the original material properties return when the egel cools back to room temperature. The hot egel was ejected from the syringe into a platinum-cured DragonSkin silicone mold (FIG. 9a). The molds were then stored at 5° C. in a laboratory refrigerator for 2-3 days. After removal from the molds, the silk nuts and screws (FIGS. 9b and 9c) were observed to have fine geometric detail. However, the silk material was not as solid as the prior geometries produced using standard high concentration silk solution. The consistency was soft and mushy.

### 8. Molding of High Concentration Silk Gears

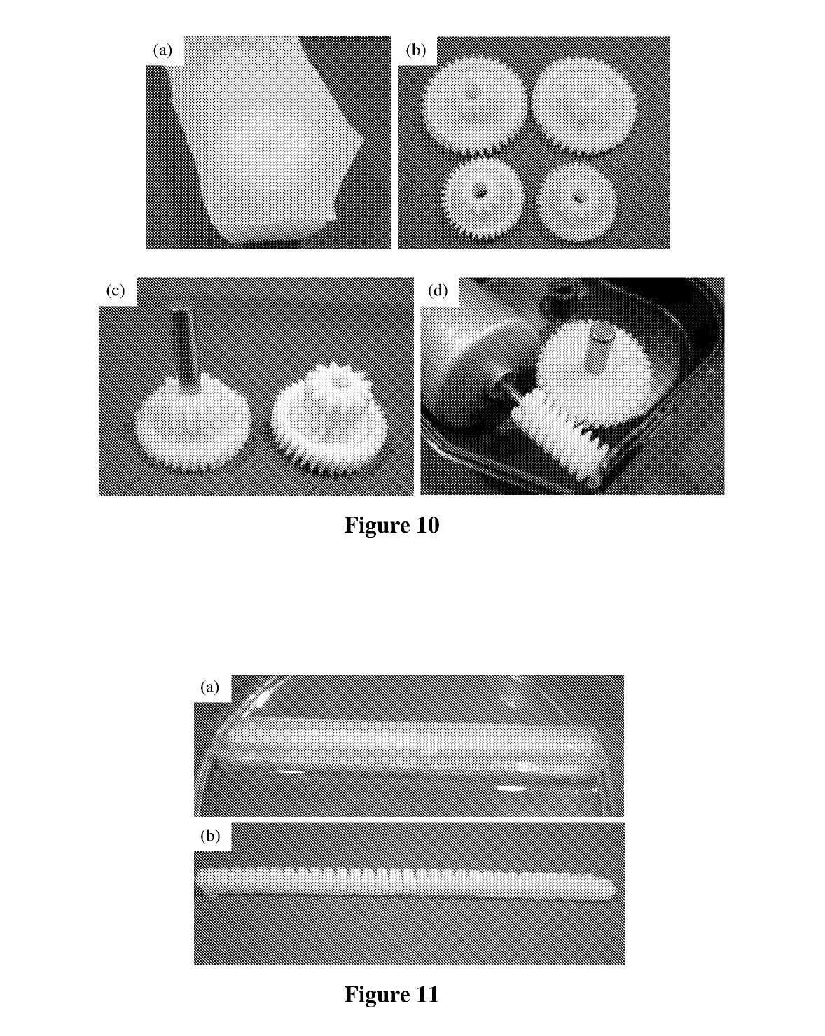

Platinum-cured DragonSkin silicone molds of plastic gears were used from Experiment 5. Molded silk spur and worm gears were produced using a very high concentration of silk solution. Using a concentration of approximately 45% w/v silk solution (which is very challenging to measure properly become of the extreme viscosity of silk solution at this concentration), the nuts and screws shown in FIG. 10 were produced. FIG. 10a shows the silk inside a spur gear mold. After removal from the molds (FIG. 10b), the silk gears exhibited excellent geometric stability (faithful representation of the complex gear geometry), with a fairly non-porous interior. The tough, rubbery consistency in the hydrated state provides gears that can be used in low load-bearing gear applications. FIG. 10c shows a silk spur gear mounted to a hardened steel shaft (with its plastic counterpart on the left). FIG. 10d shows the silk spur gear mounted in a gears DC motor housing, being driven by a plastic worm gear. This shows that hydrated fabricated silk gears can be used in a gear motor setup. When the silk gears are allow to fully dry, they shrink considerable, but maintain fairly stable geometry, with a stiff material consistency (data not shown).

### 9. Molding of Silk Soft Robot Body

A major research focus in the Tufts University Advanced Technology Laboratory has been the development of soft robots. The Tufts approach has been to create biomimetic robots that copy aspects of the Tobacco Hornworm caterpillar (manduca sexta). Therefore, robot bodies have been fabricated that mimic the general size, shape, and flexibility of a caterpillar. One long-term goal is to be able to create a completely biodegradable robot that have a better impact on the environment, allow clandestine operation, or operate within a human or animal body without need for extraction. Given this context, a silk body was fabricated using the silk molding strategies discussed above. As shown in FIG. 11a, a simple body mold was fabricated using platinum-cured DragonSkin silicone. Silk solution with approximately 40% w/v concentration was used. After storing at 5° C. in a laboratory refrigerator for approximately 14 days, the silk body was removed from the mold (FIG. 11b). While hydrated, the body was observed to be fairly tough and very flexible. It exhibited many properties seen in the silicone bodies produced previously by the soft-bodied robot research group. As discussed previously, when this silk construct was allowed to fully dry, significant shrinking occurred, and the geometry lost its ability to flex. The body was stored in a hydrated state (in a sealed dish with a small volume of pure water) for a period of one month. While the material properties stayed consistent over this month, some degradation was observed after about 3.5 weeks.

### 10. Drawing of a Tough Molded Regenerated Fiber

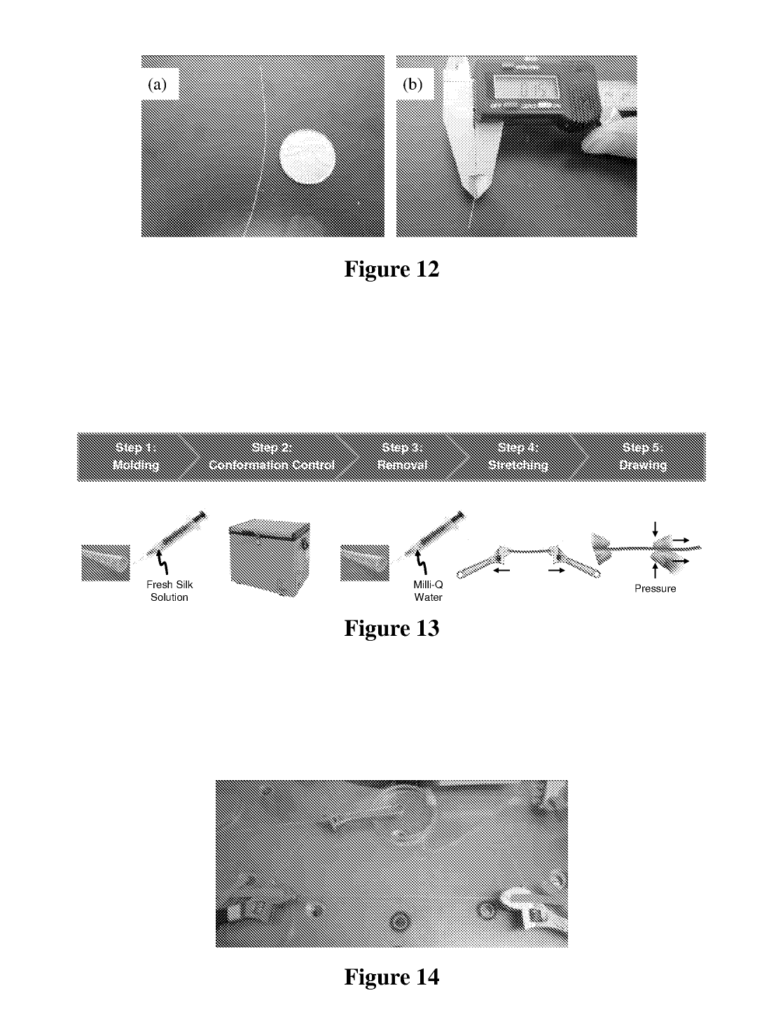

Silk solution made from Taiwanese cocoons was concentrated to ˜25% w/v. The silk was injected into a small diameter Tygon tube using a plastic syringe with a needle. The tube was stored in a freezer for 1-2 weeks at −5° C. Upon removal from the freezer, the molded material was removed from the tube by flushing the inner diameter with milli-Q water ejected from a syringe. The silk material was white in color, was stretchable, with the general consistency of boiled spaghetti. The ends of the fiber sample were clamped in Vise Grip clamps, providing slight tension. Before the fiber was allowed to dry, it was hand-drawn by dragging the thumb and forefinger of one hand down the length of the fiber while lateral pressure was applied by the two fingers. The fiber elongated during multiple drawing cycles, leading to a contraction in the diameter of the fiber (FIGS. 12a and 12b). The fiber was noticeably stiffer and stronger after a number of drawing cycles.

### 11. Additional Fabrication of Molded Regenerated Fibers

Based on the success of Experiment 10, more fibers were created by molding. Fresh silk solution (solution had been created from cocoon silk within 2 days of the experiment) was used. The process can be described in 5 steps, as shown in FIG. 13. In step 1, a molding approach is used in which a syringe injects the silk solution into approximately 18″ lengths of ( 1/32″ inner diameter) Tygon S-50-HL (silicone) tubing. After the tube ends were heat-sealed to prevent solution leaking, the tube was placed into a freezer set to −6° C. This second step is designed to effect a conformation change from the solution's random coil conformation to a more silk I-rich conformation. It should be noted that the freezer fluctuates approximately ±2.5° C. about the set-point (actual range likely −8 to −3° C.). The tube was stored undisturbed in the freezer for about 3 weeks (this is approximate; the sample was periodically monitored visually to detect solidification level). In step 3, the tube was then removed from the freezer, and allowed to heat up to room temperature. The material was flushed from the tube by using milli-Q (pure) water and hand pressure applied to a syringe. Care was taken to ensure the material would not be damaged when flushed from the tube. The material was very moist and rubbery in consistency. In step 4, each fiber was clamped in an adjustable clamp or wrench and stretched tight, as shown in FIG. 14. The fiber was suspended until most of the visible moisture dried. In step 5, hand-drawing was used to form fibers and to mechanically improve the fiber properties. The drawing was done by first holding the fiber with thumb and forefinger in one hand and drawing down the length of the fiber using thumb and forefinger on the other hand. These drawings cycles were repeated the desired number of times. While performing hand-drawing, it was noticed that the silk material, initially stiff, would stretch fairly easily until some limit seemed to be reached. Each drawing cycle was stopped when the limit appeared about to be reached. Stretching beyond the limit would lead to fiber failure.

The molded fibers were fairly robust after the initial stretch. It was noticed that the fibers would tend to be brittle as they dried out after removal from the clamps/wrenches. After several hundreds of drawing cycles were performed, the fibers seemed to become tougher (less brittle) and stronger.

### 12. Molded Regenerated Silk Ukulele String

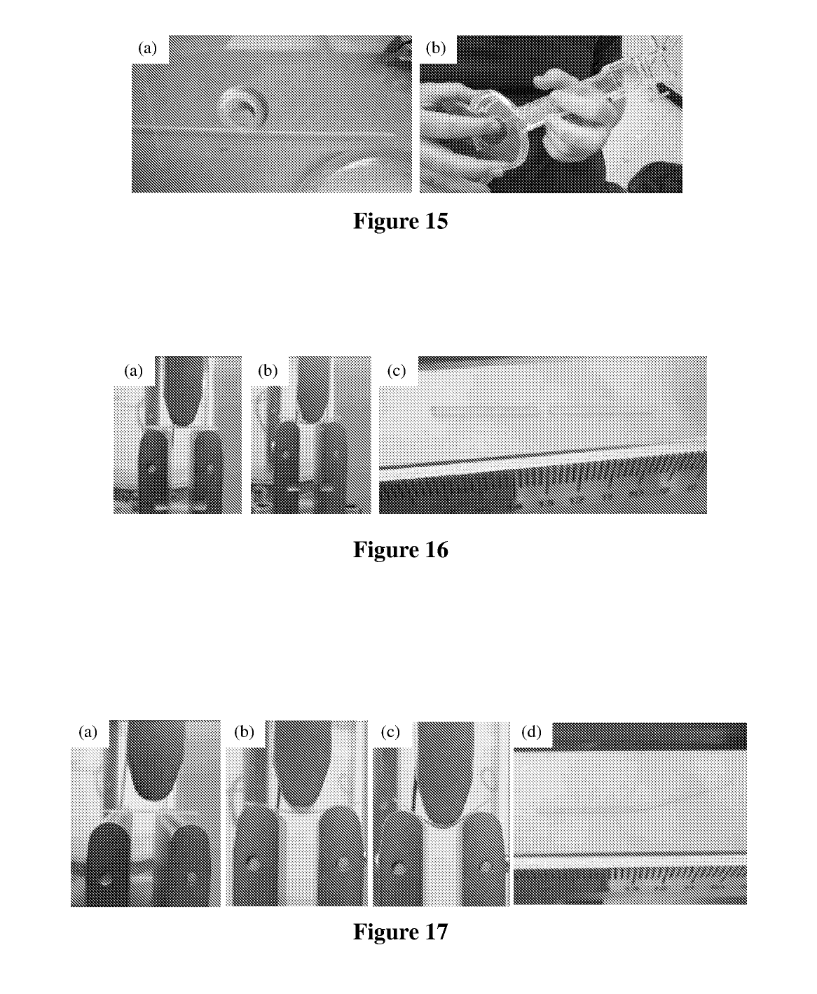

Molded regenerated silk fibers were observed to be fairly stiff and strong. To demonstrate these good material properties, a small ukulele was constructed by gluing together laser-cut acrylic pieces on a Trotec Speedy 300 laser engraver. A molded fiber, shown in FIG. 15a was fabricated and mounted to the ukulele. As shown in FIG. 15b, the fiber was sufficient to create a musical tone and the ukulele itself could be used to play crude musical numbers. The tuning mechanism could be used to tension the string for tuning purposes.

### 13. Effect of Sericin on Properties of Molded Regenerated Silk Fibers

Sericin is a protein that coats the silk fibroin that makes up silkworm cocoon silk. Sericin is a glue-like substance that is important in keeping silk fiber in the shape of a cocoon. The protein is also thought to improve the toughness of silk fibers. In this experiment, a dilute Sericin (unknown concentration), provided by Pentapharm, Inc., was used to treat molded regenerated silk fibers. After fabrication of the fibers (molding in a Tygon tube and stored at approximately −6° C. for two weeks, as in Experiment 11; then suspended to dry out), they were soaked in the Sericin solution for 2 days. After removal, an Instron 3366 universal testing machine was used to compare flexural properties for untreated and Sericin-treated fibers. FIG. 16a shows as-molded silk regenerated silk fibers mounted on an Instron 3-point bend flexural testing fixture. FIGS. 16b and 16c show the fiber under loading and after fracture, respectively. FIGS. 17a-c show regenerated fibers that were treated with Sericin on the flexural testing fixture. The fibers that were not treated with Sericin were fairly brittle, while the ones treated with Sericin were remarkably tough (did not break under 3-point bend loading).

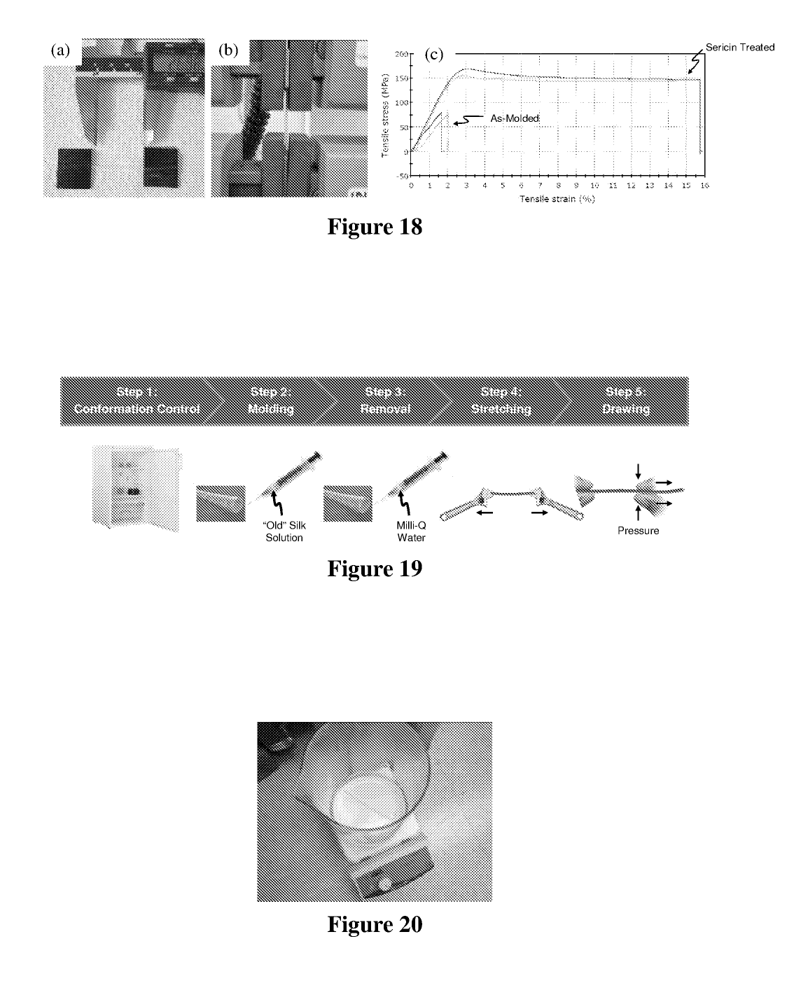

Given the Sericin-treated fiber sample did not fail under flexural loading, standard tensile tests were performed to provide a more complete set of material responses for comparison. FIG. 18a shows a fiber sample sandwiched between cardboard tabs using cynoacrylate glue. The samples were gripped using manually-adjusted grips, shown in FIG. 18b. Two fiber samples in the as-molded state and two treated with Sericin were tested on an Instron 3366 universal testing frame. The results are shown in FIG. 18c. The Sericin-treated fibers were much stronger and had significantly greater elongation-to-failure than the as-molded fibers. This data shows that coating with Sericin has a strengthening effect and improves the fiber toughness.

### 14. Molded Fibers Using Old Silk

Regenerated silkworm silk fibers were produced from silk solution that was processed 3.5 months prior and nearing self-assembly. The silk was processed from Japanese cocoons using a standard solution processing protocol (Plaza, G. R., Corsini, P., Perez-Rigueiro, J., Marsano, E., Guinea, G., and Elices, M., Effect of Water on Bombyx mori Regenerated Silk Fibers and Its Application in Modifying Their Mechanical Properties, J of Applied Polymer Science (2008), 109, pp. 1793-1801), with two modifications. The degumming (boiling) time of the cocoons was set to 60 minutes and an experimental Tangential Flow Filtration (TFF) strategy was used for dialysis. This older solution is identified in this document as “old silk”. As is typical for silk solution processed in the lab, the silk solution had been stored in a lab refrigerator at approximately 5° C. This storage temperature is used because self-assembly is slowed, providing a longer useful lifespan of the silk solution. The old silk solution was more viscous than fresher solution and had a yellowish, transparent appearance (as solution ages in the 5° C. storage environment, the initial cloudy, yellow-white coloration changes to a more transparent yellow coloration). As shown in FIG. 19, fibers were formed from “old silk” using a 5-step process. The use of old silk, identified as step 1, is thought to be important because of the conformation changes that have occurred in the silk as it was stored in the refrigerator environment. In step 2, the solution was injected into approximately 18″ lengths of small-diameter ( 1/32″ inner diameter) Tygon S-50-HL (silicone) tubing using a syringe with a small gauge needle. Both ends of the tube were then heat-sealed to ensure the silk stayed within. The tube was stored at room temperature for a period of 2-3 days, dictated less by the calendar than by visual evidence through the Tygon tube wall that the molded material had solidified. Visually, it was possible to see how much of the molded material was still mostly liquid and how much was solid. When almost all of the silk was solid, the heat-sealed ends of the tubing were cut. In this third step, the material was flushed from the tube by using milli-Q (pure) water and hand pressure applied to a syringe. Care was taken to ensure the material would not be damaged when flushed from the tube. The material was very moist and rubbery in consistency—similar to boiled spaghetti. In step 4, each fiber was clamped in an adjustable clamp and stretched tight. The fiber was suspended until most of the visible moisture dried. In step 5, hand-drawing was used to form fibers and to mechanically improve the fiber properties. The drawing was done by first holding the fiber with thumb and forefinger in one hand and drawing down the length of the fiber using thumb and forefinger on the other hand. These drawings cycles were repeated the desired number of times. While performing hand-drawing, it was noticed that the silk material, initially stiff, can stretch fairly easily until some limit seemed to be reached. Each drawing cycle was stopped when the limit appeared about to be reached. Stretching beyond the limit usually lead to fiber failure. The act of hand-drawing the fibers with lateral pressure served to help compact the fibers while being stretch to elongate and strengthen the fibers.

### 15. Steam Treatment of Freezer-Processed Regenerated Silk Fibers

When regenerated silk fibers are fabricated from either “old silk” or freezer-processed silk, they exhibit a certain amount of stretchiness. After drawing cycles are applied to such fibers, some moisture is drawn out (typically, drawing has been performed using lateral finger pressure on the silk) by skin contact or driven out by the mechanical manipulation of the fiber surface. The amount that each fiber can be stretched is affected by how many cycles were used and how aggressive the lateral loading was during drawing. In this experiment, a regenerated fiber was exposed to moist (steam) heat, as shown in FIG. 20. Two approaches were tested: (a) with a fiber suspended in the steam; and (b) with a fiber immersed in boiling water. In both circumstances, the fibers became much more flexible after exposure to the moist heat. Additional drawing cycles could be applied to the fibers. Thus, this process can be used for increasing the amount of drawing that can be applied to fibers, without causing premature failure or significantly degrading the elongation capability of the regenerated fibers.

### 16. Use of Mineral Oil to Improve Workability of Regenerated Silk Fibers

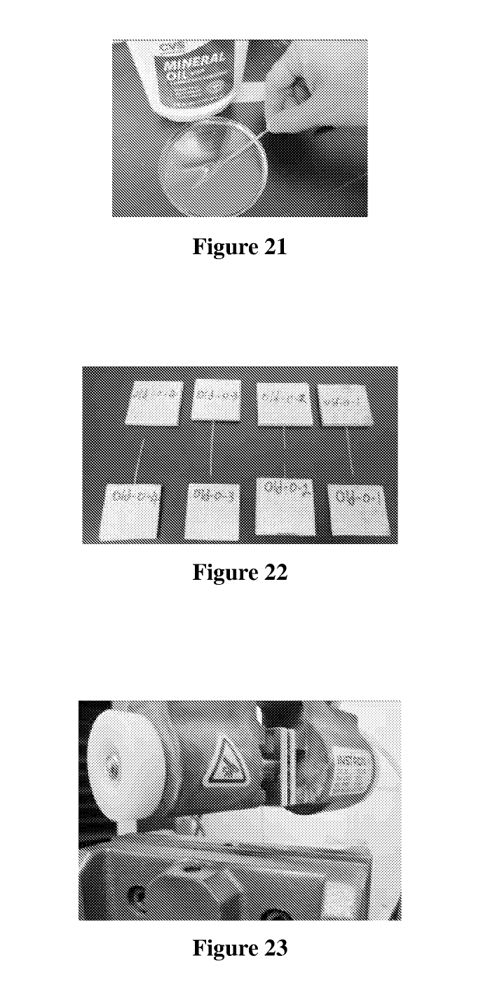

In the process of drawing regenerated fibers by hand, oils present in the user's fingers can play a beneficial role in maintaining moisture in the fibers during drawing. Moisture can lead to partial plasticizing of the silk, improving the mechanical workability of the silk. To better take advantage of in a process improvement, an experiment was conducted. Molded regenerated fibers (“old silk” fibers) were first placed in boiling water for 1 minute, then air dried for 3 minutes. The fibers were then soaked in mineral oil before drawing cycles were applied (FIG. 21). The data showed that the mineral oil helped to maintain internal fiber hydration, allowing the fibers to be stretched for a longer period of time. Over a period of several hours.

### 17. Mechanical Testing of Freezer-Processed and Old Silk Fibers

Mechanical characterization experiments on fibers were performed on an Instron 3366 universal testing machine with Instron's Bluehill software. “Old silk” fiber samples were prepared using the protocol described in Experiment 14 and “Freezer silk” fiber samples were prepared using the freezer-processing approach described in Experiment 11. Approximately 100 mm long samples were cut with scissors. Cynoacrylate glue (Loctite 406 instant adhesive) was used to glue each fiber end to a cardboard tab (approximately 15 mm×20 mm). Another pair of cardboard tabs was glued onto the first tabs, sandwiching the fiber between, as shown in FIG. 22. Pneumatic grips were used to clamp the top tab in place for tensile testing. Instead of using a pneumatic grip for the bottom clamp, which often causes an unacceptable compressive load to be applied to a sample upon installation, a machining vise was used (see FIG. 23). Using the vise, the compressive preload sometimes applied by pneumatic clamping was minimized.

One set of samples fabricated from the freezer-processes silk. Designated “Fr,” these fibers had been hand-drawn with greater than 700 drawing cycles. A total of 20 room temperature-processed samples created from old silk were tested. Four samples each were tested in these conditions: as-removed from the tube mold (“Old-0”); after the single stretch in the clamps (“Old-1”); after 200 drawing cycles (“Old-200”); after 400 drawing cycles (“Old-400); and after 700 drawing cycles (“Old-700”).

Using Instron's Bluehill software, a custom test method was created. Using extension control, the tests were conducted by stretching each sample at 0.2 mm/minute until fiber failure. Each initial fiber length was determined by measuring the exposed fiber length between the cardboard tabs. Fiber cross-sections were determined by first sectioning a short length of fiber adjacent to the fiber segment used in each sample. The sections were mounted and imaged using an inverted microscope. NIH's ImageJ software was used to determine the cross-sectional area. For reporting purposes, the cross-sectional areas were converted into an average diameter using the equation: Area=π*diameter²/4.

FIG. 24 shows the average fiber diameters for all of the tested fibers. The dashed line on this graph and all of the graphs reflect a comparison value from literature. Yan et al. (Wet-Spinning of Regenerated Silk Fiber from Aqueous Silk Fibroin Solution: Discussion of Spinning Parameters, Biomaterials (2010), 11, pp. 1-5) used a wet-spinning process to create regenerated silk fibers. Their largest fibers were, on average, 40 microns in diameter. The reported properties for these fibers were: Modulus of Elasticity of 6.7 GPa, Ultimate (Breaking) Strength of 120 MPa, and Total Elongation of 4.8%. While they also investigated smaller fibers with concomitantly superior properties, their largest fiber comes the closest to the very large diameter fibers created for this study (Wang, X., Kluge, J. A., Leisk, G. G., and Kaplan, D. L., Sonication-Induced Gelation of Silk Fibroin for Cell Encapsulation, Biomaterials (2008), 29, pp. 1054-1064). The freezer-processed fibers were the largest diameter, with approximately 0.42 mm diameter. The room temperature-processed “old silk” fibers decreased in size, from a starting diameter of approximately 0.38 mm to approximately 0.27 mm for the fibers that underwent 700 drawing cycles. The general trend that shows decreasing diameter with increasing drawing cycle number reflects the effect that many incremental stretch cycles has on the lateral dimension.

FIG. 25 shows the raw fiber testing data for the “old silk” fibers. As-molded fibers exhibited simple linear elastic behavior to sudden failure. All other fibers exhibited a linear initial stress-strain response, followed by a peak stress level. At increasing elongation, the stress decreased some, before recovering slightly. For “old silk” fibers, the stress recovery was slight. FIG. 26 shows raw fiber testing data for the freezer-processed silk fibers. These fibers exhibited initial linear stress-strain response, followed by a peak stress level. With increasing elongation, the stress decreased some. In contrast to the “old silk” fibers, the stress recovery was greater in amplitude and over a larger elongation range. In fact, the stress built to levels on three of the samples to levels that exceeded the maximum stress that occurred after the initially linear stress-strain response. The greater stress recovery and very high elongation to failure in the freezer-processed fibers can be due to the stretching of silk I material, and subsequent molecular alignment and increased crystallinity of the silk.

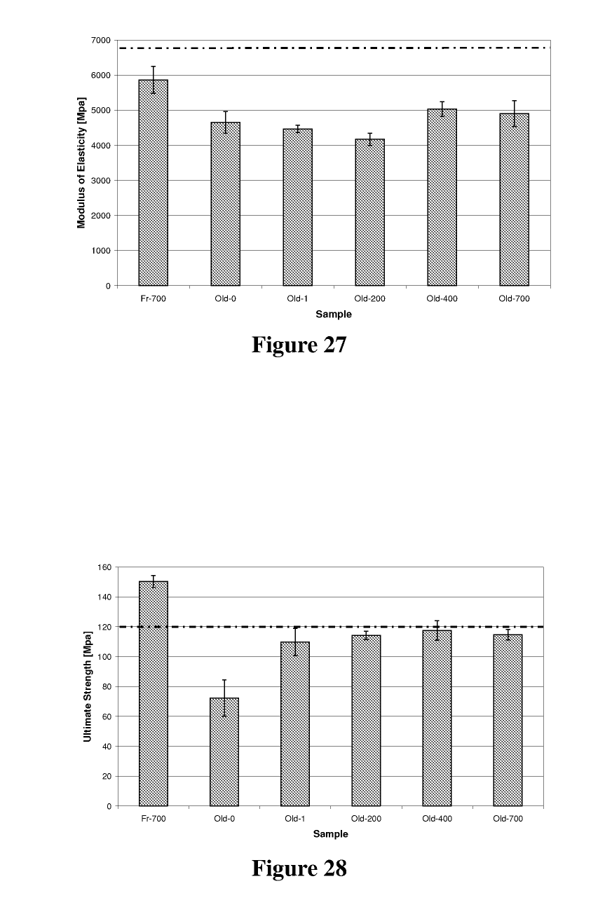

FIG. 27 shows a graph of Modulus of Elasticity for every fiber sample tested. Considered a measure of material stiffness, the modulus was the highest (about 5900 MPa) for the freezer-processed fiber samples. While the “old silk” fibers were not as stiff, the stiffness is shown to increase with increasing numbers of drawing cycles. The Ultimate Strengths, also considered the Breaking Strengths, are compared in FIG. 28. The freezer-processed fibers were superior to the wet-spun fibers reported by Yan et al. (Wet-Spinning of Regenerated Silk Fiber from Aqueous Silk Fibroin Solution: Discussion of Spinning Parameters, Biomaterials (2010), 11, pp. 1-5), with an average strength of approximately 150 MPa. The as-molded “old silk” fibers exhibited the lowest strength (approximately 70 MPa). When the hand drawing is first performed, the user can tell that the rubbery state of as-molded fibers cannot support too much loading before failure. As the number of drawing cycles increases, the strength of “old silk” fibers increases significantly. There appears to be limited improvement beyond 400 drawing cycles.

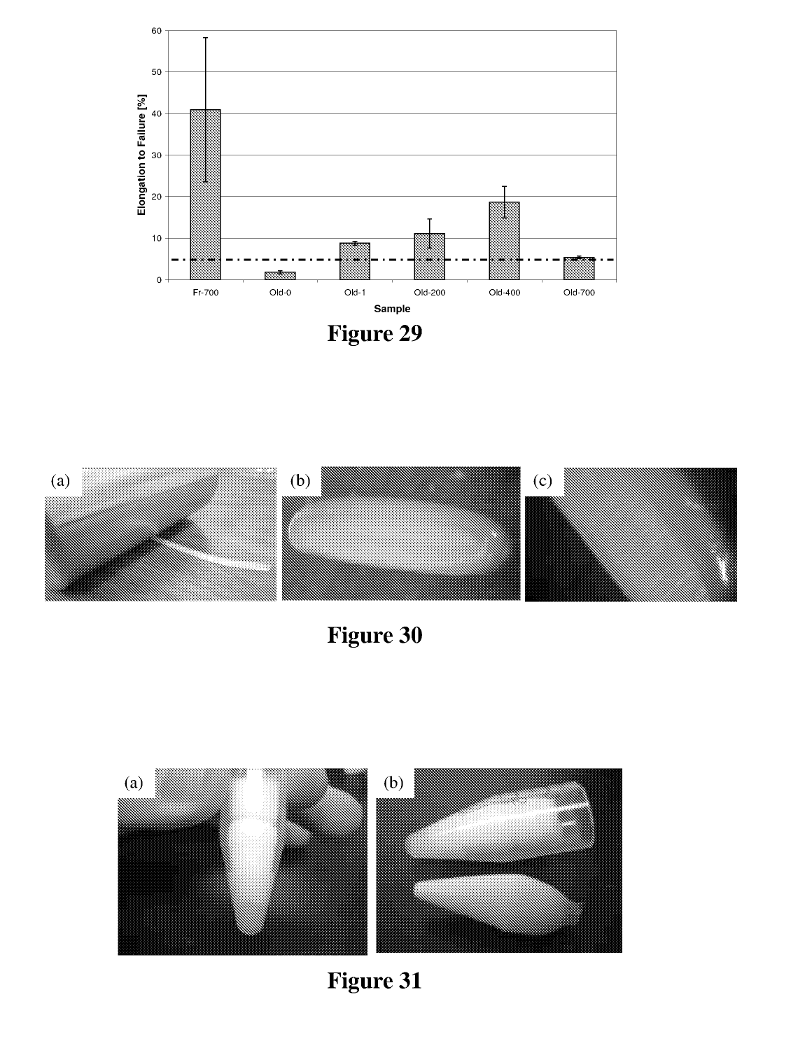

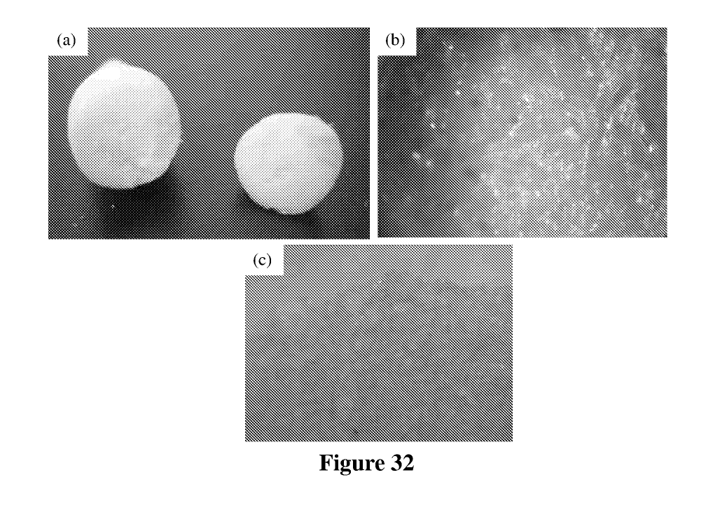

The final set of data generated in fiber testing is the Elongation to Failure (FIG. 29). The freezer-processing fibers had outstanding elongation before failure occurred. While on average the elongation was 40%, one extreme sample elongated 66% before failure. This elongation behavior was almost an order-of-magnitude better than the wet-spun regenerated fibers produced by Yan et al. (Wet-Spinning of Regenerated Silk Fiber from Aqueous Silk Fibroin Solution Discussion of Spinning Parameters, Biomaterials (2010), 11, pp. 1-54). The as-molded “old silk” fibers were very brittle; they exhibited very little elongation before failure. With an increase in the number of drawing cycles applied, a general increase in elongation to failure was witnessed. The highest number of applied drawing cycles, however, generated a fiber which was significantly more brittle than fibers with intermediate numbers of cycles.

After all fibers were tested, digital images were taken of the separated fiber fragments (not shown). Of particular note was the sample identified as “Fr 3.” This was the unique fiber sample that stretched to approximately 66% elongation before failure. This fiber developed a strikingly opaque, white appearance and was noticeably smaller in diameter than the other failed fibers (data not shown).

### 18. Rolling of Regenerated Silk Fibers to Manufacture Tough Silk Strips

The rubbery nature of fibers created from regenerated silk and molded at −6° C. provides promise that traditional mechanical processing techniques can generate unique silk geometries with very attractive mechanical properties. In this experiment, a rolling process was utilized to generate a flattened silk strip. Starting with freezer-processed silk molded in the shape of a fiber, a hardened steel roller (FIG. 30a) was rolled lengthwise over the fiber, with approximately 10-15 N downward force. Over a number of rolling cycles, the fiber was seen to flatten out to a strip (FIGS. 30b and 30c). The flattened strip appeared to reach a minimum achievable thickness, with the development of a much whiter color. The rolling action can cause permanent deformation to occur, which can be manifested in a widening and lengthening of the fiber into a strip. The strength and toughness of the regenerated silk strips was impressive. If too much downward pressure were applied to the roller, the strip could develop incipient cracks, which can lead to catastrophic failure when the strip is loaded axially.

### Discussion

The microstructure of fresh silk solution is dominated by random coil molecular conformation. It is known that the conformation can become more crystalline, achieving a higher-order conformation through several methods: time-driven self assembly, increased temperature, decreased pH, through addition of ions, shearing, and several other ways. The most crystalline state, beta-sheet rich Silk II, should provide robust mechanical strength performance, with limited elongation. Silk I conformations are typically meta-stable phases in that the material can be driven to either a more random conformation or to a more stable conformation, such as a beta-sheet conformation. Given the meta-stable behavior, significant elongation is possible, and although the mechanical strength characteristics in the silk I conformation is limited, properties may increase dramatically with elongation.

Old Silk Fibers:

When old solution is examined, it typically is more viscous and has a different appearance from fresh silk solution. In brief, very fresh solution can be slightly cloudy, possibly due to bubbles. Over time, the solution can become clearer, while a yellow tint can become more pronounced. Interestingly, very old solution can be quite transparent, which is counterintuitive because one expects that an assembly process has already begun, which includes micro-crystallinity and micelle formation. In the case of the “old silk” used in this study, self-assembly can have begun, with an elevation of beta-sheet content. By molding the silk in a small, enclosed tube and leaving at room temperature for several days, the assembly process is accelerated. The material is removed from the tube before the silk is completely solid, producing a rubbery material that has high water content. Given that the material can be easily stretched, the conformation is not completely dominated by beta sheets. If the material is simply allowed to dry out, the material exhibits extremely brittle behavior. This behavior is also seen in a simple fiber formed by drawing a fiber out of a pool of concentrated silk. Water is present as bound water (strong hydrogen bonds with silk fibroin) and free water in silk solution. Fast drying of the free water can isolate silk fibroin, producing poor mechanical (brittle) performance if no significant alignment or structural organization is present.

The act of stretching the rubbery “old silk” fiber causes molecular chain alignment, with chains moving closer to one another as the fiber diameter decreases. The lack of significant beta sheet content in the rubbery material and the presence of some water ensure some mobility of the molecular chains. With closer proximity of the molecular chains, new bonds can form, producing a stronger material. As drawing cycles are applied to the material, especially in consideration of the later force being applied, water is drawn out and chains are further elongated and driven to closer proximity. This leads to observations of higher strength, to a point. The “old silk” fibers that were processed with 700 drawing cycles dropped in strength and showed dramatically less elongation to failure. It appears that the stretching of the chains and perhaps the dehydration led to damage initiation. Another consideration is that the old silk likely had some beta sheet content before molding, along with additional beta sheet formation with shearing. It is possible that the stretching of more amorphous regions among the beta sheet content reaches a limit and that in conjunction with stress concentration developed between more crystalline and non-crystalline material contents leads to premature failure for higher numbers of drawing cycles.

Freezer-Processed Fibers:

The fiber processing technique that uses sub-zero temperature gives superior mechanical performance results to the “old silk” fiber process. Starting with fresh silk solution, molded fibers are stored in a freezer set to −6° C. Li et al. (Study on Porous Silk Fibroin Materials. I. Fine Structure of Freeze Dried Silk Fibroin, J of Applied Polymer Science (2001), 79, pp. 2185-2191) reported that the initial melting temperature of the ice in frozen solution is about −8.5° C. They attributed this observation to the amino acid polar side groups that have a strong affinity to water (and lower steam pressure compared with pure ice). In their freeze-drying experiments, a significant level of silk I conformation was seen in silk fibroin that was freeze dried between −16 and −4° C. A higher level of crystallinity was seen at lower temperatures and with higher concentration silk fibroin at the same given temperature range. For silk solution frozen between −20 and −8.5° C., the removal of ice makes the silk fibroin in random-coil structure concentrated. Spatial distance between molecular chains decreases, so there's a higher level of chain interaction. In addition, molecular heat kinetic energy enables chain segments to actively move, potentially forming an ordered structure.

As discussed above herein, the freezer temperature was seen to fluctuate about the set-point (actual range likely −8 to −3° C.). While the water in silk fibroin was not completely frozen, because a rubbery, stretchable solid was formed, some elevation of silk I content can be achieved and molecular chain interaction is present in the semi-frozen material. Without wishing to be bound by a theory, using a temperature just above freezing avoids the water crystallization that can affect any assembled silk structures due to expansion. The silk I content is a meta-stable phase that can be readily stretched and relatively easily driven to a more stable phase with mechanical manipulation.

An embodiment of fabricating a molded fiber with drawing is shown in FIG. 65.

### Example 2

### Silk Foam and Paper-Like Materials Molded Using Freezer Processing, with Applications for 3D Object Fabrication

Spongy scaffolds are frequently applied in tissue engineering for a number of reasons. A key reason is the network of pores is advantageous for allowing cell attachment, yet allowing nutrient and waste flows. In a popular approach to producing silk-based spongy scaffolds, salt leaching involves the packing of salt with controlled particle size into a mold. Silk solution is poured onto the salt, which quickly leads to self assembly of the solution. Once a gel has formed, the salt is dissolved, leaving an interconnected network of controlled pores. While the desired internal pore structure is produced, the resulting material leaves room for improvement in terms of geometric stability, ability to created three-dimensional geometries, and mechanical properties.

Inventors have discovered alternative strategies for making silk foams. One approach begins with a gel form of silk, known as electrogelated silk. Silk electrogelation involves the conversion of solubilized silk into a sticky gel through the application of DC voltage applied directly to the solution using electrodes. When the voltage is turned off, the gel can be removed from the remaining silk solution by extracting the positive electrode from the solution. It has been visually observed that the silk solution surrounding the forming gel is affected by the electrogelation process. However, the solution does not appear to form a solid material and is not removed when the gel is removed. When the solution remaining behind after electrogelation is placed in a freezer for an extended period and brought to room temperature, a range of material forms can be generated, from a bulk foam to a thin, paper-like film. This new material has features that can be exploited in various applications.

A second approach for making silk foams comprises freezer-processing of silk solution directly. After silk cocoons have been processed into a silk solution, the solution is typically stored in a refrigerator typically set to 5° C. This low temperature slows the self-assembly process within the polymer, extending the useful life of the silk solution. An interesting observation was made when a batch of silk solution was unintentionally stored overnight at a temperature of approximately −5° C. The material appeared to have self-assembled, but had a different consistency from a typical silk gel. The material had the consistency of tiramisu and could be stretched considerably. Further controlled tests have shown that freezing silk solution at a temperature range of between −5° C. to −10° C. is useful for making various silk material forms, such as fibers or robust foams. This document describes a series of experiments that were conducted using the two aforementioned silk foam fabrication techniques.

The following describes experiments conducted to explore embodiments of the method described herein for fabrication of silk foams and thin, paper-like geometries. The results of these experiments demonstrate that a variety of foam and paper-like geometries can be created which have a wide range of applications.

### 1. Initial Formation of Silk Egel Foam

Silk electrogelation involves the application of a DC voltage using electrodes submerged in a solubilized silk solution to form a metastable silk gel. Prior experiments have shown that so-called “egel” exhibits unique capabilities from other silk gels. At the conclusion of an experiment that used electrogelated (egel) silk, an observation was made concerning the formation of silk foam. Using a traditional egel setup, two platinum electrodes were suspended in an 8% w/v silk solution contained in a shortened Falcon tube and 25 VDC was applied. After gel formed on the positive electrode, the egel was removed and fresh silk solution was added to allow repeated electrogelation. After multiple egel runs, the remaining silk solution, still in the Falcon tube, was placed in an EdgeStar Model FP430 thermoelectric cooler maintained at around 14° F. (−10° C.) for 6 days. The silk was removed from the cooler and kept in ambient conditions at room temperature for approximately 10 days. During this time, the sample had formed into a solid material and had shrunk approximately 25% from the Falcon tube geometry. FIG. 31 shows two views of this first silk egel foam. FIG. 31a shows the foam sample in a Falcon tube before drying completely. FIG. 21b shows one foam sample inside a shortened Falcon tube and another after removal and drying. The silk solution that remains after electrogelation was completed acted differently than fresh silk solution. Without wishing to be bound by a theory, a secondary structure can be formed by the electrical field generated during electrogelation. It was noted that the pH in the surrounding silk solution was close to neutral. Thus, the secondary structure formation can be due to alignment in the electric field and not due to electrolysis-driven pH change.

The resulting foam was white in color, except for a yellowed portion at the top, where the sample can have dried first (the surface of the silk solution near the top of the Falcon tube container is exposed to the experimental environment). The foam was very light and highly porous, with many small pores, resembling an open-cell foam. The outer surface was very smooth, reflecting the smooth inner surface of the Falcon tube. FIG. 22 shows images of the foam in cross-section. FIG. 22a shows the interior of the foam after sectioning with a razor blade. FIGS. 22b and 22c show stereo microscope images of the cross-section. In the initial samples, there appeared to be a coarser region near the center of the foam cross section (data not shown).

### 2. SEM Imaging of Silk Egel Foam

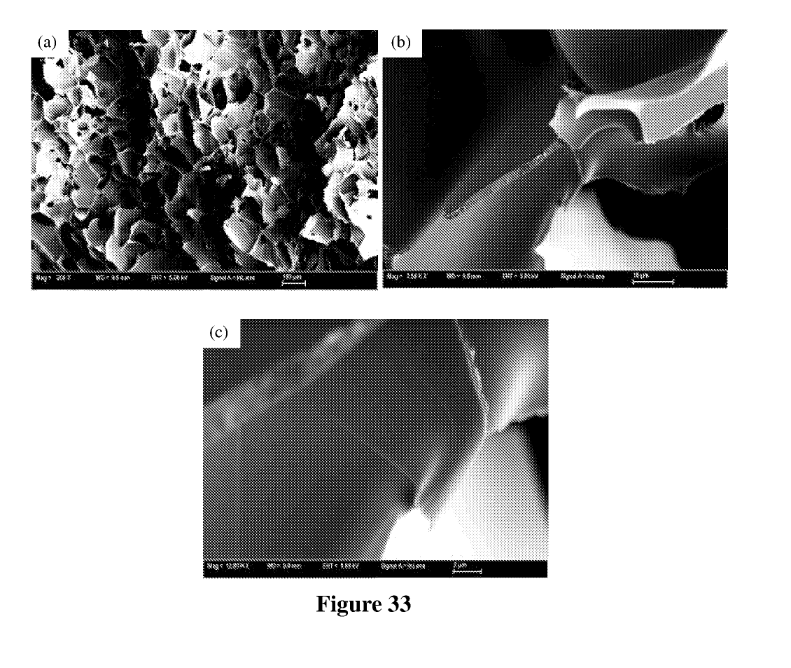

FIG. 33 shows SEM images of a silk egel foam sectioned using a razor blade. The images were taken near the central region of the cross-section, where the morphology appears to be coarser. FIG. 33a shows the fine inter-connected pore structure at 200×. FIGS. 33b and 33c show the silk foam at 3500× and 12000×. The morphology is characteristic of a phase separation phenomenon. Maintaining the silk solution at 14° F. (−10° C.) can cause bound water to become unbound and separate from the silk fibroin. The small holes in the pore structure represent locations where water has passed through the structure.

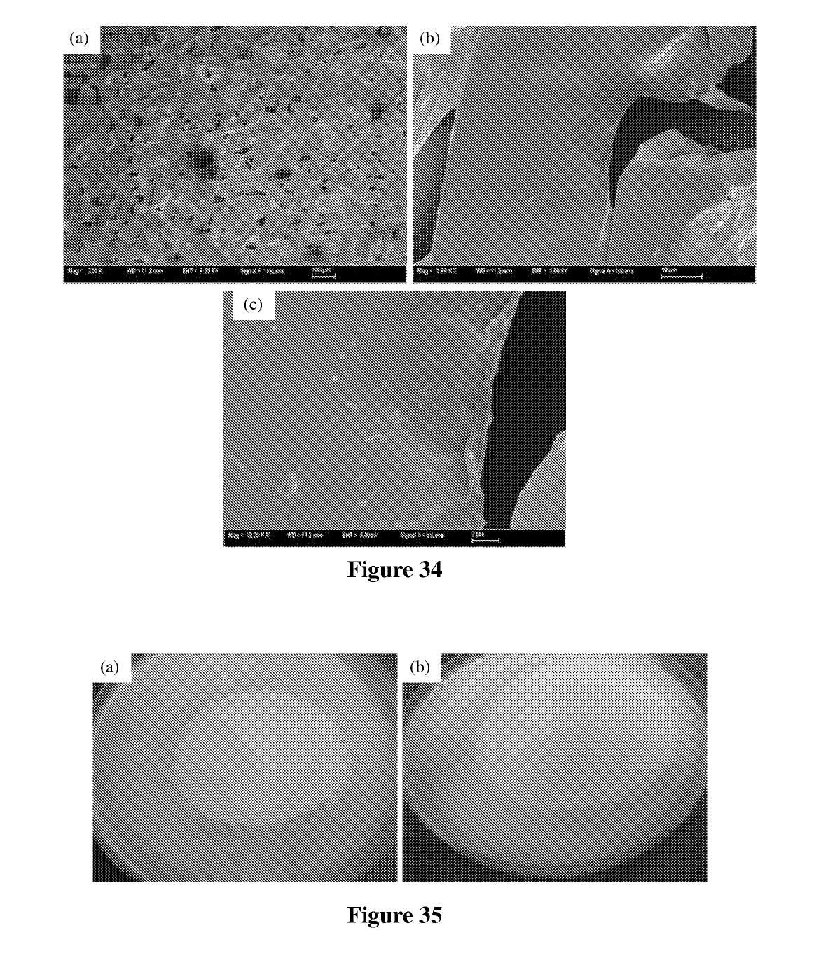

FIG. 34 shows SEM images of the smooth, outside surface of silk egel foam. The morphology is seen as a smooth surface, with some exposed pores. FIGS. 34b and 34c show the silk foam at 3500× and 12000×, respectively.

### 3. Paper-Like Material Fabricated Using Silk Egel

To develop a deeper understanding of how sub-zero temperatures can affect foam formation using silk egel, a thin-layered construct was created. As in Experiment 1 above, a standard egel setup was used. After silk egel was formed, the remaining solution that was not part of the visible gel was separated and poured into a Petri dish. Only a thin layer of liquid silk was poured. The dish was placed in a freezer maintained at around 14° F. (−10° C.). After 3 days (FIG. 35a) and 5 days (FIG. 35b), the dish was removed from the freezer for imaging. An initial round, white region in the otherwise gray film was seen at the 3 day time point. A slightly larger white-gray zone was also evident. After 5 days, the white region was much larger, covering approximately 60% of the thin egel construct. The white region appeared to the naked eye to have a consistent network of pores, while the gray region appeared to be more gel-like, with an icy sheen of water entrapped in the silk material.

### 4. Casting of Silk Egel Paper-Like Foam

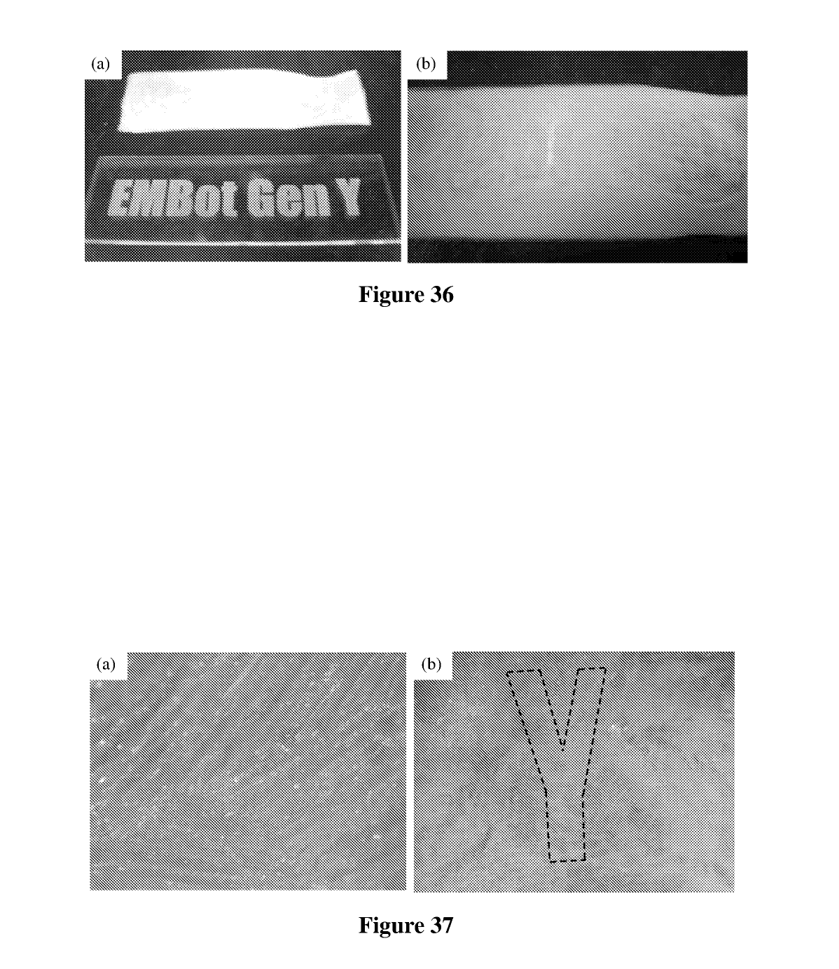

A cast acrylic material was etched with words on a Trotec laser etching machine. This material was then used as a casting substrate for silk egel foam. Approximately 8% w/v non-gelated egel solution (remaining solution from an electrogelation pool) was poured onto the acrylic with a syringe, with care taken to completely cover the acrylic without spill-over. The substrate with silk solution was then stored in a freezer maintained at approximately 14° F. (−10° C.) for 12 days. After removal from the freezer, the material was brought to room temperature and removed from the acrylic substrate, as shown in FIG. 36a. The material had the consistency of a thick paper or thin foam, without a significant number of pores. The surface that mated with the acrylic was very smooth and exhibited letters that were originally etched in the acrylic (FIG. 36b). Using a stereomicroscope, the images in FIG. 37 were recorded. As shown in FIG. 37a, the surface morphology of the cast egel film had a fairly organized structure. Crystalline-like contours were embedded in the film. This feature can be used for imparting desired anisotropic properties in the material. FIG. 37b provides a closer look at one of the etched letters that was cast into the silk material. The micro-scale etching features of the letter “Y” was replicated in the silk paper-like foam.

### 5. Casting of Silk Egel Paper Sheets

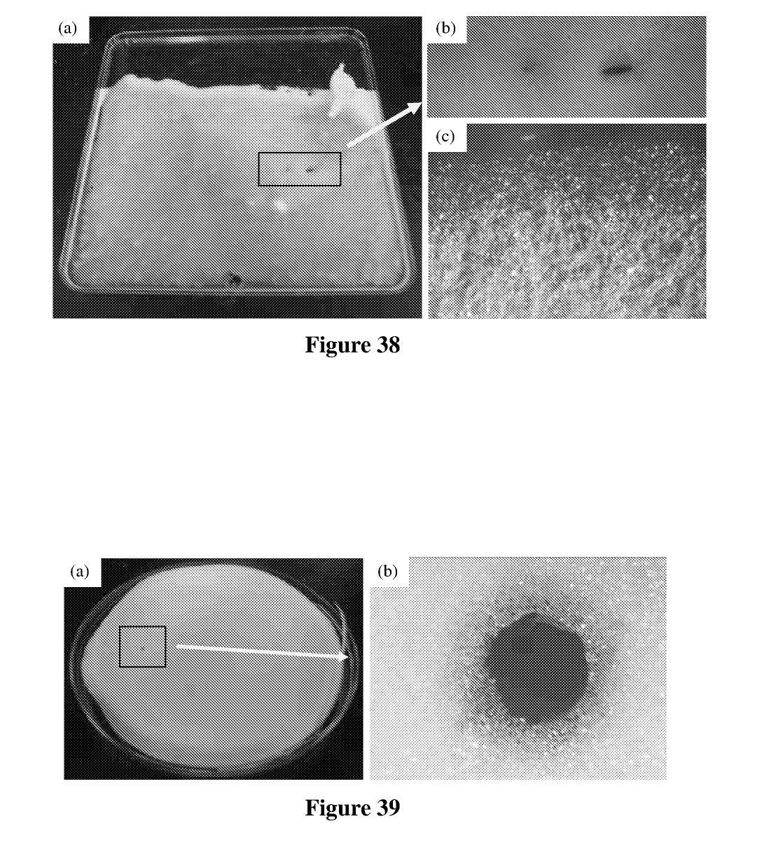

Using the same batch of 8% w/v non-gelated egel solution from experiment 4, a large plastic tray and a plastic Petri dish were used to cast foam sheets. As shown in FIG. 38a, the tray surface was not completely covered, in order to allow inspection of the foam-tray interface. After freezing the tray and dish at 14° F. (−10° C.) for 12 days, the resulting materials were inspected with a stereomicroscope. FIG. 38b shows a close-up view of two large pores that developed in the foam sheet (tray). The top surface of the foam and pore edges clearly indicated that the material had many fine-sized pores. A close-in view of the foam-tray interface (FIG. 38c) indicated that the foam morphology penetrates the entire depth of the foam sheet. The silk material cast in the Petri dish was thicker than the material cast on the tray and could be easily peeled away from the Petri dish surface (FIG. 39a). The bottom side of the material was very smooth. A close-in view of a large pore in the material using a stereomicroscope (FIG. 39b) showed that the material clearly had a network of fine pores throughout the material thickness.

### 6. Comparison of Egel Paper Using Varying Freezing Time: Nov. 6, 2009

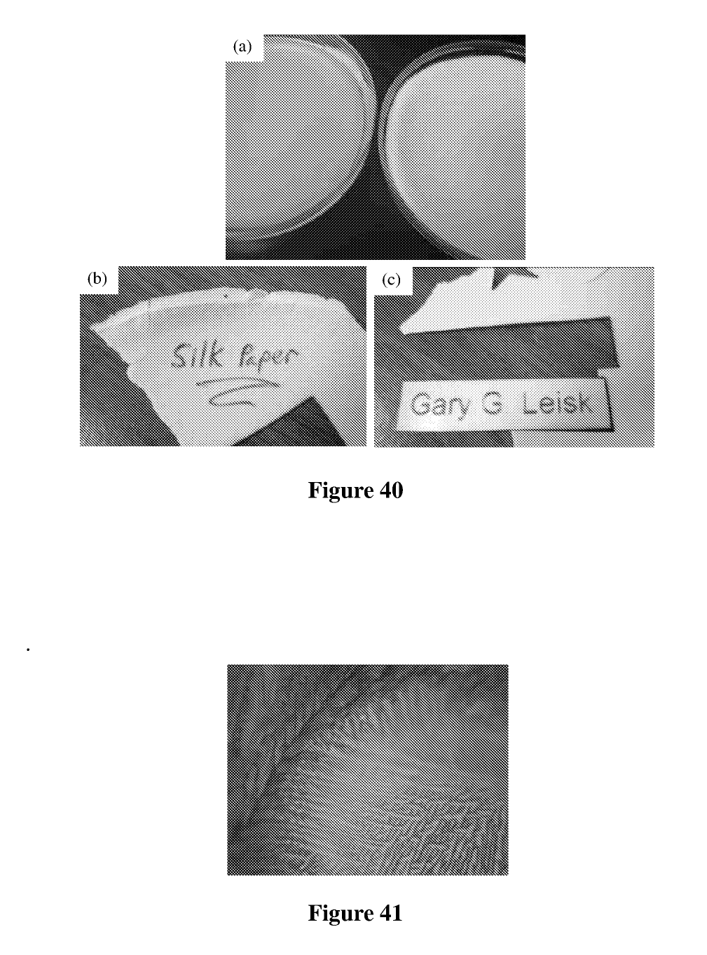

Cast egel foam was created by pouring 8% w/v non-gelated egel solution into two plastic Petri dishes and placing the dishes in a freezer at 14° F. (−10° C.). After 8 days in the freezer, one dish was removed and brought to room temperature (left side in FIG. 40a). The other was removed after 12 days (right side in FIG. 40a). The material removed after 8 days had much more water still entrapped in the silk, and was more gel-like than foam-like. It was cool to the touch and began to dry out considerably under ambient conditions. The material removed after 12 days was lighter in color and resembled fine-pore foam. It was not cool to the touch and did not change significantly when kept at ambient conditions. It is noted that if such a sample were left in the freezer for more than 12 days, no significant difference was seen from a sample removed at 12 days. Once dry, the foam material could be written on using an ink pen, as if it were a thick writing paper (FIG. 40b). In addition, the material was readily cut and etched using a Trotec laser etching machine (FIG. 40c). Various shapes and words could be etched or cut into the silk material.

7. Paper using Egel from High Concentration Silk

Using a traditional egel setup, two platinum electrodes were suspended in high concentration silk solution (above 20% w/v) contained in a shortened Falcon tube and 25 VDC was applied. In this experiment, after gelation, the egel was removed from the solution and placed in a plastic syringe. The syringe was heated with a heat gun to above 60° C. The heated egel was then cast in a plastic Petri dish and placed into a freezer at 14° F. (−10° C.). Note that this experiment was performed with the metastable egel material itself, in contrast to the prior experiments. After 10 days in the freezer, the silk material was inspected using a stereomicroscope, as shown in FIG. 41. It was observed that crystalline-line morphology developed in the solid material. This can be due to the activity of water freezing and formation of ice crystals, which can pattern the silk material. The material itself was found to be stiff, but very brittle.

8. Foam Construct from Remaining Egel Solution

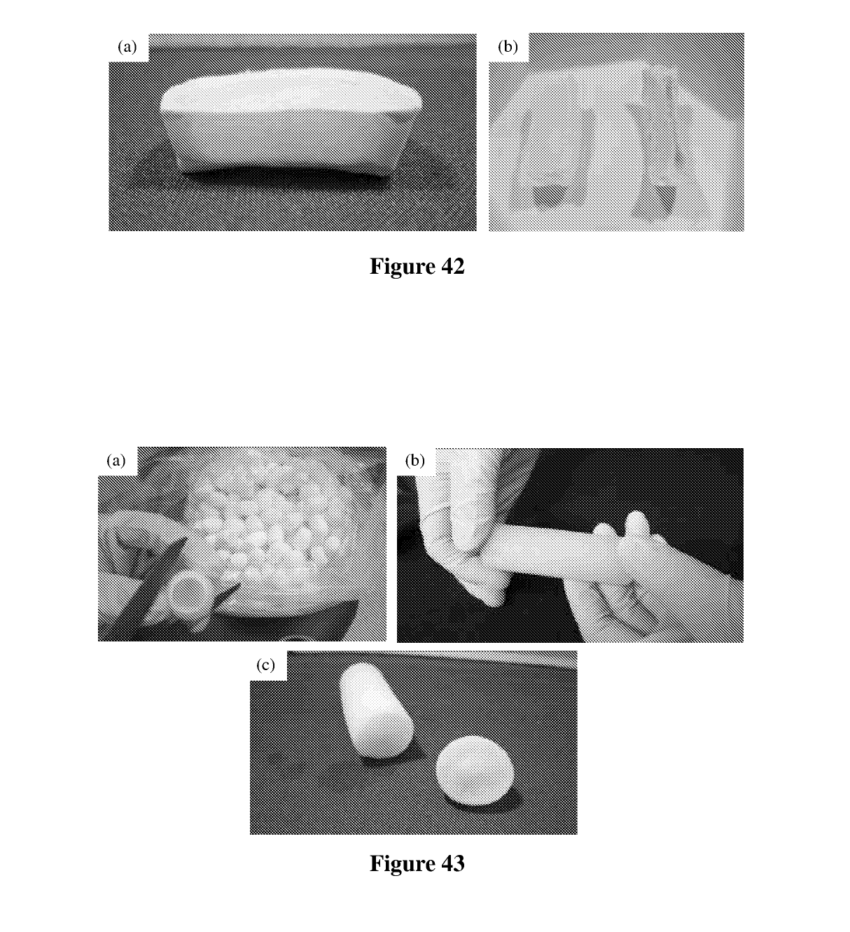

The fabrication of much thicker foam constructs was pursued using similar silk processing conditions as in the prior experiments. Silk solution remaining after an electrogelation process was poured into a plastic cup and stored over 2 weeks in a −10° C. freezer. Within a day of storing in the freezer, an opaque, white solid was observed to form, starting from the outside diameter of the silk solution. After 2 weeks in the freezer, the sample was removed, allowed to heat to room temperature, and then sectioned using a razor blade (the sample was still hydrated in the middle). As shown in FIG. 42a, the cross-section of the dry sample exhibited two distinct foam regions. Around the bottom and sides of the construct, consistent, fine-pore foam was present. In the bulk of the sample, a larger-pore structure was formed. A thin layer across the top contained fine pores. Without wishing to be bound by a theory, the fine-pore structure can form first because of the freezing rate. Two separate sectioned samples are shown in FIG. 42b. The sample on the right was made from a higher concentration silk solution (15% w/v). Both were processed with the same parameters and held at room temperature for the same length of time. The data demonstrate that higher-concentration silk solution can cause significant shrinking of the foam.

### 9. Taiwan Cocoon Source—Freezer Foam

A standard silk solution was formed using Taiwanese cocoons (FIG. 43a). The key distinguishing feature between the Taiwanese supply of cocoons and those from other suppliers are that the cocoons were pre-cut by the supplier before the silkworms died or pupated. The resulting cocoons are cleaner than other cocoons and have a thinner wall thickness (the silkworms do not complete their fiber spinning before being removed). It has been observed that the these cocoons degum somewhat easier than other cocoon sources, likely because of the thin wall. Foams were fabricated using silk solution made from Taiwanese cocoons using a freezer process. Unlike in prior experiments, the silk solution was poured into a 60 ml syringe, which acted like a mold; no electrogelation process was employed. The syringe was stored in a freezer at −10° C. for 2-3 weeks. Once removed from the freezer, the silk material was pushed out of the syringe (after the cross-section of the plastic syringe was cut open). As seen in FIG. 43b, the material was still very wet and flexible. The image of the material cross-section in FIG. 43c shows that the bulk of the water has been squeezed out, although the sample is still moist. After storing at room temperature to dry, the material became stiff, like Styrofoam. Thus, while egel can produce good foam, it is not necessary to include the egel step in producing foam. Without wishing to be bound by a theory, foam fabricated from egel can respond differently (e.g., have different properties) than silk make from silk solution using no electrogelation process (as in this experiment). As seen with testing of electrogelated silk, the material exhibited an elevated amount of silk I secondary structure, which can be converted to a more robust conformation during processing. This can provide improved mechanical performance.

### 10. The Effect of Added Powder in Silk Foam Fabrication and Properties

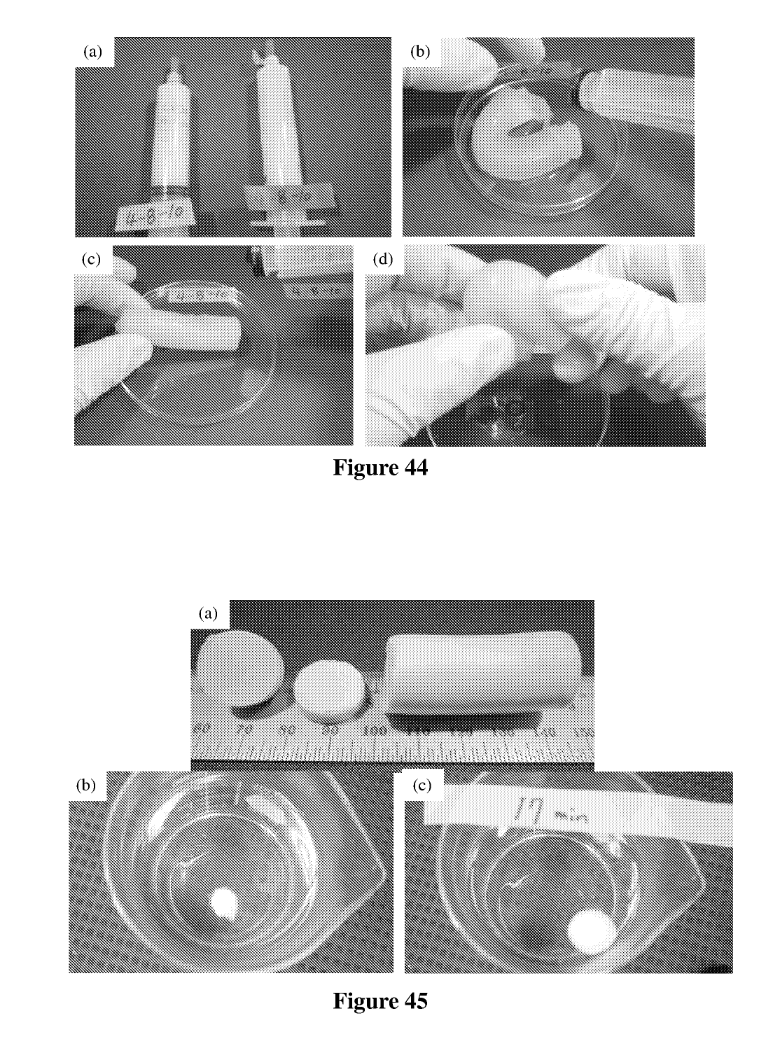

A similar experimental setup was used as in Experiment 9 above, with the exception of the cocoon source. Two cocoon sources were compared: Japanese and Chinese-supplied silk cocoons with a 30 minute degumming time. Each silk solution (between 7-8% w/v concentration) was mixed with a fine silk powder purchased from a beauty products supplier (TKB Trading) and poured into a 60 ml plastic syringe (FIG. 44a). After storing in a freezer at −10° C. for one week, each sample was pushed out of the syringe (after the cross-section of the plastic syringe was cut open). FIG. 44b shows the silk made from Japanese cocoons after removal from the syringe and still in a fully hydrated state. The material was very gooey and did not maintain the original cylindrical shape. It was observed that this sample should have been left in the freezer for an extended period of time. The silk construct made from Chinese cocoons, however (FIG. 44c), was a coherent solid and maintained its shape after removal from the syringe, even in a fully hydrated state. FIG. 44d shows how flexible the fully hydrated sample is. In a dry state, the foam was tough, but could be fractured if bent with sufficient force. The use of powder had two main effects: (1) the foam formation time was much faster—from 2-3 weeks down to 7 days; and (2) when in a dry state, the foam fabricated with silk powder appeared to be much stronger. Without wishing to be bound by a theory, the presence of the powder influences the bonding that forms between molecular chains in the silk fibroin: acting almost like a catalyst for the formation of a solid material. In terms of strength, it can be that the powder itself is causing a strengthening effect, analogous to the strengthening effect seen in some composite materials that incorporate particles or flakes. It is also possible that the improved bonding or speed of formation of a solid ultimately leads to a change in mechanical properties as well.

To explore the ability of silk foams created in this experiment to be compressed and re-expanded through hydration, a simple test was conducted. The silk construct fabricated using silk cocoons from a Chinese supplier was allow to fully dry in ambient conditions. A short segment was sectioned (FIG. 45a) and fully re-hydrated. It was then compressed and left at room temperature in a compressed state for 16 hours until fully dry. The compressed sample was placed in warm (−50° C.) milli-Q water (FIG. 45b). After 17 minutes of immersion, the sample had nearly completely expanded to its original size and shape (FIG. 45c). This ability to be completely compressed and reconstituted back to its original size and shape demonstrated that the foams created using a freezing process can act like a typical sponge. Thus, foams made using the method described herein can be used for applications that can benefit from a robust sponge material, with the added benefit that the constituent material is both biocompatible and controllably biodegradable.

11. Silk Material Formed with a Large Volume of Silk Powder

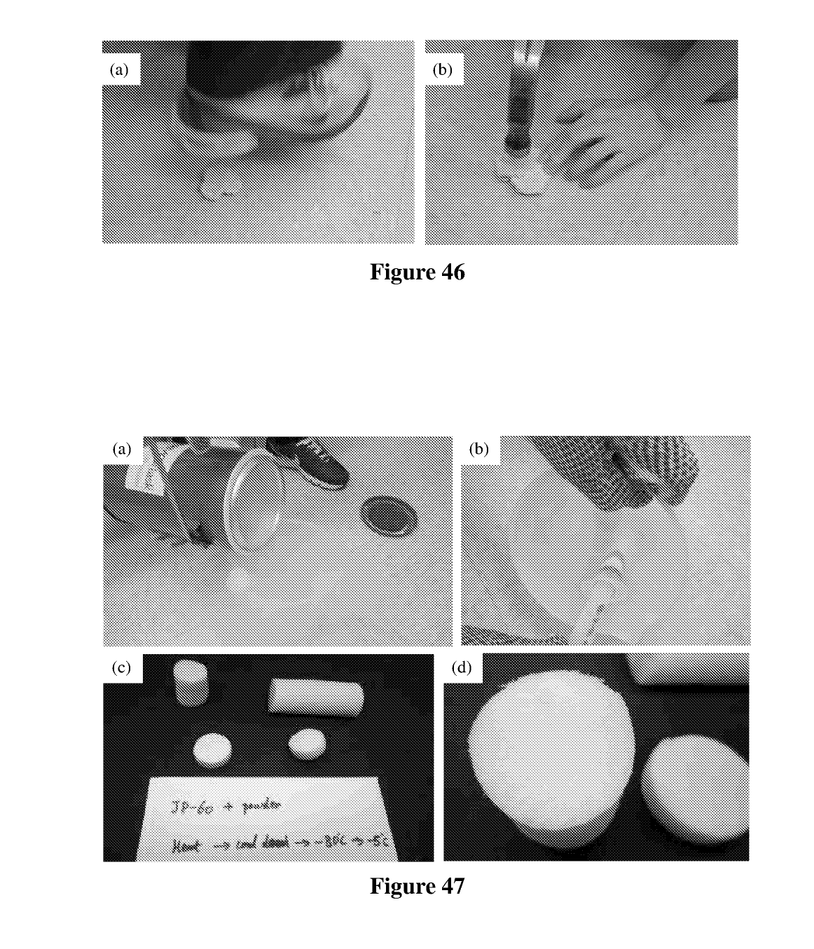

As a further investigation of the use of silk powder, a large volume of fine silk powder (TKB Trading) was added to silk solution manufactured from Chinese cocoon silk. Upon mixing in the powder, the viscous silk solution appeared to convert to a gel, indicative of the formation of a secondary structure. The gel-like silk was dried at ambient conditions, providing a very tough material. As FIGS. 46a and 46b show, the silk was able to withstand impact loading with little damage visible. This experiment confirmed that silk powder acts like a catalyst when combined with silk solution, increasing the speed of conversion of silk solution to a higher-order structure (secondary structure formation). As in Experiment 10, the addition of silk powder resulted in a stronger foam. However, there can be an upper limit in the strength and toughness that can be achieved with the addition of powder; in other words, adding powder above some critical volume does not appreciably improve the properties.

### 12. Use of Silk Powder to Form Foam in Long Degumming Silk Solution

In silk solution preparation, an early boiling step is used to remove the sericin protein coating that the silkworm produces on the surface of the cocoon fiber; a process known as degumming. A series of tests with silk solution derived from silk fibroin (various suppliers) was conducted to see what effect degumming time had on the ability to form quality foam. It was determined that degumming times of 30 minutes or greater makes it difficult to form a foam. In general, the higher the degumming time, the longer it takes to convert the silk solution to solid foam using the freezing process describe previously. The inventors discovered that silk powder can be used to assist in the formation of foams, despite using a 60 minute degummed silk solution. The general method included four steps: (1) 60 minute-degummed Japanese silk solution was heated in a beaker with a heating plate set to about 60 C; (2) silk powder (TKB Trading) was mixed in and the solution was then poured into a plastic syringe; (3) as shown in FIG. 47a, liquid nitrogen was poured onto the syringe; and (4) the syringe was then stored in a freezer at −5° C. for more than a week. Note that FIG. 47c has an incorrect label—the liquid nitrogen temperature was closer to −200 C, although the actual silk temperature was likely higher. The resulting foam was very robust. This demonstrated that silk powder can be used to create silk foams when silk degumming time above 30 minutes is used. This is an important observation from degumming and sterility points-of-view. In degumming, some researchers use degumming times longer than 30 minutes to ensure the protein, sericin, is fully extracted from the silk. In addition, longer boiling times could be utilized to ensure sterility if the resulting construct were designed for animal or human implantation. While past experience showed that the longer degumming times prevents proper foam fabrication, the silk powder addition overcame this barrier.

### 13. Strong, Machinable Foam

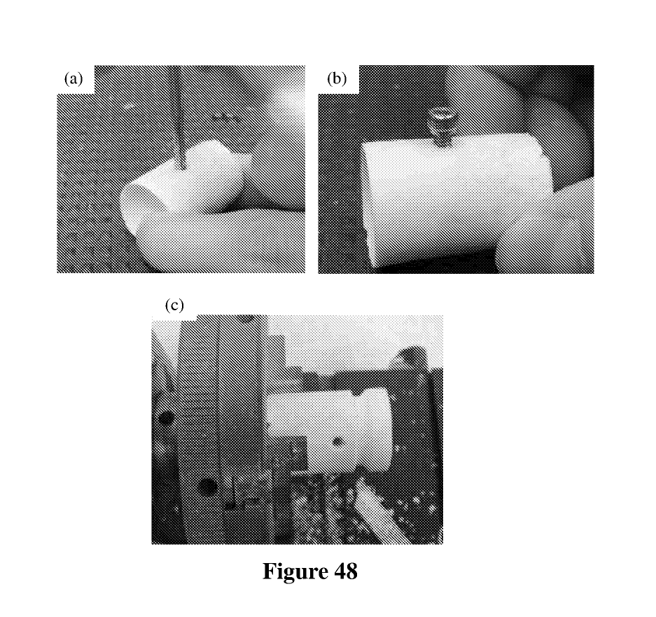

Silk solution that was produced using Taiwanese cocoons and 60 minutes of boiling time (for degumming) was concentrated to about 25% w/v. The solution was heated to above 60° C., the temperature above which water bound to silk fibroin at the molecular level becomes unbound. Pure silk powder (TKB Trading) was mixed into the hot solution in a Falcon tube. After the solution was allowed to return to room temperature, the material was then poured into a plastic syringe and stored in a freezer at −5° C. After 10-14 days, the sample was removed by cutting apart the syringe body. The fully hydrated sample was air-dried at room temperature for 3-5 days. The resulting material was very hard and tough and could be machined using standard machine tools. FIGS. 48a-48c show the foam being tapped to hold a machine screw and machined on a jeweler's lathe.

### 14. Bone-Shaped Foam Construct

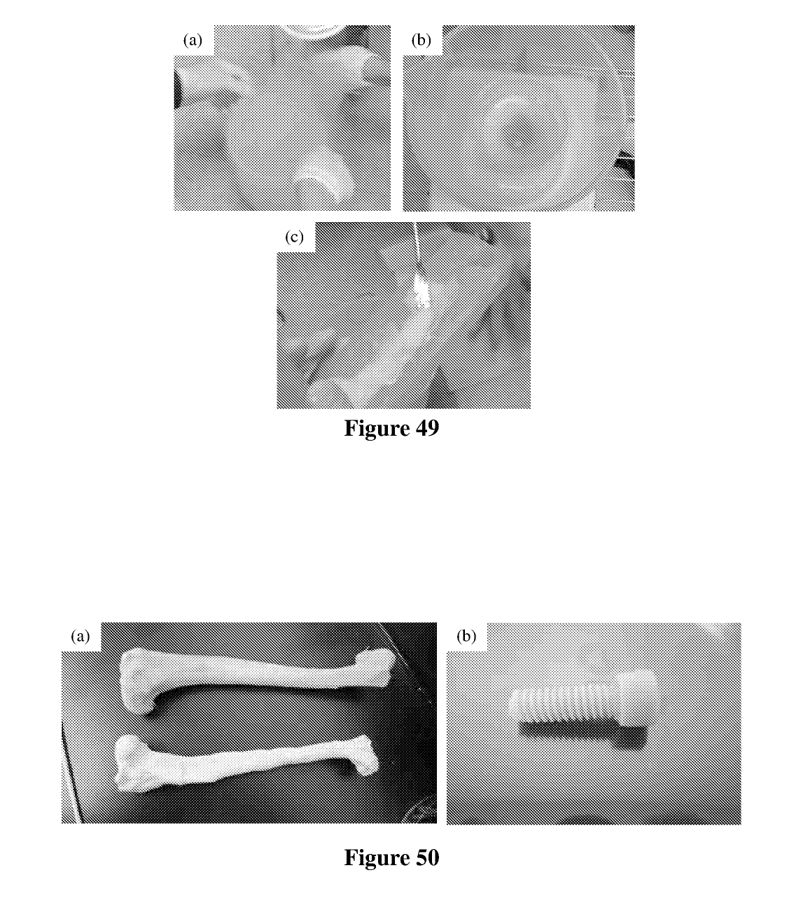

As in Experiment 13 above, silk solution that was produced using Taiwanese cocoons and 60 minutes of boiling time (for degumming) and concentrated to about 25% w/v. The solution was heated to above 60° C., the temperature above which water bound to silk fibroin at the molecular level becomes unbound. Pure silk powder (TKB Trading) was mixed into the hot solution in a Falcon tube. After the solution was allowed to return to room temperature, liquid nitrogen was carefully added to the solution (FIG. 49a). The freezing mixture was stirred on a stir plate (FIG. 49b). A mold was created using DragonSkin, a platinum-cured elastomeric material from Smooth-On Corp. The two-part elastomer was mixed together and poured into a rectangular container. An actual dog femur, donated by the Cummings School of Veterinary Medicine (Tufts), was placed in the uncured elastomer. After curing in an oven for 2 hours, the DragonSkin was separated in two with a knife; ensuring the parting line was at the level where the dog femur was placed. The femur was then removed, leaving a well-defined femur mold. The silk solution with liquid nitrogen mixed in was very viscous, with a consistency of mashed potatoes. Using a lab spatula, the silk was packed into the two halves of the femur mold (FIG. 49c), and the mold was subsequently clamped together. The mold with silk was stored at −5° C. for 1-2 weeks in a freezer. The silk femur was removed by separating the mold at the parting line. Given the as-molded silk was fully hydrated, the material was allowed to dry at room temperature for a period of 3-5 days. The resulting silk bone construct showed excessive shrinking and did not exhibit good geometric stability (data not shown).

### 15. Bone-Shaped Foam Construct

As in Experiment 14 above, silk solution that was produced using Taiwanese cocoons and 60 minutes of boiling time (for degumming) was concentrated to about 25% w/v. The solution was heated to above 60° C. and silk powder (TKB Trading) was mixed into the hot solution in a Falcon tube. In contrast to Experiment 14, the warm solution with powder embedded was poured into an enclosed bone mold without the use of liquid nitrogen. The mold containing silk solution was placed in a freezer at −5° C. for about two weeks. After removal from the freezer, the mold was disassembled and the silk construct allowed to dry at ambient conditions. The resulting bone model was remarkable in the level of detail replicated in the silk. The bone model was fairly stiff, although the level of brittleness was not tested. FIG. 50a shows two silk bone constructs. Note that the pink color was produced by mixing a small volume of red ink into the silk solution before molding. Based on the uniform color distribution, other chemicals and/or drugs could also be evenly distributed in the foam structure by mixing them in at the silk solution stage. Given the high level of geometric detail retained from the mold, other geometries can also be made, such as a silk screw (FIG. 50b).

### 16. Freezer Characterization Experiments

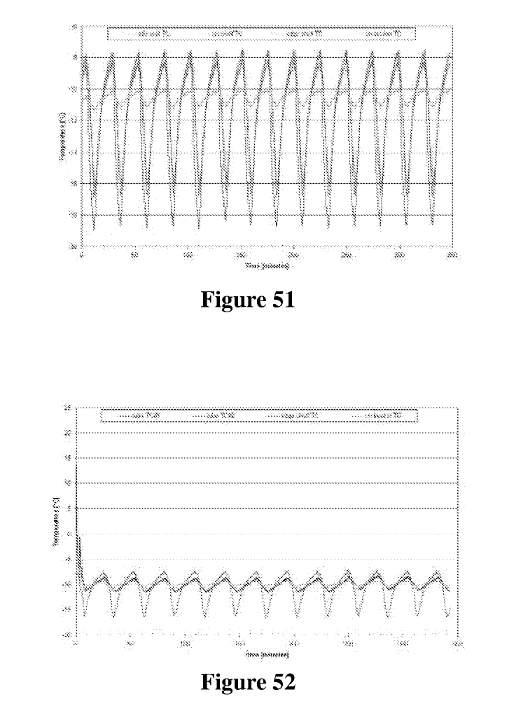

The thermoelectric cooler/freezer used in these foam experiments is known to exhibit some temperature swings. This is expected in all freezers, given the need to maintain a temperature target range through the use of built-in sensors and a controlled cooling device. In the case of the thermoelectric cooler, it was thought that temperature cycling within the device might be contributing to the foam formation and not just the average temperature value. To help modulate the temperature swings inside the cooler, a large beaker of water with ethylene glycol was placed inside for all experiments using the cooler. The thermal mass of the water slows the response time of the temperature swings. Because of the ethylene glycol, the water could not freeze at the sub-zero temperatures inside. To characterize the temperature profile within the cooler and to understand the nature of its temperature cycling, four thermocouples were mounted inside: one mounted to an inner wall, one on a shelf inside, one on the edge of the self, and one on the beaker that contained the water. The thermocouples were attached to a National Instruments CompactDAQ modular data acquisition chassis and temperature values were recorded with a National Instruments LabVIEW program. As seen in FIG. 51, the widest temperature swings were measured on the side wall of the cooler, ranging from approximately −8 to −18° C. Near the beaker, which is where most samples are placed in the cooler, the temperature cycled between approximately −10 to −11° C. Based on the timescale, the temperature cycled once every 25 minutes.

In a follow-up characterization, a Tygon tube was placed across the middle of the thermoelectric cooler, spanning the beaker and the internal shelf. Four thermocouples were used to characterize the temperature: two placed inside the very ends of the Tygon tube, one on the edge of the internal cooler shelf, and one on the beaker of water. The temperature within the ends of the tube, shown in FIG. 52, cycled between approximately −9.5 to −10.5° C. The cycle period was once again approximately 25 minutes. Based on these results, any experiments that were conducted in the thermoelectric cooler are described using an average temperature. For many newer experiments, an average temperature of −10° C. is reported. It is unclear whether the temperature swings play a large role in foam formation, but it is possible. If the cycling causes the internal temperature to swing between −8 to −18° C., the freeze/thaw cycling can be playing a role in foam formation. However, given the samples themselves were typically in a thermally insulating dish or mold and the liquid-like samples have an appreciable thermal mass, the temperature swings experienced by the silk samples can be closer to the −9.5 to −10.5° C. range. Even though this would not lead to thawing of the frozen water in the silk fibroin, the heating/cooling cant lead to some additional mobility of the silk fibroin within the water/ice matrix.

### 17. Controlled Foam Geometry to Explore Formation Mechanism

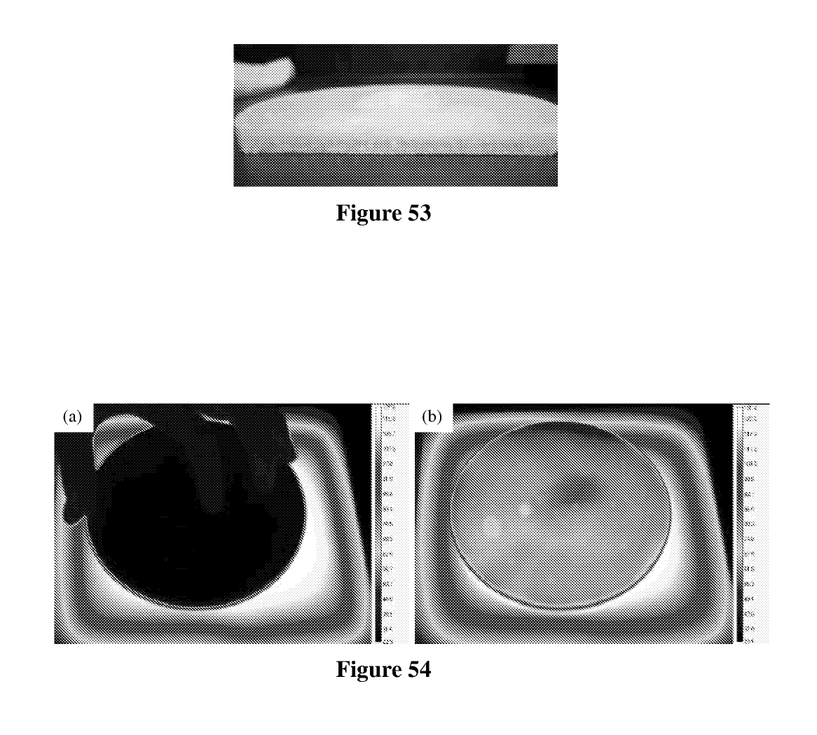

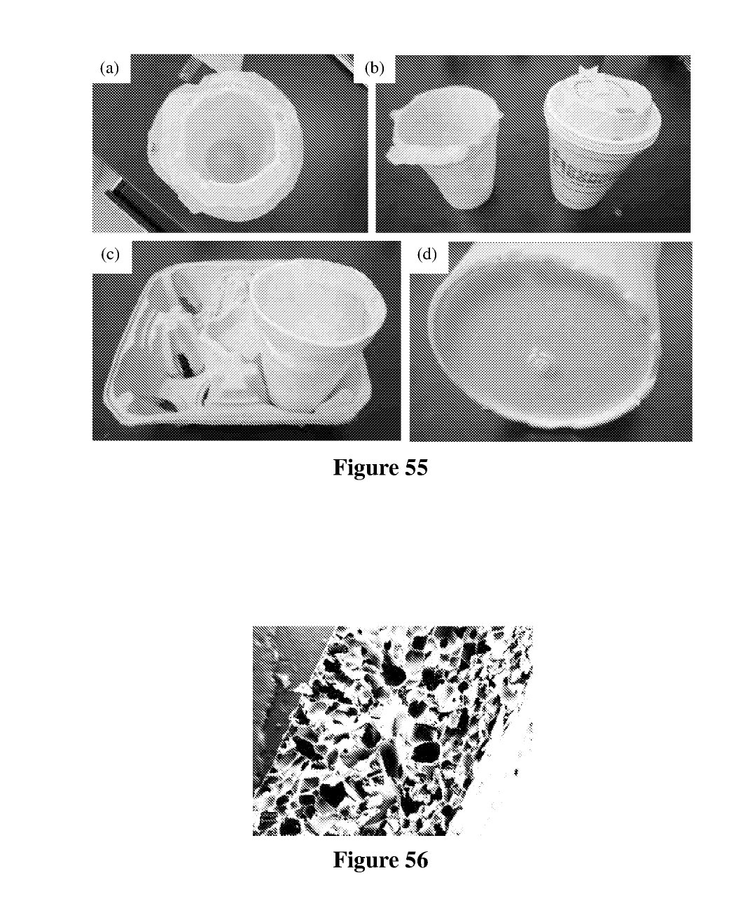

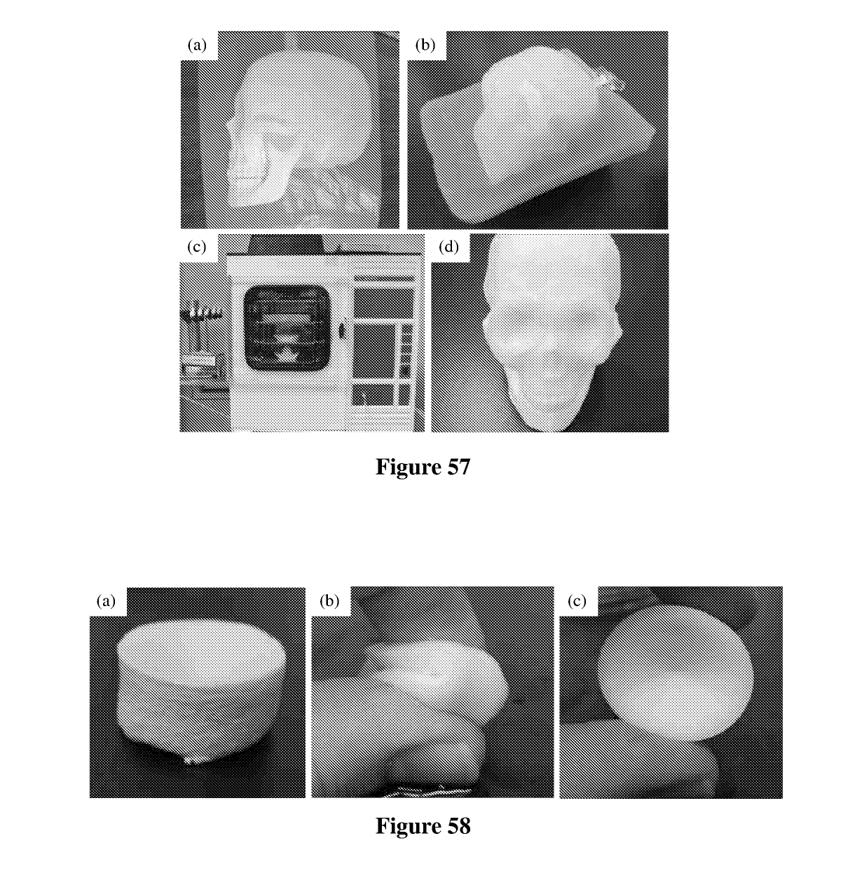

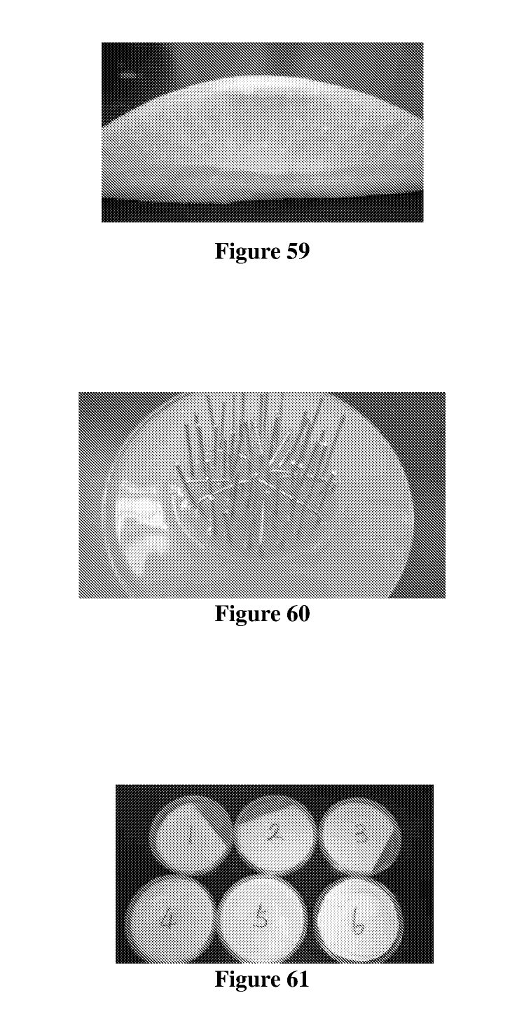

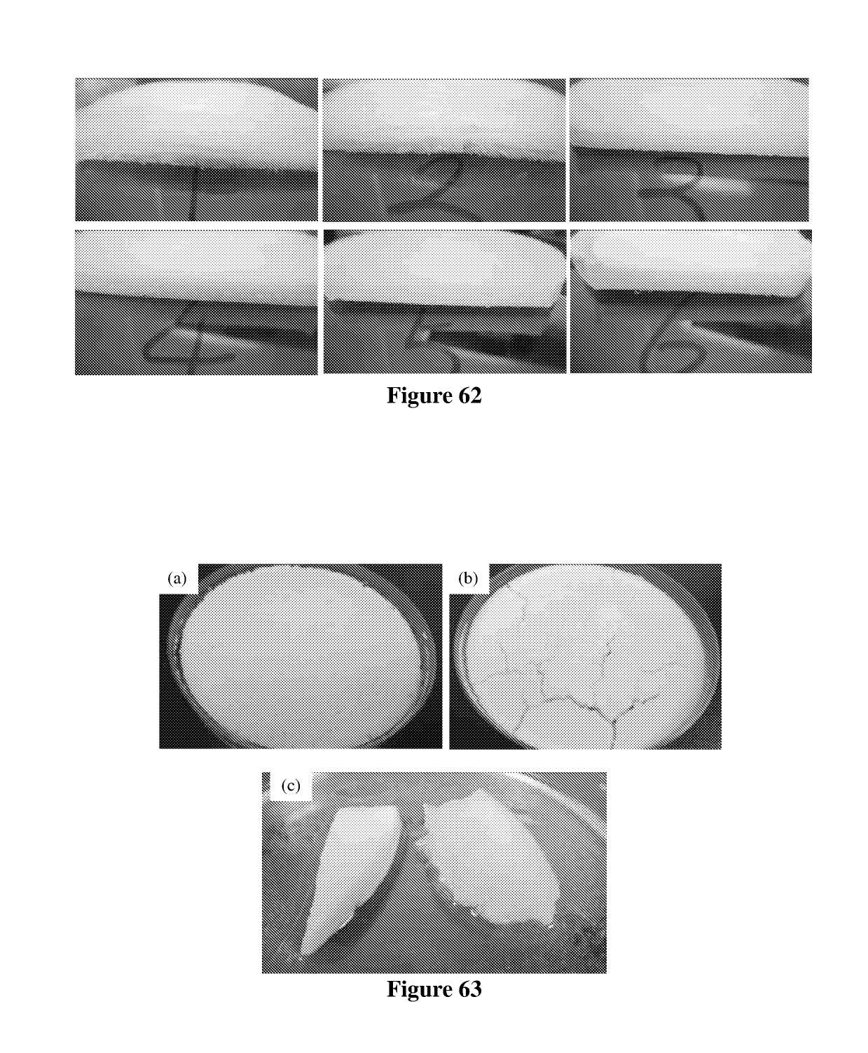

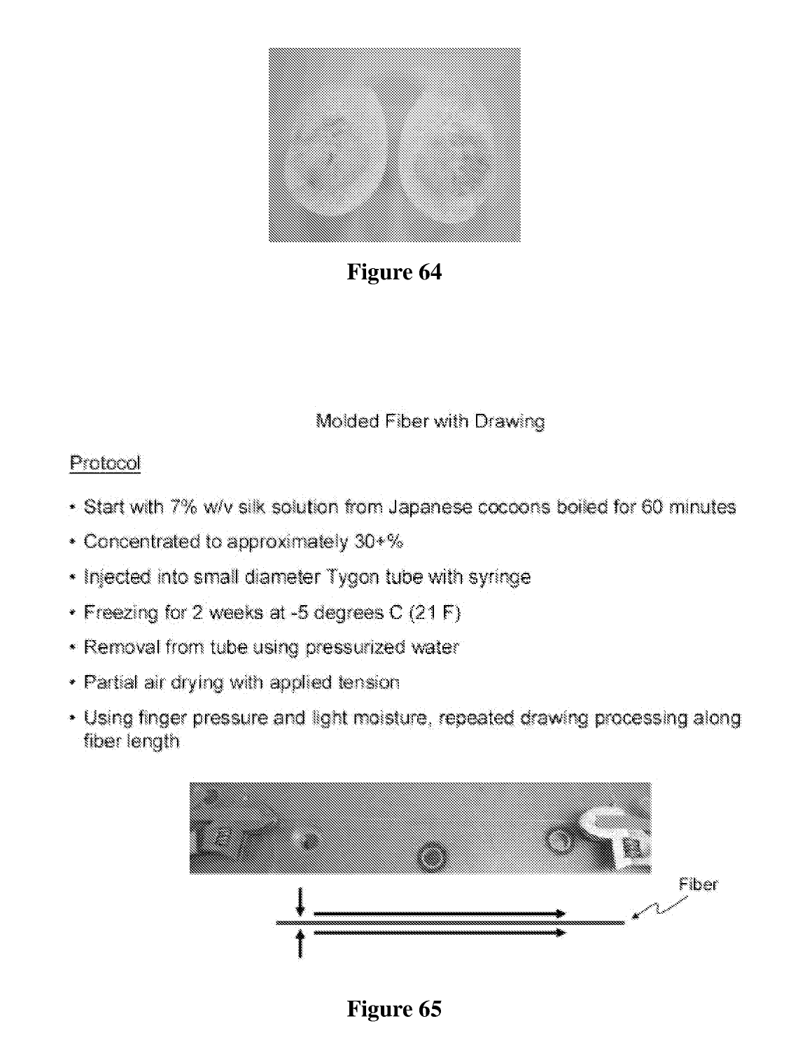

To develop a better understanding of the mechanisms involved in forming silk foam, a series of controlled tests were conducted. In this experiment, a silk solution made from cocoons from a Chinese supplier and degummed for 30 minutes was used. The silk was poured into a Petri dish and placed in a freezer at −10° C. for 3-4 days. Once removed from the freezer, the silk (still within the dish) was transferred to a VirTis Genesis Lyophilizer (Model 25L Genesis SQ Super XL-70), in which a high vacuum was established. After the material was visibly dry (−3-4 days), it was removed from the lyophilizer. A lyophilizer helps eliminate free water in a silk solution through sublimation. In the typical usage, the sample is first flash-frozen in liquid nitrogen and placed in the vacuum. In the case of the silk foams described in this document, no flash freezing was used. The goal was to allow the free water and any bound water to be sublimated. The vacuum reduces atmospheric pressure around the sample, which then leads to a lower boiling temperature of the silk solution. As vaporization of water molecules occurs, heat is removed from the solution, which leads to freezing. The rate of water loss then slows. FIG. 53 shows the foam sample after sectioning. Consistent with Experiment 8, the volume of the sample which was frozen first exhibited a consistent, fine-pore structure. The volume in the bulk of the sample and closest to the bottom of the Petri dish, which is somewhat thermally insulated, exhibited a large-port structure. Not easily seen in FIG. 53 is a thin, dense silk layer that spans the sample horizontally (mid-height).

Without wishing to be bound by a theory, several phenomena can help explain the morphology seen in this foam. Silk fibroin is a block copolymer that can exhibit both hydrophobic and hydrophilic behavior. This interaction can cause silk fibroin to align at a water-air interface, causing chain alignment and strong intermolecular bonds to form. This is one factor in the fine-pore structure made of dense silk fibroin that forms at the exposed upper foam surface. In addition, due to hydrophobic interactions with water, as the freezing temperature of water in silk fibroin is approached, the silk coagulates into regions of high silk concentration (a process known as freeze-concentrating). Since silk can be exhibiting a relatively low surface tension, as the water starts to freeze and expand, the silk fibroin chains stretch and align. Due to close proximity and higher mobility of the silk fibroin (which is not frozen), hydrogen bonds can form, creating pore walls. Buoyancy effects which cause water to pool at the bottom of the Petri dish and the mobility of the silk fibroin may lead to the larger pore formation in the bulk of the sample. Temperature cycling, from a temperature close to the freezing temperature of water in silk fibroin to a lower temperature, can assist in the mobility of the silk fibroin in the bulk of the sample.

### 18. Characterization of Insulating Capability of Silk Foam

Given the highly porous nature of the silk foams created in prior experiments, it was desired to determine how well relatively thin silk foam could thermally insulate objects. A resistance-based heating plot was set to a high temperature and a silk foam construct (shown in Experiment 17) was placed on top. A Fluke infrared camera was used to monitor the temperature profiles of the heating plate and silk foam over about 1 minute. As shown in FIG. 54a, the initially cool silk foam was placed on the heating plate, which had a peak temperature of 120° C. Over the span of about 35 seconds, the silk foam reached a steady-state temperature of approximately 75° C. (FIG. 54b). Given the foam sample was approximately ¼″ thick, the temperature difference between the top surface of the foam and surface of the heating plate of greater than 40° C. was impressive. The foam could be removed by hand, although care was taken not to touch the heating plate, which would have caused a skin burn.

### 19. Molded Silk Foam Coffee Cup Prototype

Given the ability for a silk foam to act as a thermal insulator, use of silk as an alternative to Styrofoam studied. Silk solution made with Chinese silkworm cocoons and 20 minutes of boiling time was used (−7% w/v concentration). A mold was created using DragonSkin, a platinum-cured elastomeric material from Smooth-On Corp. The two-part elastomer was mixed together and poured into a glass beaker. A take-out Styrofoam coffee cup was then pushed into the uncured elastomer to act as a positive. The inside of the coffee cup was filled with additional uncured elastomer. After storing in an over for about 2 hours to cure the elastomer, the DragonSkin mold was separated and the Styrofoam cup removed. The mold was then reassembled and the silk solution poured into the coffee cup-shaped cavity. The mold was then stored in a freezer at −10° C. for 3 days, before being transferred to a lyophilizer. After removal from the vacuum environment (−4 days), the mold was separated. FIG. 55a shows the silk cup still in the bottom half of the mold. FIG. 55b shows the cup next to the original coffee cup positive. Excess material was removed with a razor blade. FIGS. 55c and 55d show the final product. The detail in FIG. 55d indicates that even subtle detail in a positive mold can be replicated in a silk-based version.

### 20. Thin Foam Construct

To further explore the control of porosity, as in Experiments 8 and 17, a follow-up experiment was conducted. Using the same conditions from Experiment 17 (Chinese cocoons, 30 minute degumming), a thin layer of silk solution (around 2 mm thickness) was stored in a Petri dish at −10° C. for 3-4 days, then vacuum-dried in a lyophilizer. The resulting silk foam formed a fine, interconnected-pore structure through the entire thickness (FIG. 56). Given the exposure of the top surface of the silk solution to ambient conditions and the thin layer of silk, it is confirmed that freezing rate is important for the formation of a fine pore network. Building on the mechanistic description in Experiment 17, the faster freezing of the water in the silk fibroin solution can shorten the time for the low surface-tension silk fibroin to be stretched and migrate. However, unlike in flash freezing (e.g., bringing silk solution quickly to liquid nitrogen temperatures), there is some mobility allowed, creating a foam that is more robust mechanically than a flash frozen material.

### 21. Skull-Shaped Foam Construct

As demonstrated in Experiment 19, silk foam can be molded into the shape of everyday objects. To explore the level of geometric complexity that is achievable, a silk foam skull was created. Starting with a Chinese cocoon source, ˜7% w/v silk solution was created using a 20 minute degumming time. A small plastic skull was obtained to act as a mold positive. The skull was suspended in a 1 liter cup, ensuring the skull did not contact the cup walls or base. A two-part, platinum-cured elastomeric material, known as DragonSkin (Smooth-on, Inc.), was poured into the space around the skull. After storing in an oven at 60° C. for two hours, the cured DragonSkin was removed from the cup. After cutting the molded DragonSkin in half (FIG. 57a), the plastic skull was removed, and the two mold halves clamped together. The silk solution was then slowly poured into the mold cavity to avoid bubble entrapment. The mold was then stored in an EdgeStar Model FP430 thermoelectric cooler for 5 days. The mold was then unclamped (FIG. 57b) and the silk skull removed. The skull was semi-frozen, with a large volume of entrapped water. The skull was placed in a VirTis Genesis (Model 25L Genesis SQ Super XL-70) Lyophilizer for 5 days (FIG. 57c). The lyophilizer pulled a high vacuum, but no specific temperature control was set. The completed skull (FIG. 57d) had good dimensional stability, exhibiting precise features recapitulated from the original plastic skull. The same mold can be resused to make multiple copies of the silk foam skull.

### 22. Powder-Enhanced Foam Formation

This experiment was conducted to explore the ability for silk powder to enhance the processing of foams using the freezing process described previously. Using a Chinese cocoon source and 20 minutes of degumming time, a 7% w/v silk solution was processed. Pure silk powder (TKB Trading) was mixed into the silk solution in a Falcon tube and transferred into a plastic syringe. The syringe was stored in an EdgeStar Model FP430 thermoelectric cooler for about 4 days at −10° C. After removal from the syringe, the silk was observed to be semi-frozen and flexible. The construct was then stored in a lyophilizer for only 2 days. After entrapped water had been removed by the lyophilizer, the silk exhibited a fine-pore foam-like structure (FIG. 58a). This foam, however, was much tougher than prior foams, such as in Experiment 20. The foam could be quickly re-hydrated and then compressed to remove the water (FIG. 58b). After removal of compressive force, the foam would quickly self-expand to it's original shape and size (FIG. 58c). This demonstrated that the addition of the silk powder enhanced the rate of foam formation. It is known that powder forms of silk often contain much lower molecular weight than native cocoon fiber, due to increased surface area and, therefore, increased aggressiveness of boiling used during degumming. The short chains of silk are very mobile and can cause rapid formation of hydrogen bonds at the interface between water, where freeze-concentrating causes coagulation of silk.

### 23. Implantable Silk Foam Constructs

Overall, the freezer-processed silk foams exhibited good mechanical performance, controllable pore network, and excellent geometric stability and precision. These features can be used to create biomedical implant scaffolds for various applications. In one direction, the creation of soft silk foams for filling void space in soft tissue was studied. A series of hemispherical foam constructs were created to evaluate usage in such applications. In this experiment, a 7% w/v silk solution made from Chinese cocoons and 20 minute degumming was utilized. As in Experiment 21, a DragonSkin mold was created. The two-part platinum-cured elastomeric material was poured into a large Petri dish. An oversized ball was positioned in the DragoSkin to form a hemispherical cavity. After curing in an oven at 60° C. for 2 hours, the cured DragonSkin was removed from the Petri dish. Silk solution was poured into the mold and the construct stored in an EdgeStar Model FP430 thermoelectric cooler for about 3 days at −10° C. The silk hemisphere was then transferred to a lyophilizer for 3 days. FIG. 59 shows the sample after sectioning in half. It exhibited many of the hallmarks of the foam created in prior experiments, such as Experiment 17. The flat, exposed surface of the hemispherical sample, as well as the near-surface region around the spherical surface exhibited fine-pore structures. This was consistent with prior observations for areas that have the highest freezing rate. The bulk of the sample exhibited a large-pore structure, which can be due to its thermal isolation.

### 24. Freezing-Rate Control of Hemispherical Silk Foam Porosity

Given that the freezing-processed silk foams exhibit fine-pore structure in areas of high freezing rate, an experiment was conducted to better control freezing rate throughout a construct. As shown in FIG. 60, a DragonSkin mold was created, as described in Experiment 23. Brass rods were driven into the mold. 7% w/v silk solution (Chinese cocoons, 20 minute degumming) was poured into the mold and the construct stored in a cooler at −10° C. for 3 days. During the first day in the cooler, it was observed that the silk solution surrounding each brass rod was solidifying faster than in the surrounding silk volume (can be seen as a subtle white color around each rod in FIG. 60). After 3 days in the cooler, the brass rods were removed and the silk construct was then stored in a lyophilizer for 3 days. The silk construct looked like the construct in Experiment 23, but with holes penetrating where the rods were placed, with a fine-pore interface where each rod enhanced freezing rate. This demonstrated that fine control; over pore size and distribution can be achieved.

### 25. Effect of Concentration on Freezer-Processed Silk Foam

Silk concentration can influence the mechanical properties of geometries made from regenerated silk. To explore the variations in freezer-processed silk foam due to concentration, a series of simple geometries were created. Using a Chinese silk source and 10 minute degumming, silk solutions were prepared with concentrations of 1, 2, 3, 4, 5, and 6% w/v. This was achieved by creating a nominally ˜7% w/v solution and diluting with milli-Q water. Each prepared solution was poured into a Petri dish and processed using the freezer-processing approach described in Experiment 24. The completed foams are pictured in FIG. 61. Each sample was sectioned, as shown in FIG. 62. Each concentration exhibited slightly different morphology. The 1% w/v silk solution generated the softest and lightest foam construct. The foam was extremely compressible, with the largest pore structure of all 6 foams. On the other end of the spectrum, the 6% w/v foam exhibited the stiffest mechanical performance, with the finest pore structure. Stiffness increased while pore size decreased with increasing silk concentration. This can be due to the formation of bonds between silk fibroin molecular chains during the freezing process. With the lower concentrations, the low surface tension of the silk fibroin and weak bonding causes large pores to form, stretching the silk fibroin chains into relatively thin, weak pore walls. At higher concentrations, chain-to-chain bonding has a higher likelihood of occurring early in the freezer process, which form pore walls before significant stretching occurs. Therefore, silk concentration and freezing rate can be used to provide fine control of foam pore structure.

### 26. Silk-Stabilized Egg Foam

Given the ease of producing high-quality silk foams using the freezer-processing technique described herein, an experiment was conducted to study the ability of silk to act as a foam stabilizer. Chicken eggs are used extensively in cooking. Because of high protein content, it was a goal to see if the freezer-processing technique could be used to form egg foam. In this experiment, egg yolks were separated from the egg whites of two medium-sized eggs. They were then mixed with equal proportions of a 7% w/v silk solution and poured into Petri dishes (Chinese cocoon source, 10 minute degumming time). Using the freezer-processing as described in Experiment 24, each was stored in a cooler and lyophilizer for a period of 3 days each. The resulting materials were interesting (FIGS. 63a and 63b). The silk stabilized the egg yolk very well, producing a high-quality, fine-pored foam. The egg white foam tended to crack. This was can be a result of removing the foams from the lyophilizer too soon (leftover water content may have evaporated after removal from the lyophilizer, causing unpredictable shrinking of the foam). The tough egg yolk foam readily soaked up water, which can be subsequently squeezed dry. This experiment demonstrates that substances that could be challenging to stabilize in the form of foam can be done so with the use of a freezer-process silk foam formation method described herein.

### 27. Silk-Stabilized Egg Construct

Experiment 26 was repeated, with the added goal of being able to build a foam-stabilized structure that could stabilize multiple, unique substances in a single overarching construct. A spherical mold was created using DragonSkin and a small ball. Following the procedure given in Experiment 21, the cured DragonSkin was parted with a razor blade. Egg yolks, separated from the egg whites, were mixed with 7% w/v silk solution (Chinese cocoon source, 10 minute degumming time) and poured into the mold. After storing in a freezer at −10° C. for 3 days, the egg yolk foam ball was removed from the mold and stored in a lyophilizer for another 3 days. An egg mold was created using DragonSkin and a raw egg. After curing and parting with a razor blade, the void was filled with an egg white/silk solution blend (7% w/v as above), with the egg yolk ball suspended in the middle. As with the egg yolk foam, the entire construct was stored at −10° C. for 3 days, removed from the DragonSkin mold, and then stored in a lyophilizer for another 3 days. The final construct was separated into two (FIG. 64). The excellent foam geometry demonstrated the ability to stabilize multiple substances in a single construct.

All patents and other publications identified in the specification and examples are expressly incorporated herein by reference for all purposes. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow. Further, to the extent not already indicated, it will be understood by those of ordinary skill in the art that any one of the various embodiments herein described and illustrated can be further modified to incorporate features shown in any of the other embodiments disclosed herein.

1. A method of fabricating an article from silk fibroin, the method comprising:
(i) providing a silk fibroin solution into a mold; and
(ii) holding the mold at a temperature from about −30° C. to about 25° C. for a period of time.

2. (canceled)

3. (canceled)

4. (canceled)

5. The method of claim 1, further comprising a post-processing step.

6. The method of claim 5, wherein the post-processing step comprises drying, rehydrating, coating, soaking in a solution, mechanical processing, or freeze-drying the article.

7. The method of claim 1, further comprising incubating the silk fibroin solution at a temperature from about −30° C. to about 25° C. for a period of time before coating the surface of the mold.

8. The method of claim 1, wherein the silk fibroin solution comprises an additive in addition to silk fibroins.

9. (canceled)

10. The method of claim 1, wherein the article is a film, a foam, a fiber, a coating, a gel, a hydrogel, a sponge, a 3D-scaffold, and the like.

11. The method of claim 1, further comprising preprocessing the silk fibroin solution before contacting with the mold.

12. The method of claim 11, wherein said preprocessing comprises increasing viscosity of the silk fibroin solution.

13. The method of claim 12, wherein said preprocessing comprises electrogelation, pH induced gelation, shear stress induced gelation, or a combination thereof.

14. The method of claim 12, further comprising heating the silk fibroin solution before pouring into the mold.

15. An article prepared by a method according to claim 1.

16. The article of claim 15, wherein the article is a fiber, a gel, a foam, a sponge, or a film.

17. A method of fabricating a silk fiber, the method comprising:
(i) providing a silk fibroin solution in a mold to form a fiber;
(ii) holding the mold at a temperature from about −30° C. to about 25° C. for a period of time;
(iii) removing the fiber from the mold; and
(iv) optionally further processing the fiber.

18. A method of fabricating a silk fiber, the method comprising:
(i) subjecting a silk fibroin solution to a gelation process;
(ii) partially removing at least a geled portion of the silk fibroin solution from the silk fibroin solution;
(iii) heating the geled portion;
(iv) pouring the heated geled portion from step (iii) into a mold to form a fiber;
(v) holding the mold at a temperature from about −30° C. to about 25° C. for a period of time;
(vi) removing the fiber from the mold; and
(vii) optionally further processing the fiber.

19. A method of fabricating a silk fiber, the method comprising:
(i) incubating a silk fibroin solution at pouring a temperature from about −30° C. to about 25° C. for a first period of time;
(ii) pouring the silk fibroin solution from step (i) into a mold to form a fiber; and
(iii) holding the mold at a temperature from about −30° C. to about 25° C. for a second period of time;
(iv) removing the fiber from the mold; and
(v) optionally further processing the fiber.

20. A method of fabricating a silk foam, the method comprising
(i) subjecting a silk fibroin solution to a gelation process;
(ii) removing geled portion of the silk fibroin solution from the silk fibroin solution; and
(iii) incubating non-gelated portion from step (ii) at a temperature from about −30° C. to about 25° C. for a period of time.

21. A method of fabricating a silk foam, the method comprising
(i) pouring a silk fibroin solution into a mold; and
(ii) holding the mold at a temperature from about −30° C. to about 25° C. for a period of time.

22. A method of fabricating a silk film, the method comprising
(i) subjecting a silk fibroin solution to a gelation process;
(ii) removing geled portion of the silk fibroin solution from the silk fibroin solution;
(iii) coating a surface of a solid-substrate with the non-gelated portion of the silk fibroin solution; and
(iv) incubating the coated substrate at a temperature from about −30° C. to about 25° C. for a period of time.

23. A method of fabricating a silk film, the method comprising
(i) coating a surface of a solid-substrate with a silk fibroin solution; and
(ii) incubating the coated substrate at a temperature from about −30° C. to about 25° C. for a period of time.

24. (canceled)

25. (canceled)

26. (canceled)

27. (canceled)

28. (canceled)

29. (canceled)

30. (canceled)
